(19) United States
(12) Patent Application Publication
(10) Pub. No.: US 2023/0112953 A1
(43) Pub. Date: Apr. 13, 2023

(54) LIQUID CRYSTAL COMPOSITION, LIQUID CRYSTAL ELEMENT, SENSOR, LIQUID CRYSTAL LENS, OPTICAL COMMUNICATION DEVICE, AND ANTENNA

(71) Applicant: DIC Corporation, Tokyo (JP)

(72) Inventors: Mika YAMAMOTO, Saitama (JP); Yoshio AOKI, Saitama (JP); Hidetoshi NAKATA, Saitama (JP); Kazunori MARUYAMA, Saitama (JP); Shinichi HIRATA, Saitama (JP); Haruki OHISHI, Saitama (JP); Masahiro HORIGUCHI, Saitama (JP)

(73) Assignee: DIC Corporation, Tokyo (JP)

(21) Appl. No.: 17/794,259

(22) PCT Filed: Dec. 10, 2020
(86) PCT No.: PCT/JP2020/045958

§ 371 Date: Jul. 21, 2022

(30) Foreign Application Priority Data
Feb. 7, 2020 (JP) 2020-019699

(51) Int. Cl. C09K 19/34; C09K 19/32; C09K 19/30; C09K 19/24; H01Q 13/10; H01Q 21/24

(52) U.S. Cl. CPC C09K 19/3455; C09K 19/322; C09K 19/3059; C09K 19/24; H01Q 13/106; H01Q 21/24; C09K 2019/325; C09K 2019/3063; G02F 1/137

(57) ABSTRACT

A nematic liquid crystal composition having a high Δn and a high Δε in a liquid crystal material that enables greater phase control over electromagnetic waves in the microwave or millimeter wave range, and a liquid crystal element, a sensor, a liquid crystal lens, an optical communication device, and an antenna including the nematic liquid crystal composition. Specifically, a liquid crystal composition containing one or two or more compounds represented by general formula (i) in the specification and one or two or more compounds represented by general formula (ii) in the specification, and having a high Δn and a high Δε.

### TECHNICAL FIELD

The present invention relates to a liquid crystal composition, a liquid crystal element, a sensor, a liquid crystal lens, an optical communication device, and an antenna.

### BACKGROUND ART

Antennas formed of liquid crystals to transmit and receive radio waves between movable bodies such as automobiles and communications satellites are attracting attention as a new application for liquid crystals widely used for displays. Conventionally, satellite communications have used parabolic antennas. When used in a movable body such as an automobile, the parabolic antenna has to be pointed in a direction of the satellite as needed and requires a large moving part. An antenna formed of liquid crystals, however, can change the direction of radio wave transmission and reception by operating the liquid crystals, so there is no need to move the antenna itself, and the shape of the antenna can be flat.

In general, automatic driving of automobiles and other vehicles requires massive data downloads of high-precision 3D map information. However, an antenna formed of liquid crystals, when mounted on an automobile, enables massive data downloads from communications satellites without a mechanical moving part. The frequency band used for satellite communications is approximately 13 GHz, which is significantly different from the frequencies that have been used for liquid crystal display applications. The required physical properties of liquid crystals therefore are also significantly different. Specifically, Δn required for liquid crystals for antennas is approximately 0.4, and the operating temperature range is −40 to 120° C. or higher.

Infrared laser image recognition and ranging devices formed of liquid crystals are also attracting attention as sensors for automatic driving of movable bodies such as automobiles. The required Δn of liquid crystals for this application is 0.2 to 0.3, and the operating temperature range is −40 to 120° C. or higher.

In this respect, examples of the technology of liquid crystals for antennas include PTL 1.

NPL 1 also proposes the use of liquid crystal materials as a component of high-frequency devices.

### CITATION LIST

### Patent Literature

PTL 1: Japanese Unexamined Patent Application Publication No. 2016-37607

### Non Patent Literature

NPL 1: D. Dolfi, “Electronics Letters”, (UK), 1993, Vol. 29, No. 10, pp. 926-927.

### SUMMARY OF INVENTION

### Technical Problem

For liquid crystals for antennas, there is a demand for the development of liquid crystal compositions that exhibit a higher refractive index anisotropy (Δn) to enable greater phase control over electromagnetic waves in the microwave or millimeter wave range. Furthermore, in the field of liquid crystal compositions for high-frequency applications such as antennas, there is a demand for those having a higher dielectric constant anisotropy (Δε) in terms of lower drive voltages and quick response. Thus, there is a need for liquid crystal compositions that combine a high Δn and a high Δε and satisfy the required characteristics for high-frequency applications. Unfortunately, in the liquid crystal compositions described in PTL 1 above, few specific values of Δn are listed. Although Δn is listed, only liquid crystal compositions with a small Δε are listed, and liquid crystal compositions that combine a high Δn and a high Δε are not disclosed.

An object of the present invention is to provide a nematic liquid crystal composition having a high Δn and a high Δε in a liquid crystal material that enables greater phase control over electromagnetic waves in the microwave or millimeter wave range, and a liquid crystal element, a sensor, a liquid crystal lens, an optical communication device, and an antenna including the nematic liquid crystal composition.

### Solution to Problem

The inventors of the present invention have conducted elaborate studies and found that the above object can be achieved by a liquid crystal composition containing one or two or more compounds represented by general formula (i) and one or two or more compounds represented by general formula (ii) described below. This finding has led to completion of the present invention.

The overall configuration of the present invention to achieve the above object is as follows.

A liquid crystal composition of the present invention contains:

one or two or more compounds represented by general formula (i) below:

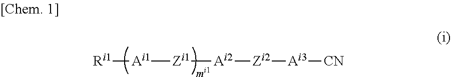

(in general formula (i),

Rⁱ¹ represents an alkyl group having 1 to 12 carbon atoms, wherein one or two or more non-adjacent —CH₂-'s in the alkyl group are each independently optionally substituted with —CH═CH—, —C≡C—, —O—, —CO—, —COO—, or —OCO—, and one or two or more hydrogen atoms in Rⁱ¹ are each independently optionally substituted with a fluorine atom,

Aⁱ¹, Aⁱ², and Aⁱ³ each independently represent a group selected from the group consisting of the following groups (a) to (c):

(a) a 1,4-cyclohexylene group (one —CH₂— or two or more non-adjacent —CH₂-'s in this group are optionally substituted with —O—),

(b) a 1,4-phenylene group (one —CH═ or two or more non-adjacent —CH='s in this group are optionally substituted with —N═), and

(c) a naphthalene-2,6-diyl group, a 1,2,3,4-tetrahydronaphthalene-2,6-diyl group, or a decahydronaphthalene-2,6-diyl group (one —CH═ or two or more non-adjacent —CH='s in the naphthalene-2,6-diyl group or the 1,2,3,4-tetrahydronaphthalene-2,6-diyl group are optionally substituted with —N═),

hydrogen atoms in the group (a), the group (b), and the group (c) are each independently optionally substituted with a halogen atom, a cyano group, or an alkyl group having 1 to 6 carbon atoms,

Zⁱ¹ and Zⁱ² each independently represent —OCH₂—, —CH₂O—, —C₂H₄—, —C₄H₈—, —COO—, —OCO—, —CH═CH—, —CF═CF—, —CF₂O—, —OCF₂—, —CF₂CF₂—, —C≡C—, or a single bond, wherein at least one Zⁱ¹ or Zⁱ² represents —C≡C—,

mⁱ¹ represents 1 or 2,

a plurality of Aⁱ¹s, if present, may be the same or different, and a plurality of Zⁱ¹s, if present, may be the same or different); and

one or two or more compounds represented by general formula (ii) below:

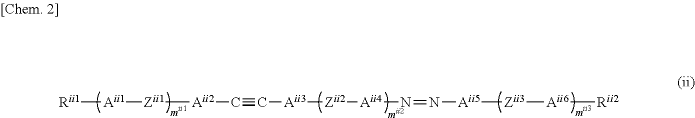

(in general formula (ii),

Rⁱⁱ¹ and Rⁱⁱ² each independently represent a fluorine atom, a chlorine atom, a cyano group, or an alkyl group having 1 to 12 carbon atoms, wherein one or two or more non-adjacent —CH₂-'s in the alkyl group are each independently optionally substituted with —CH═CH—, —C≡C—, —O—, —CO—, —COO— or —OCO—, and one or two or more hydrogen atoms in Rⁱⁱ¹ and Rⁱⁱ² are each independently optionally substituted with a fluorine atom, wherein Rⁱⁱ¹ and Rⁱⁱ² do not simultaneously represent a substituent selected from a fluorine atom, a chlorine atom, and a cyano group,

Zⁱⁱ¹, Zⁱⁱ², and Zⁱⁱ³ each independently represent a single bond, —OCH₂—, —CH₂O—, —C₂H₄—, —C₄H₈—, —COO—, —OCO—, —CH═CH—, —CF═CF—, —CF₂O—, —OCF₂—, —CF₂CF₂—, or —C≡C—,

Aⁱⁱ¹, Aⁱⁱ², Aⁱⁱ³, Aⁱⁱ⁴, Aⁱⁱ⁵, and Aⁱⁱ⁶ each independently represent a group selected from the group consisting of the following groups (a) to (c):

(a) a 1,4-cyclohexylene group (one CH₂— or two or more non-adjacent —CH₂-'s in this group are optionally substituted with —O—),

(b) a 1,4-phenylene group (one —CH═ or two or more non-adjacent —CH='s in this group are optionally substituted with —N═), and

(c) a naphthalene-1,4-diyl group, a naphthalene-2,6-diyl group, a 1,2,3,4-tetrahydronaphthalene-2,6-diyl group, or a decahydronaphthalene-2,6-diyl group (one —CH═ or two or more non-adjacent —CH='s in the naphthalene-1,4-diyl group, the naphthalene-2,6-diyl group, or the 1,2,3,4-tetrahydronaphthalene-2,6-diyl group are optionally substituted with —N═),

hydrogen atoms in the group (a), the group (b), and the group (c) are each independently optionally substituted with a halogen atom, a cyano group, or an alkyl group having 1 to 6 carbon atoms, and

mⁱⁱ¹, mⁱⁱ², and mⁱⁱ³ each independently represent 0 or 1, wherein mⁱⁱ¹+mⁱⁱ²+mⁱⁱ³ represents 0 or 1).

A liquid crystal element of the present invention includes the above liquid crystal composition.

A sensor of the present invention includes the above liquid crystal composition.

A liquid crystal lens of the present invention includes the above liquid crystal composition.

An optical communication device of the present invention includes the above liquid crystal composition.

An antenna of the present invention includes the above liquid crystal composition.

### Advantageous Effects of Invention

The present invention can provide a nematic liquid crystal composition having a high refractive index anisotropy (Δn) and a high dielectric constant anisotropy (Δε) and further can provide a liquid crystal element, a sensor, a liquid crystal lens, an optical communication device, and particularly an antenna including the nematic liquid crystal composition.

### BRIEF DESCRIPTION OF DRAWINGS

FIG. 1 is an exemplary diagram illustrating a vehicle equipped with an antenna according to the present invention.

FIG. 2 is an exemplary exploded view of the antenna according to the present invention.

FIG. 3 is an exemplary exploded view of an antenna body according to the present invention.

FIG. 4 is an exemplary top view of a slot array part in the present invention.

FIG. 5 is an exemplary top view of projection of the antenna body according to the present invention.

FIG. 6 is a form of a sectional view of the antenna body in FIG. 5 cut along line A-A.

FIG. 7 is another form of a sectional view of the antenna body in FIG. 5 cut along line A-A.

FIG. 8 is another exemplary top view of projection of the antenna body according to the present invention.

FIG. 9 is a sectional view of the antenna body in FIG. 8 cut along line C-C.

FIG. 10 is a sectional view of the antenna body in FIG. 8 cut along line B-B.

### DESCRIPTION OF EMBODIMENTS

A liquid crystal composition, a liquid crystal element, a sensor, a lens, an optical communication device, and an antenna of the present invention will be described in detail below based on embodiments thereof.

A liquid crystal composition according to the present invention contains a compound represented by general formula (i) and a compound represented by general formula (ii). The compounds represented by general formula (i) and general formula (ii) are described in order below. The compound represented by general formula (i) has a high Δε and a relatively high Δn and has even more favorable miscibility. Because of this, a liquid crystal composition stable at room temperature can be provided.

The liquid crystal compound represented by general formula (i) in the present invention is as follows.

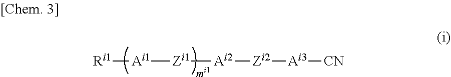

In general formula (i), Rⁱ¹ represents an alkyl group having 1 to 12 carbon atoms, wherein one or two or more non-adjacent —CH₂-'s in the alkyl group are each independently optionally substituted with —CH═CH—, —C≡C—, —O—, —CO—, —COO—, or —OCO—, and one or two or more hydrogen atoms in Rⁱ¹ are each independently optionally substituted with a fluorine atom.

Rⁱ¹ is a linear or branched group and preferably a linear group. Rⁱ¹ preferably represents an alkyl group having 2 to 11 carbon atoms, more preferably an alkyl group having 3 to 9 carbon atoms, and even more preferably an alkyl group having 4 to 7 carbon atoms.

Examples of the alkyl group in the present description include, but not limited to, methyl, ethyl, propyl, butyl, pentyl, hexyl, heptyl, octyl, nonyl, decyl, isodecyl, dodecyl, and 2-ethylhexyl, and a linear alkyl group is preferred.

A methylene group in Rⁱ¹ in general formula (i) is optionally substituted with —CH═CH—, —C≡C—, —O—, —CO—, —COO—, or —OCO— such that oxygen atoms are not directly adjacent to each other. Specifically, Rⁱ¹ is preferably an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, preferably an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, even more preferably an alkyl group having 1 to 5 carbon atoms or an alkenyl group having 2 to 5 carbon atoms, and even more preferably an alkyl group having 2 to 5 carbon atoms or an alkenyl group having 2 to 3 carbon atoms.

When the reliability of the entire liquid crystal composition is important, Rⁱ¹ is preferably an alkyl group. When the viscosity of the entire liquid crystal composition is important, Rⁱ¹ is preferably an alkenyl group.

The alkenyl group in the present description is preferably selected from groups represented by any of formulae (R1) to (R5). (The black circle in each formula represents a carbon atom in a ring structure.)

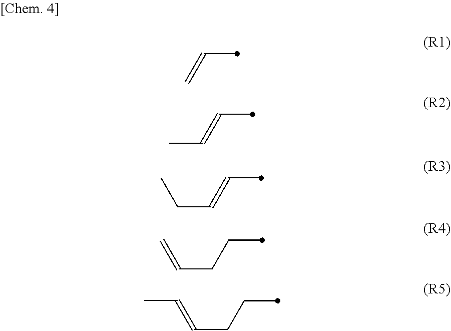

The alkenyloxy group in the present description is preferably selected from groups represented by any of formulae (R6) to (R10). (The black circle in each formula represents a carbon atom in a ring structure.)

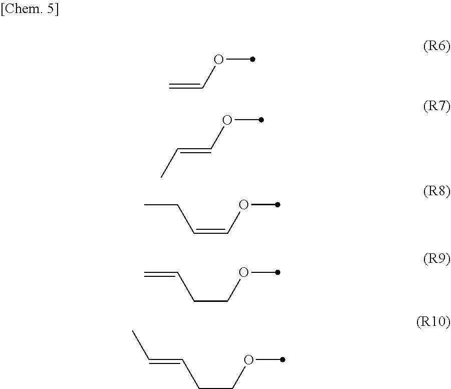

The alkoxy group in the present description includes, but not limited to, methoxy, ethoxy, propoxy, butoxy, pentoxy, and hexoxy, and a linear alkoxy group is preferred.

When the ring structure to which Rⁱ¹ is bonded is a phenyl group (aromatic group), a linear alkyl group having 1 to 5 carbon atoms, a linear alkoxy group having 1 to 4 carbon atoms, and an alkenyl group having 4 to 5 carbon atoms are preferred. When the ring structure to which it is bonded is a saturated ring structure such as cyclohexane, pyran, and dioxane, a linear alkyl group having 1 to 5 carbon atoms, a linear alkoxy group having 1 to 4 carbon atoms, and a linear alkenyl group having 2 to 5 carbon atoms are preferred. To stabilize the nematic phase, the total number of carbon atoms and oxygen atoms, if present, is preferably 5 or less, and preferably they are linear.

In general formula (i), Aⁱ¹, Aⁱ², and Aⁱ³ each independently represent a divalent cyclic group in which one or two or more hydrogen atoms in the ring structure are each independently optionally substituted with a halogen atom, a cyano group, or an alkyl group having 1 to 6 carbon atoms. The cyclic group is any of groups (a) to (c), and formula (a) or (b) is more preferred. Hydrogen atoms in the group (a), the group (b), and the group (c) are each independently optionally substituted with a halogen atom, a cyano group, or an alkyl group having 1 to 6 carbon atoms.

(a) a 1,4-cyclohexylene group (one —CH₂— or two or more non-adjacent —CH₂-'s in this group are optionally substituted with —O—),

(b) a 1,4-phenylene group (one —CH═ or two or more non-adjacent —CH='s in this group are optionally substituted with —N═), and

(c) a naphthalene-2,6-diyl group, a 1,2,3,4-tetrahydronaphthalene-2,6-diyl group, or a decahydronaphthalene-2,6-diyl group (one —CH═ or two or more non-adjacent —CH='s in the naphthalene-2,6-diyl group or the 1,2,3,4-tetrahydronaphthalene-2,6-diyl group are optionally substituted with —N═.)

Specific examples of Aⁱ¹, Aⁱ², and Aⁱ³ include divalent cyclic groups represented by formulae (a1) to (a26) below.

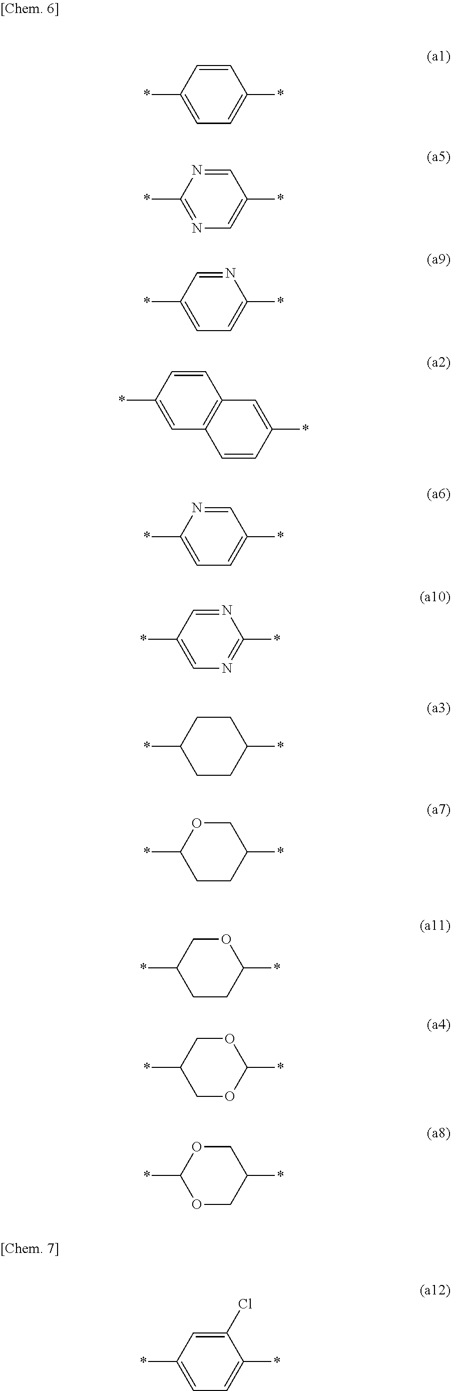

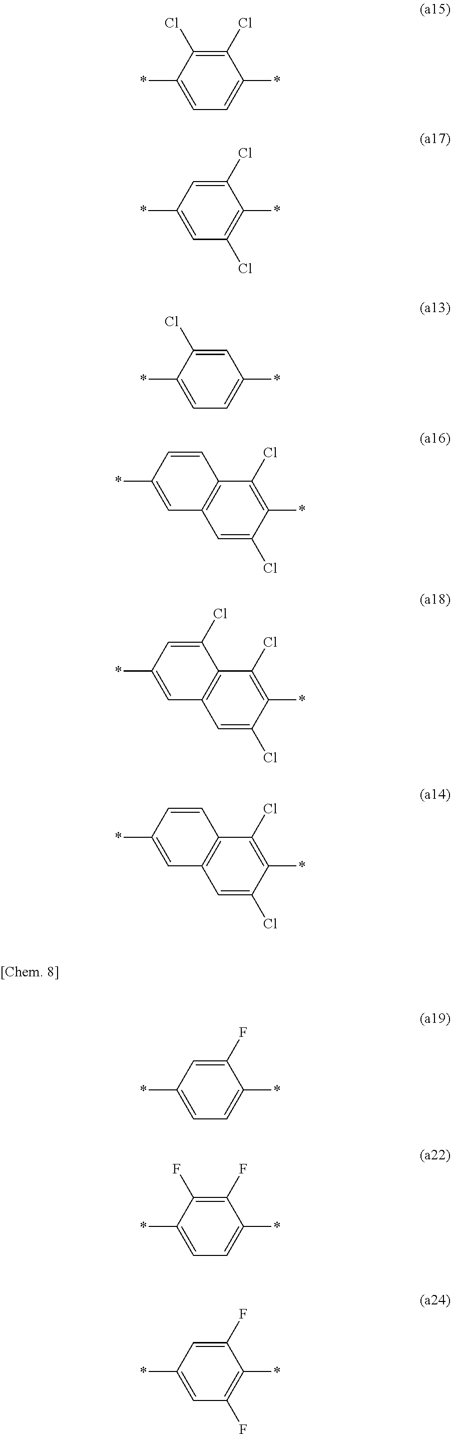

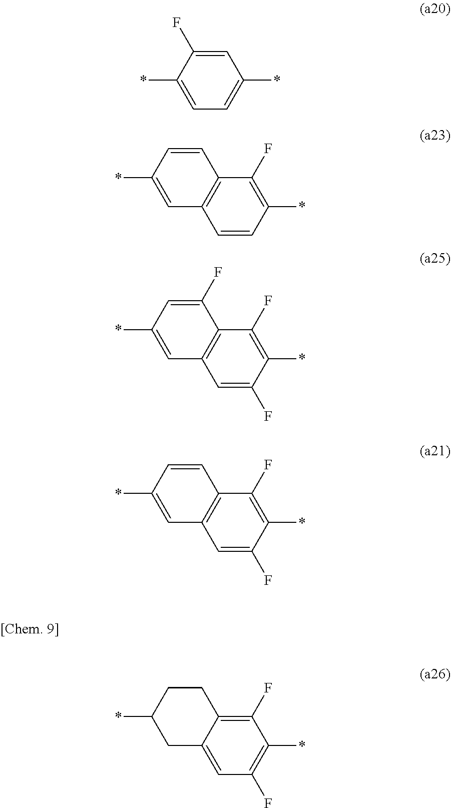

(In the above formulae, * represents a bond with a carbon atom or another atom.)

Among the above divalent cyclic groups, (a1) to (a3), (a5) to (a6), (a9) to (a10), and (a12) to (a25) are preferred, (a1) to (a3), (a5) to (a6), and (a12) to (a25) are more preferred, and (a1) to (a3) and (a12) to (a26) are even more preferred. In terms of improving Δn, (a5) to (a6), (a9) to (a10), and (a12) to (a26) are preferred, and (a1) to (a3), (a5) to (a6), and (a12) to (a26) are more preferred. In terms of further improving Δε, it is preferable that at least one or more of Aⁱ¹, Aⁱ², and Aⁱ³ have (a12), (a14), (a16), (a17), (a18), (a19), (a21), (a23), (a24), (a25), or (a26).

A plurality of Aⁱ¹s, if present, may be the same or different.

In general formula (i), Zⁱ¹ and Zⁱ² each independently represent —OCH₂—, —CH₂O—, —C₂H₄—, —C₄H₈—, —COO—, —OCO—, —CH═CH—, —CF═CF—, —CF₂O—, —OCF₂—, —CF₂CF₂—, —C≡C—, or a single bond, wherein at least one Zⁱ¹ or Zⁱ² represents —C≡C—.

When Zⁱ¹ and Zⁱ² satisfy the above condition, a linking group between the ring structures forming mesogen easily ensures molecular linearity.

Since at least one of Zⁱ¹ and mⁱ¹ Zⁱ²s represents —C≡C— in general formula (i), the compound represented by general formula (i) has at least one —C≡C— in its structure.

Preferably, Zⁱ¹ and Zⁱ² are independently a single bond, —C≡C—, —CH═CH—, or —CF═CF—. Zⁱ¹ and Zⁱ² are preferably each independently a single bond when the stability of the liquid crystal composition is important, and preferably —C≡C— when Δn is important.

A plurality of Zⁱ¹s, if present, may be the same or different.

mⁱ¹ represents 1 or 2, and preferably 1. When mⁱ¹ is 1 or 2, the compound represented by general formula (i) corresponds to a tricyclic or tetracyclic liquid crystal compound and exhibits high miscibility with other liquid crystal compounds.

Aⁱ¹, Aⁱ², and Aⁱ³, which are ring structures in a molecule of the compound represented by general formula (i) in the present invention, preferably have 1 to 5 fluorine atoms in total, and more preferably have 1 to 4 fluorine atoms.

Aⁱ¹, Aⁱ², and Aⁱ³, which are ring structures in a molecule of the compound represented by general formula (i) in the present invention, preferably have 0 to 3 halogen atoms (other than fluorine atoms) in total, and more preferably have 0 to 2 halogen atoms.

Aⁱ¹, Aⁱ², and Aⁱ³, which are ring structures in a molecule of the compound represented by general formula (i) in the present invention, preferably have 1 to 5 halogen atoms (including fluorine atoms) in total, and more preferably have 1 to 4 halogen atoms.

The compound represented by general formula (i) in the present invention has a cyano group bonded to Aⁱ³. In addition to the cyano group, Aⁱ¹, Aⁱ², and Aⁱ³ which are ring structures in a molecule may have 1 to 3 cyano groups in total.

In the liquid crystal composition according to the present invention, the compounds represented by general formula (i) may be used singly or in combination of two or more. The kinds of compounds that can be combined are not limited, and the compounds are used in appropriate combinations according to the desired performance, such as dielectric constant anisotropy, solubility at room temperature, transition temperature, and birefringence index. For example, one kind of liquid crystal compound is used in one embodiment of the present invention. Alternatively, in another embodiment of the present invention, two kinds, three kinds, four kinds, five kinds, six kinds, seven kinds, eight kinds, nine kinds, or ten or more kinds are used.

The lower limit (% by mass) of the preferred amount of the compound represented by general formula (i) in the total amount of the liquid crystal composition of the present invention is 1%, 2%, 5%, 8%, 10%, 13%, 15%, 18%, 20%, 22%, 25%, 30%, 40%, 50%, 55%, 60%, 65%, and 70%. In terms of preventing inconvenience such as precipitation, the upper limit of the preferred amount is 85%, 80%, 75%, 70%, 65%, 55%, 45%, 35%, 30%, 28%, 25%, 23%, 20%, 18%, and 15%.

A preferred form of the compound represented by general formula (i) of the present invention is a compound in which, in general formula (i), Rⁱ¹ is a linear alkyl group or alkoxy group having 1 to 8 carbon atoms, a linear alkenyl group or alkenyloxy group having 2 to 8 carbon atoms, Aⁱ¹, Aⁱ², and Aⁱ³ are the above formulae (a1) to (a3), (a19), or (a24), Zⁱ¹ and Zⁱ² are each independently a single bond, —COO—, or —C≡C—, and Zⁱ¹ or Zⁱ² is —C≡C—, and mⁱ¹ represents 1. The preferred amount of the compound represented by general formula (i) is preferably 5 to 85% by mass, more preferably 10 to 83% by mass, and particularly preferably 13 to 80% by mass of the entire liquid crystal composition (100% by mass).

The compound represented by general formula (i) is preferably a compound represented by general formula (i-1) below.

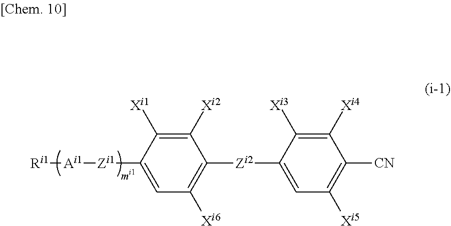

(In general formula (i-1), Rⁱ¹, Aⁱ¹, Zⁱ¹, Zⁱ², and mⁱ¹ respectively have the same meaning as Rⁱ¹, Aⁱ¹, Zⁱ¹, Zⁱ², and mⁱ¹ in general formula (i), and Xⁱ¹ to Xⁱ⁶ each independently represent a hydrogen atom or a fluorine atom, wherein Xⁱ¹ and Xⁱ² do not simultaneously represent a fluorine atom, and Xⁱ³ and Xⁱ⁴ do not simultaneously represent a fluorine atom.)

Rⁱ¹, Aⁱ¹, Zⁱ¹, Zⁱ², and mⁱ¹ in general formula (i-1) are the same as Rⁱ¹, Aⁱ¹, Zⁱ¹, Zⁱ², and mⁱ¹ in general formula (i) and are not further elaborated here.

In Xⁱ¹ to Xⁱ⁶, Xⁱ¹ and Xⁱ² do not simultaneously represent a fluorine atom, and Xⁱ³ and Xⁱ⁴ do not simultaneously represent a fluorine atom, whereby the liquid crystal compound represented by general formula (i) easily exhibits a dielectric constant anisotropy (Δε) of 0 or more.

In terms of increasing the positive value of the dielectric constant anisotropy, preferably, at least one or more of Xⁱ², Xⁱ⁴, Xⁱ⁵, and Xⁱ⁶ represents a fluorine atom. Introducing a halogen atom such as a fluorine atom at the lateral position of the ring structure is preferred because if so, the miscibility is improved. The use of the compound represented by general formula (i-1) easily ensures storage stability at room temperature.

mⁱ¹ Aⁱ¹s and two benzene rings, which are ring structures in a molecule of the compound represented by general formula (i-1) in the present invention, preferably have 1 to 5 fluorine atoms in total, and more preferably have 1 to 4 fluorine atoms.

mⁱ¹ Aⁱ¹s, which are ring structures in a molecule of the compound represented by general formula (i-1) in the present invention, preferably have 0 to 3 halogen atoms (other than fluorine atoms) in total, and more preferably have 0 to 2 halogen atoms.

mⁱ¹ Aⁱ¹s and two benzene rings, which are ring structures in a molecule of the compound represented by general formula (i-1) in the present invention, preferably have 1 to 5 halogen atoms (including fluorine atoms) in total, and more preferably have 1 to 4 halogen atoms.

mⁱ¹ Aⁱ¹s, which are ring structures in a molecule of the compound represented by general formula (i-1) in the present invention, preferably have 0 to 3 cyano groups in total, and more preferably have 0 to 2 cyano groups.

Examples of a preferred form of the compounds represented by general formula (i) and general formula (i-1) include compounds represented by general formulae (i-1-a) to (i-1-d) below.

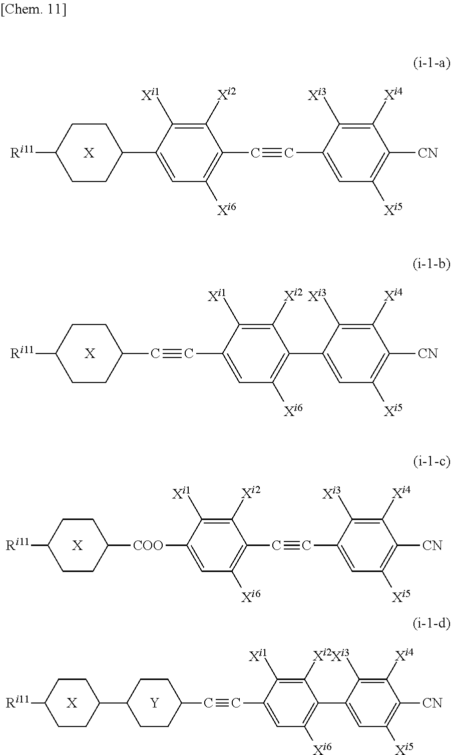

In general formulae (i-1-a) to (i-1-d), Rⁱ¹¹ represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, the ring X and the ring Y each independently represent a divalent cyclic group represented by formulae (a1) to (a26), and Xⁱ¹, Xⁱ², Xⁱ³, Xⁱ⁴, Xⁱ⁵, and Xⁱ⁶ each independently represent a hydrogen atom or a fluorine atom.

In general formulae (i-1-a) to (i-1-d), more preferably, the ring X and the ring Y are each independently (a1) to (a3), (a19), or (a24).

In general formulae (i-1-a) to (i-1-d), Rⁱ¹ is preferably an alkyl group having 1 to 8 carbon atoms in terms of reliability. Among the compounds above, (i-1-a), (i-1-b), and (i-1-c) are preferred.

Examples of a preferred form of the compounds represented by general formula (i) and general formula (i-1) include a compound represented by general formula (i-1-1) below. The compound represented by general formula (i-1-1) has a relatively high Δn and favorable miscibility. Because of this, a liquid crystal composition stable at room temperature can be obtained.

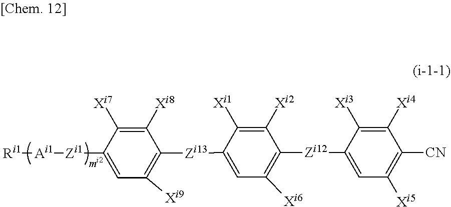

(In general formula (i-1-1), Rⁱ¹, Xⁱ¹ to Xⁱ⁶, and Aⁱ¹ respectively have the same meaning as Rⁱ¹, Xⁱ¹ to Xⁱ⁶, and Aⁱ¹ in general formula (i) or general formula (i-1),

Xⁱ⁷, Xⁱ⁸, and Xⁱ⁹ each independently represent a hydrogen atom or a fluorine atom, wherein Xⁱ⁷ and Xⁱ⁸ do not simultaneously represent a fluorine atom,

Zⁱ¹² represents a single bond or —C≡C—,

Zⁱ¹³ represents a single bond or —C≡C—, wherein at least one Zⁱ² or Zⁱ³ represents —C≡C—, and

mⁱ² represents 0 or 1.)

In general formula (i-1-1), Rⁱ¹, Xⁱ¹ to Xⁱ⁶, and Aⁱ¹ are the same as Rⁱ¹, Xⁱ¹ to Xⁱ⁶, and Aⁱ¹ and Zⁱ¹ in general formula (i) or general formula (i-1) and are not further elaborated here.

In general formula (i-1-1), Xⁱ⁷ and Xⁱ⁸ do not simultaneously represent a fluorine atom, whereby the liquid crystal compound represented by general formula (i-1-1) easily exhibits a dielectric constant anisotropy (Δε) of 0 or more.

In terms of stability of the liquid crystal composition, preferably, one of Zⁱ¹² and Zⁱ¹³ represents —C≡C— and the other represents a single bond.

In the compound represented by general formula (i-1-1) according to the present invention, preferably, at least one of Xⁱ¹ to Xⁱ⁷ is a fluorine atom. That is, in a molecule of the compound represented by general formula (i-1-1) in the present invention, the benzene ring has a total of one or two or more fluorine atoms that are electron-withdrawing groups. Thus, the compound represented by general formula (i-1-1) more easily exhibits positive dielectric constant anisotropy, and introducing a halogen atom such as a fluorine atom at the lateral position of the ring structure is preferred because if so, the miscibility is improved. The use of the compound represented by general formula (i-1-1) easily ensures storage stability at room temperature.

Aⁱ¹ and three benzene rings, which are ring structures in a molecule of the compound represented by general formula (i-1-1) in the present invention, preferably have 1 to 5 halogen atoms (including fluorine atoms) in total, and more preferably have 1 to 4 halogen atoms.

As specific structures of general formula (i) according to the present invention, tricyclic or tetracyclic liquid crystal compounds represented by general formulae (i.1) to (i.26) below are preferred. Tricyclic compounds are more preferred in terms of further improving the miscibility of the liquid crystal composition. In the liquid crystal composition according to the present invention, the compounds represented by general formulae (i.1) to (i.26) may be used singly or in combination of two or more.

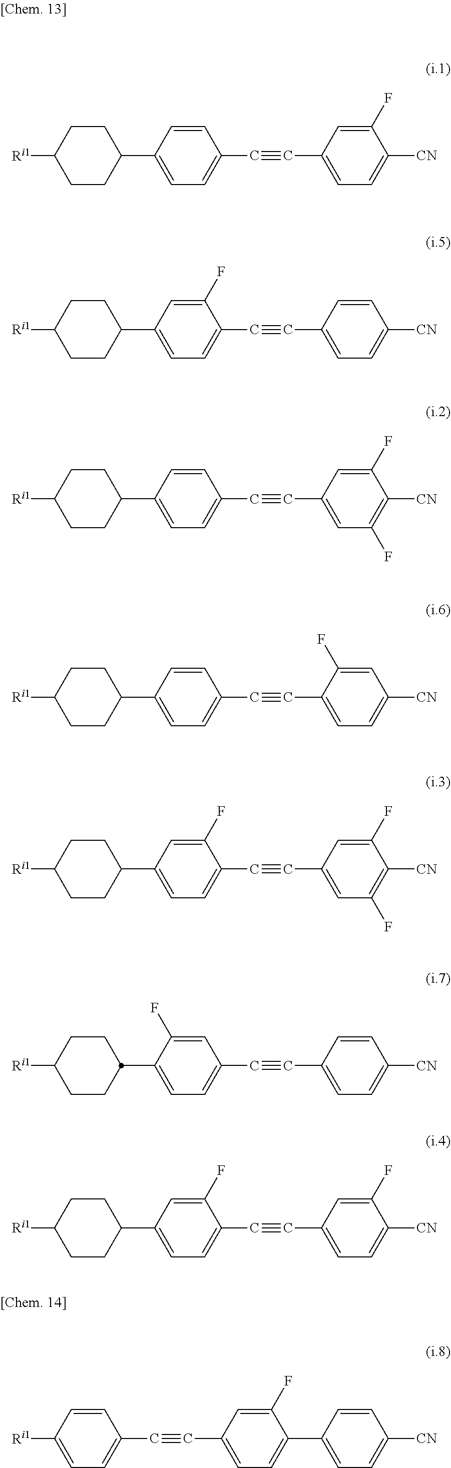

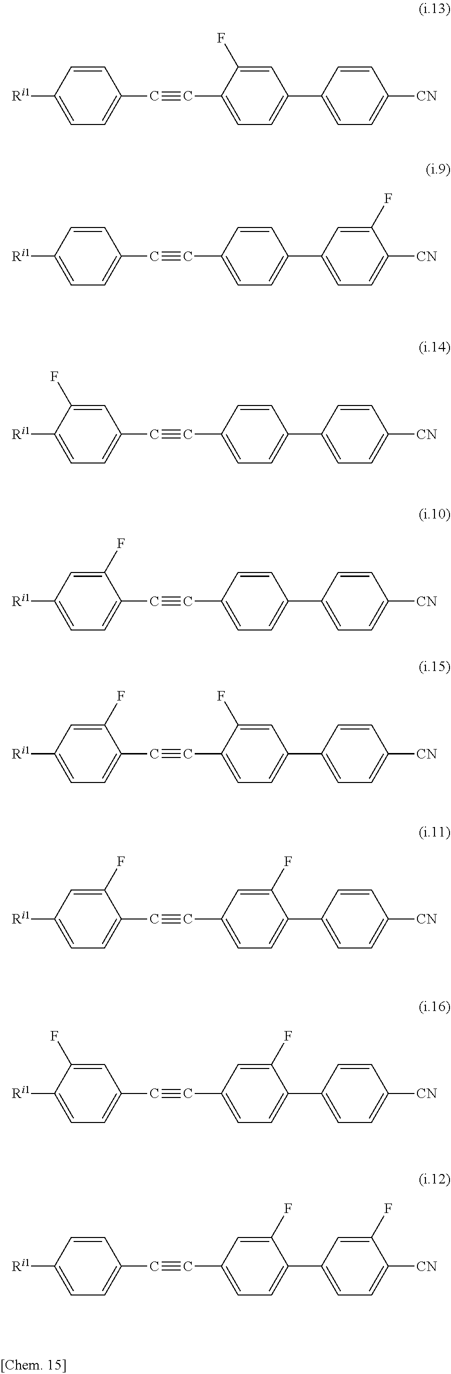

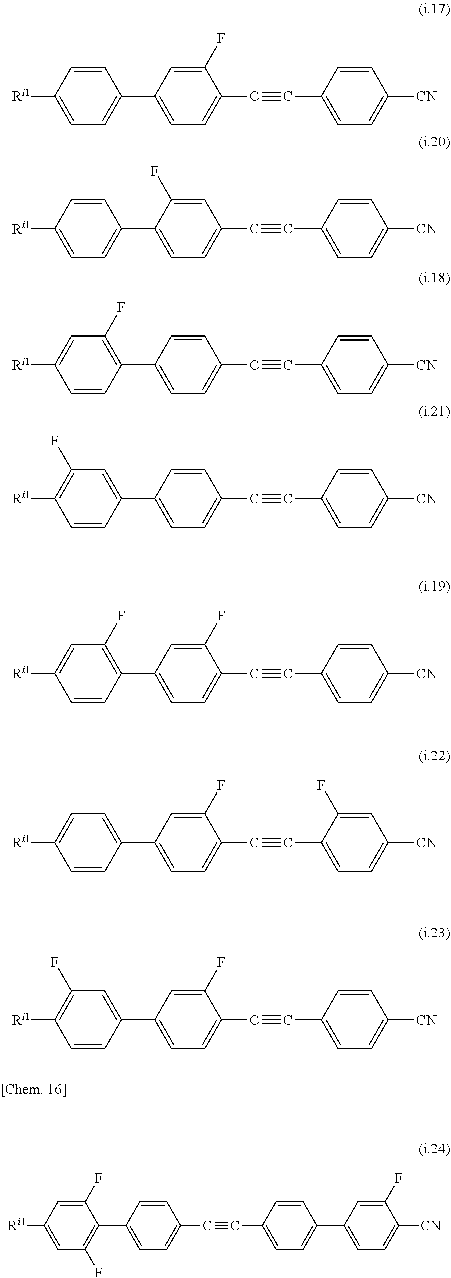

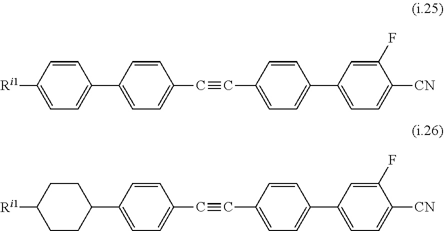

In general formulae (i.1) to (i.26), preferably, Rⁱ¹ represents an alkyl group having 1 to 6 carbon atoms, an alkenyl group having 1 to 6 carbon atoms, an alkoxy group having 1 to 6 carbon atoms, or an alkenyloxy group having 1 to 6 carbon atoms.

Among the compounds represented by general formulae (i.1) to (i.26), (i.8) to (i.23) are preferred.

In the liquid crystal composition according to the present invention, the preferred amount of general formula (i) can be used as the amount of each of the compounds in general formulae (i.1) to (i.26) in the entire liquid crystal composition.

Examples of a preferred form of the compounds represented by general formula (i) and general formula (i-1) include a compound represented by general formula (i-1-1a) below. The compound represented by general formula (i-1-1a) has a tolan structure and has a cyano group at a terminal of the ring structure and has a fluorine atom in Xⁱ⁴, thereby improving Δε.

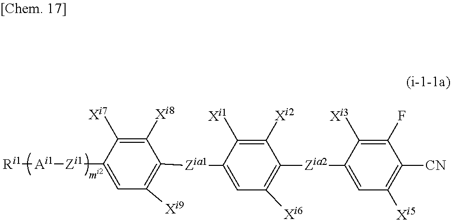

(In general formula (i-1-1a), Rⁱ¹, Aⁱ¹, Zⁱ¹, and Xⁱ¹ to Xⁱ³, Xⁱ⁵, and Xⁱ⁶ respectively have the same meaning as Rⁱ¹, Aⁱ¹, Zⁱ¹, Xⁱ¹ to Xⁱ³, Xⁱ⁵, and Xⁱ⁶ in general formula (i-1),
mⁱ² represents 0 or 1,
Z^{ia1} and Z^{ia2} each independently represent a single bond or —C≡C—, wherein at least one of these represents —C≡C—,
Xⁱ⁷ to Xⁱ⁹ each independently represent a hydrogen atom or a fluorine atom, wherein Xⁱ⁷ and Xⁱ⁸ do not simultaneously represent a fluorine atom, and
in general formula (i-1-1a), at least one of Xⁱ², Xⁱ⁵, Xⁱ⁶, Xⁱ⁸, and Xⁱ⁹ represents a fluorine atom.)

In general formula (i-1-1a), Rⁱ¹, Aⁱ¹, Zⁱ¹, and Xⁱ¹ to Xⁱ³, Xⁱ⁵, and Xⁱ⁶ are the same as Rⁱ¹, Aⁱ¹, Zⁱ¹, and Xⁱ¹ to Xⁱ³, Xⁱ⁵, and Xⁱ⁶ in general formula (i) or general formula (i-1) and are not further elaborated here.

In terms of stability of the liquid crystal composition, preferably, one of Z^{ia1} and Z^{ia2} represents —C≡C— and the other represents a single bond.

Aᵢ₁ and three benzene rings, which are ring structures in a molecule of the compound represented by general formula (i-1-1a) in the present invention, preferably have 1 to 5 halogen atoms (including fluorine atoms) in total, and more preferably have 1 to 4 halogen atoms.

As specific structures of general formula (i) and general formula (i-1-1a) according to the present invention, tricyclic or tetracyclic liquid crystal compounds represented by general formulae (i.27) to (i.44) below are preferred. Tricyclic compounds are more preferred in terms of further improving the miscibility of the liquid crystal composition. In the liquid crystal composition according to the present invention, the compounds represented by general formulae (i.27) to (i.44) may be used singly or in combination of two or more.

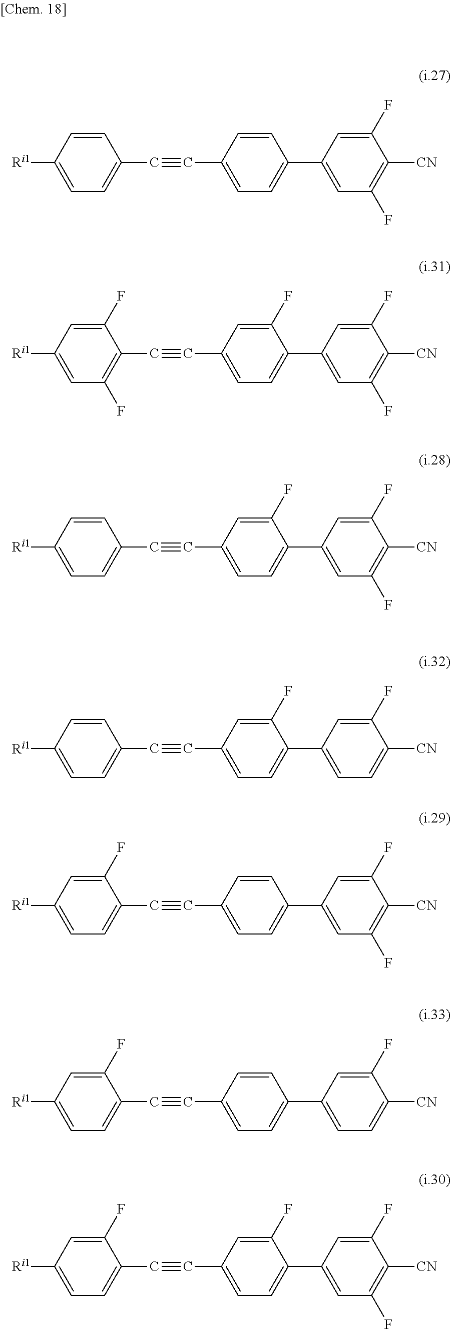

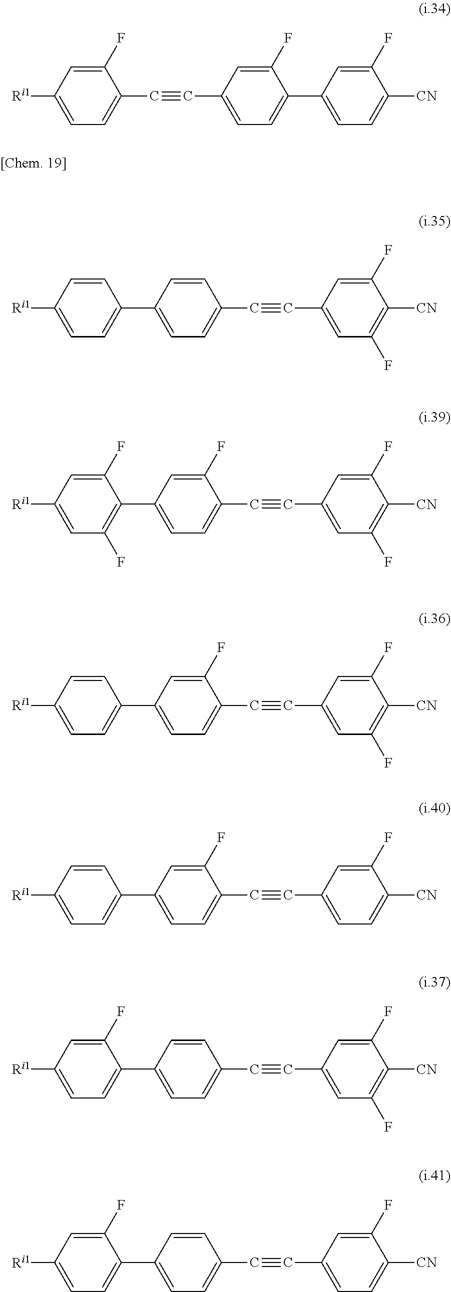

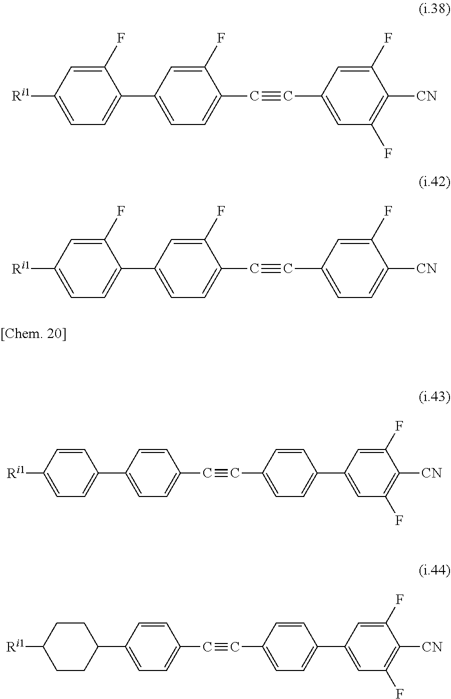

In general formulae (i.27) to (i.44), Rⁱ¹ has the same meaning as Rⁱ¹ in general formula (i) but preferably represents an alkyl group having 1 to 6 carbon atoms, an alkenyl group having 1 to 6 carbon atoms, an alkoxy group having 1 to 6 carbon atoms, or an alkenyloxy group having 1 to 6 carbon atoms.

Among the compounds represented by general formulae (i.27) to (i.44), (i.27) to (i.34) are preferred.

In the liquid crystal composition according to the present invention, the preferred amount of general formula (i) can be used as the amount of each of the compounds in general formulae (i.27) to (i.44) in the entire liquid crystal composition.

The compound represented by general formula (i-1-1a) can be produced by a known method and can be produced, for example, by the following method.

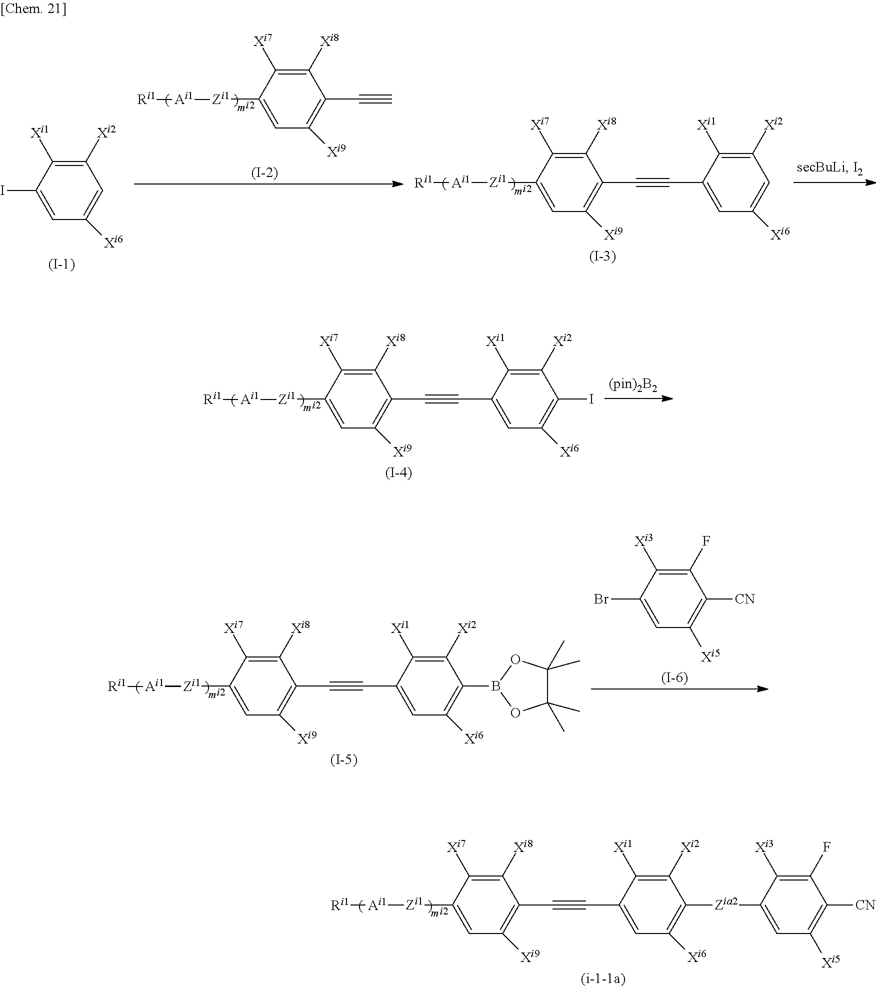

(In the formulae, Rⁱ¹, Aⁱ¹, Zⁱ¹, Xⁱ¹ to Xⁱ³, and Xⁱ⁵ to Xⁱ⁹ respectively have the same meaning as Rⁱ¹, Aⁱ¹, Zⁱ¹, Xⁱ¹ to Xⁱ³, and Xⁱ⁵ to Xⁱ⁹ in general formula (i-1-1a).)

The compound represented by general formula (I-1) is allowed to react with the compound represented by general formula (I-2) to yield the compound represented by general formula (I-3). Examples of the reaction method include the Sonogashira coupling reaction using a palladium catalyst, a copper catalyst, and a base. Specific examples of the palladium catalyst include those listed above. Specific examples of the copper catalyst include copper(I) iodide. Specific examples of the base include triethylamine.

The compound represented by general formula (I-3) is allowed to reach with, for example, sec-butyllithium and iodine to yield the compound represented by general formula (I-4).

The compound represented by general formula (I-4) is allowed to react with, for example, bis(pinacolato)diboron to yield the compound represented by general formula (I-5).

The compound represented by general formula (I-6) is allowed to react with the compound represented by general formula (I-5) to yield the compound represented by general formula (i-1-1a). Examples of the reaction method include cross-coupling in the presence of a metal catalyst and a base. Specific examples of the metal catalyst include [1,1′-bis(diphenylphosphino)ferrocene]palladium(II) dichloride, palladium(II) acetate, dichlorobis[di-tert-butyl(p-dimethylaminophenyl)phosphino]palladium(II), and tetrakis(triphenylphosphine)palladium(0). When palladium(II) acetate is used as the metal catalyst, a ligand such as triphenylphosphine or 2-dicyclohexylphosphino-2′,4′,6′-triisopropylbiphenyl may be added. Specific examples of the base include potassium carbonate, potassium phosphate, and cesium carbonate.

The liquid crystal composition according to the present invention contains one or two or more compounds represented by general formula (ii). The compound represented by general formula (ii) is as follows.

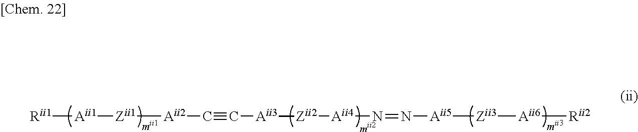

The compound represented by general formula (ii) has a high Δn. The compound represented by general formula (ii) has excellent miscibility with the compound represented by general formula (i) and can be combined with the compound represented by general formula (i) to provide a liquid crystal composition that combines a high Δn and a high Δε.

In general formula (ii), Rⁱⁱ¹ and Rⁱⁱ² each independently represent a fluorine atom, a chlorine atom, a cyano group, or an alkyl group having 1 to 12 carbon atoms, wherein one or two or more non-adjacent —CH₂-'s in the alkyl group are each independently optionally substituted with —CH═CH—, —C≡C—, —O—, —CO—, —COO—, or —OCO—, and one or two or more hydrogen atoms in Rⁱⁱ¹ and Rⁱⁱ² are each independently optionally substituted with a fluorine atom, wherein Rⁱⁱ¹ and Rⁱⁱ² do not simultaneously represent a substituent selected from a fluorine atom, a chlorine atom, and a cyano group.

In general formula (ii), Rⁱⁱ¹ is preferably an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, preferably an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, even more preferably an alkyl group having 1 to 5 carbon atoms or an alkenyl group having 2 to 5 carbon atoms, and even more preferably an alkyl group having 2 to 5 carbon atoms or an alkenyl group having 2 to 3 carbon atoms.

When the reliability is important, Rⁱⁱ¹ is preferably an alkyl group. When lower viscosity is important, Rⁱⁱ¹ is preferably an alkenyl group.

When the ring structure to which Rⁱⁱ¹ is bonded is a phenyl group (aromatic group), a linear alkyl group having 1 to 5 carbon atoms, a linear alkoxy group having 1 to 4 carbon atoms, and an alkenyl group having 4 to 5 carbon atoms are preferred. When the ring structure to which Rⁱⁱ¹ is bonded is a saturated ring structure such as cyclohexane, pyran, and dioxane, a linear alkyl group having 1 to 5 carbon atoms, a linear alkoxy group having 1 to 4 carbon atoms, and a linear alkenyl group having 2 to 5 carbon atoms are preferred. To stabilize the nematic phase, Rⁱⁱ¹ preferably has a total number of carbon atoms and, if present, oxygen atoms of 5 or less and preferably is linear.

Here, the alkenyl group is preferably selected from groups represented by any of formulae (R1) to (R5) above.

Rⁱⁱ² is preferably a fluorine atom, a cyano group, a trifluoromethyl group, or a trifluoromethoxy group when the compound represented by general formula (ii) is what is called a p-type compound with a positive Δε, and a fluorine atom or a cyano group is preferred.

When the compound represented by general formula (ii) is what is called a nonpolar compound in which Δε is almost zero, Rⁱⁱ² has the same meaning as Rⁱⁱ¹, wherein Rⁱⁱ² and Rⁱⁱ¹ may be the same or different.

In general formula (ii), Zⁱⁱ¹, Zⁱⁱ², and Zⁱⁱ³ each independently represent a single bond, OCH₂—, —CH₂O—, —C₂H₄—, —C₄H₈—, —COO—, —OCO—, —CH═CH—, —CF═CF—, —CF₂O—, —OCF₂—, —CF₂CF₂, or —C≡C—.

Here, Zⁱⁱ¹ to Zⁱⁱ³ are preferably single bonds.

In general formula (ii), Aⁱⁱ¹, Aⁱⁱ², Aⁱⁱ³, Aⁱⁱ⁴, Aⁱⁱ⁵, and Aⁱⁱ⁶ each independently represent a group selected from the group consisting of the following groups (a) to (c).

(a) a 1,4-cyclohexylene group (one —CH₂— or two or more non-adjacent —CH₂-'s in this group are optionally substituted with —O—.)

(b) a 1,4-phenylene group (one —CH═ or two or more non-adjacent —CH='s in this group are optionally substituted with —N═.)

(c) a naphthalene-1,4-diyl group, a naphthalene-2,6-diyl group, a 1,2,3,4-tetrahydronaphthalene-2,6-diyl group, or a decahydronaphthalene-2,6-diyl group (one —CH═ or two or more non-adjacent —CH='s in the naphthalene-1,4-diyl group, the naphthalene-2,6-diyl group, or the 1,2,3,4-tetrahydronaphthalene-2,6-diyl group are optionally substituted with —N═.)

One or two or more hydrogen atoms in the group (a), the group (b), and the group (c) are each independently optionally substituted with a halogen atom, a cyano group, or an alkyl group having 1 to 6 carbon atoms.

Aⁱⁱ¹ to Aⁱⁱ⁶ are each independently preferably aromatic when a higher Δn is required, and preferably aliphatic in order to improve the response speed, and each independently preferably represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, and more preferably represent the following structure:

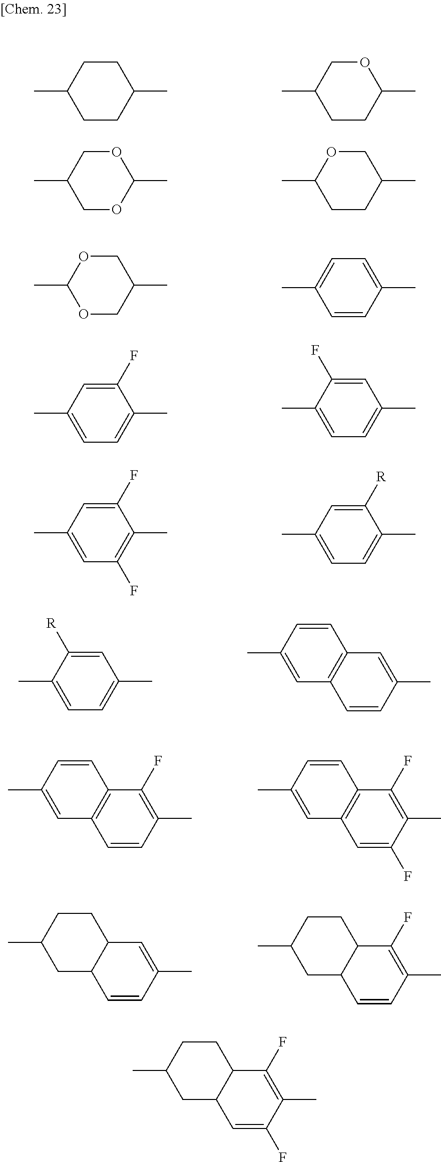

(R represents an alkyl group having 1 to 6 carbon atoms.) particularly preferably a 1,4-phenylene group, a naphthalene-2,6-diyl group, and a tetrahydronaphthalene-2,6-diyl group, wherein one or two or more hydrogens in the 1,4-phenylene group, the naphthalene-2,6-diyl group, and the tetrahydronaphthalene-2,6-diyl group are each independently optionally substituted with a fluorine atom or an alkyl group having 1 to 6 carbon atoms.

Aⁱⁱ² preferably represents a group selected from the group consisting of the following groups (d) to (f):

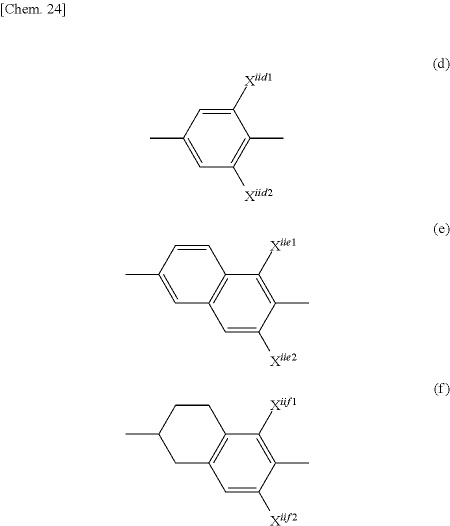

(X^{iid1}, X^{iid2}, X^{iie1}, X^{iie2}, X^{iif1}, and X^{iif2} each independently represent a hydrogen atom or a fluorine atom)

in terms of improving Δn. The group (f) is preferred in terms of miscibility with other liquid crystal compounds.

In order to enhance the miscibility with other liquid crystal compositions, at least one of Aⁱⁱ¹ to Aⁱⁱ⁶ preferably represents a 1,4-phenylene group substituted with an alkyl group having 1 to 6 carbon atoms, and more preferably represents a 1,4-phenylene group substituted with an ethylene group.

In general formula (ii), mⁱⁱ¹, mⁱⁱ², and mⁱⁱ³ each independently represent 0 or 1, where mⁱⁱ¹+mⁱⁱ²+mⁱⁱ³ represents 0 or 1.

Here, mⁱⁱ¹ is preferably 0 when the solubility in the liquid crystal composition is important, and preferably 1 when Δn and Tni are important.

Preferably, mⁱⁱ¹+mⁱⁱ²+mⁱⁱ³ is 0.

Aⁱ¹ to Aⁱ⁶, which are ring structures in a molecule of the compound represented by general formula (ii) in the present invention, preferably have 1 to 5 fluorine atoms in total, and more preferably have 1 to 4 fluorine atoms.

Aⁱ¹ to Aⁱ⁶, which are ring structures in a molecule of the compound represented by general formula (ii) in the present invention, preferably have 0 to 3 halogen atoms (other than fluorine atoms) in total, and more preferably have 0 to 2 halogen atoms.

Aⁱ¹ to Aⁱ⁶, which are ring structures in a molecule of the compound represented by general formula (ii) in the present invention, preferably have 1 to 5 halogen atoms (including fluorine atoms) in total, and more preferably have 1 to 4 halogen atoms.

In the liquid crystal composition according to the present invention, the compounds represented by general formula (ii) may be used singly or in combination of two or more. The kinds of compounds that can be combined are not limited, and the compounds are used in appropriate combinations according to the desired performance, such as dielectric constant anisotropy, solubility at room temperature, transition temperature, and birefringence index. For example, one kind of liquid crystal compound is used in one embodiment of the present invention. Alternatively, in another embodiment of the present invention, two kinds, three kinds, four kinds, five kinds, six kinds, seven kinds, eight kinds, nine kinds, or ten or more kinds are used.

The lower limit (% by mass) of the preferred amount of the compound represented by general formula (ii) in the total amount of the liquid crystal composition of the present invention is 1%, 2%, 5%, 8%, 10%, 13%, 15%, 18%, 20%, 22%, 25%, 30%, 40%, 50%, 55%, 60%, 65%, and 70%. In terms of preventing inconvenience such as precipitation, the upper limit of the preferred amount is 70%, 65%, 55%, 45%, 35%, 30%, 28%, 25%, 23%, 20%, 18%, and 15%.

The compound represented by general formula (ii) is preferably a compound represented by general formula (ii-1) below.

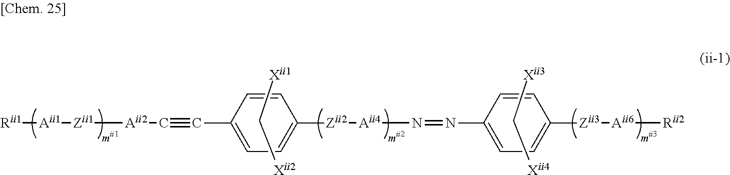

(In general formula (ii-1), Rⁱⁱ¹, Rⁱⁱ², Zⁱⁱ¹, Zⁱⁱ², Zⁱⁱ³, Aⁱⁱ¹, Aⁱⁱ⁴, Aⁱⁱ⁶, mⁱⁱ¹, mⁱⁱ², and mⁱⁱ³ respectively have the same meaning as Rⁱⁱ¹, Rⁱⁱ², Zⁱⁱ¹, Zⁱⁱ², Zⁱⁱ³, Aⁱⁱ¹, Aⁱⁱ⁴, Aⁱⁱ⁶, mⁱⁱ¹, mⁱⁱ², and mⁱⁱ³ in general formula (ii),

Aⁱⁱ² represents a group selected from the group consisting of the following groups (d) to (f):

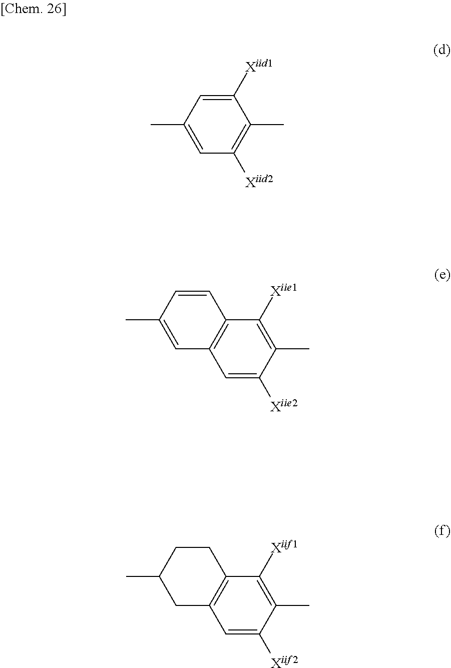

(X^{iid1}, X^{iid2}, X^{iie1}, X^{iie2}, X^{iif1}, and X^{iif2} each independently represent a hydrogen atom or a fluorine atom)

Xⁱⁱ¹, Xⁱⁱ², Xⁱⁱ³, and Xⁱⁱ⁴ each independently represent a hydrogen atom, a halogen atom, a cyano group, or an alkyl group having 1 to 6 carbon atoms.)

In general formula (ii-1), Rⁱⁱ¹, Rⁱⁱ², Zⁱⁱ¹, Zⁱⁱ², Zⁱⁱ³, Aⁱⁱ¹, Aⁱⁱ⁴, Aⁱⁱ⁶, mⁱⁱ¹, mⁱⁱ² and mⁱⁱ³ are the same as Rⁱⁱ¹, Rⁱⁱ², Zⁱⁱ¹, Zⁱⁱ², Zⁱⁱ³, Aⁱⁱ¹, Aⁱⁱ⁴, Aⁱⁱ⁶, mⁱⁱ¹, mⁱⁱ², and mⁱⁱ³ in general formula (ii) and are not further elaborated here.

X^{iid1}, X^{iid2}, X^{iie1}, X^{iie2}, X^{iif1}, and X^{iif2} each independently represent a hydrogen atom or a fluorine atom, preferably one of them is a fluorine atom in terms of improving Δε, and more preferably they all are fluorine atoms.

Preferably, at least one of Xⁱⁱ¹, Xⁱⁱ², Xⁱⁱ³, and Xⁱⁱ⁴ is a fluorine atom in terms of improving Δε. The total number of fluorine atoms of Xiii, Xⁱⁱ², Xⁱⁱ³, and Xⁱⁱ⁴ is preferably 0 to 3, and more preferably 0 to 2.

Xⁱⁱ¹, Xⁱⁱ², Xⁱⁱ³, and Xⁱⁱ⁴ are preferably an alkyl group having 1 to 6 carbon atoms in terms of miscibility, and more preferably an ethyl group.

The ring structure to which Xⁱⁱ¹ and Xⁱⁱ² are bonded and the ring structure to which Xⁱⁱ³ and Xⁱⁱ⁴ are bonded are each preferably the following structure.

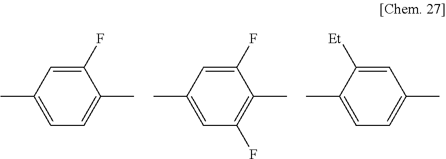

(Et represents an ethyl group.)

As specific structures of general formula (ii) according to the present invention, tricyclic or tetracyclic compounds represented by general formulae (ii.1) to (ii.38) below are preferred. Tricyclic compounds are more preferred in terms of further improving the miscibility of the liquid crystal composition. In the liquid crystal composition according to the present invention, the compounds represented by general formulae (ii.1) to (ii.38) may be used singly or in combination of two or more.

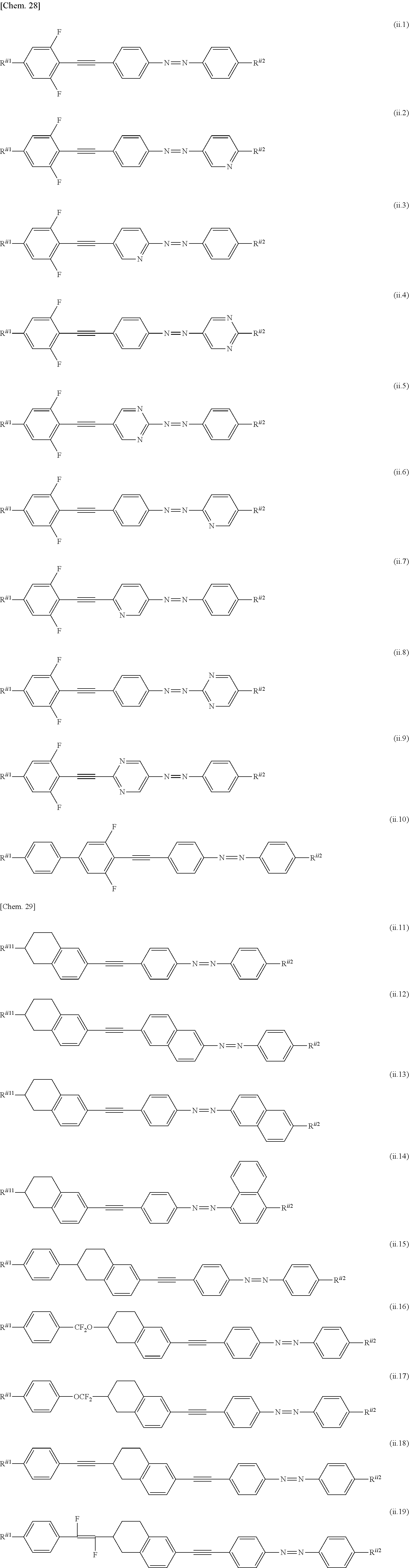

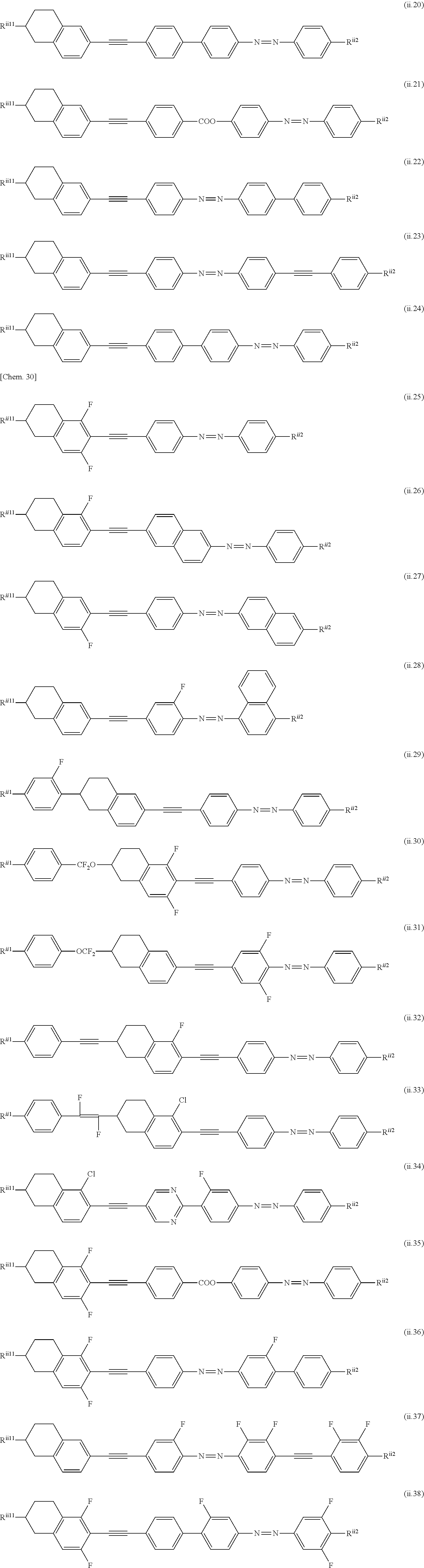

In general formula (ii.1) to general formula (ii.38), Rⁱⁱ¹ and Rⁱⁱ² each independently represent the same meaning as Rⁱⁱ¹ and Rⁱⁱ² in general formula (ii), wherein Rⁱⁱ¹ preferably represents an alkyl group having 1 to 6 carbon atoms, an alkenyl group having 1 to 6 carbon atoms, an alkoxy group having 1 to 6 carbon atoms, or an alkenyloxy group having 1 to 6 carbon atoms. Rⁱⁱ² preferably represents an alkyl group having 1 to 6 carbon atoms, an alkenyl group having 1 to 6 carbon atoms, an alkoxy group having 1 to 6 carbon atoms, an alkenyloxy group having 1 to 6 carbon atoms, a fluorine atom, or a chlorine atom.

Among the compounds represented by general formula (ii.1) to general formula (ii.38), general formulae (ii-1), (ii-10) to (ii-11), and (ii-25) to (ii-29) are preferred.

Examples of a preferred form of the compounds represented by general formula (ii) and general formula (ii-1) include a compound represented by general formula (ii-1a) below. The compound represented by general formula (ii-1a) has a tolan structure and has two or more electron-withdrawing groups represented by fluorine atoms, chlorine atoms, or cyano atoms in a molecule, thereby improving Δε.

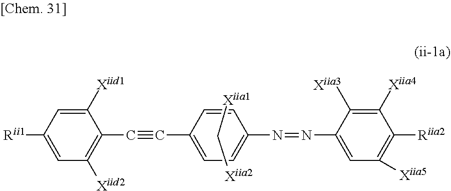

(In general formula (ii-1a), Rⁱⁱ¹, X^{iid1}, and X^{iid2} have the same meaning as Rⁱⁱ¹, X^{iid1}, and X^{iid2} in general formula (ii-1),

R^{iia2} represents a fluorine atom, a chlorine atom, a cyano group, or an alkyl group having 1 to 12 carbon atoms, wherein one or two or more non-adjacent —CH₂-'s in the alkyl group are each independently optionally substituted with —CH═CH—, —C≡C—, —O—, —CO—, —COO— or OCO—, and one or two or more hydrogen atoms in Rⁱⁱ¹ are each independently optionally substituted with a fluorine atom, wherein Rⁱⁱ¹ and R^{iia2} do not simultaneously represent a substituent selected from a fluorine atom, a chlorine atom, and a cyano group,

X^{iia1} and X^{iia2} each independently represent a hydrogen atom, a fluorine atom, or an alkyl group having 1 to 6 carbon atoms, and

X^{iia3}, X^{iia4}, and X^{iia5} each independently represent a hydrogen atom, a fluorine atom, or a chlorine atom, wherein at least one of X^{iia3}, X^{iia4}, and X^{iia5} represents a fluorine atom or a chlorine atom.)

In general formula (ii-1a), Rⁱⁱ¹, X^{iid1}, and X^{iid2} are the same as Rⁱⁱ¹, X^{iid1}, and X^{iid2} in general formula (ii) or general formula (ii-1) and are not further elaborated here.

In general formula (ii-1a), in terms of improving solubility, at least one of X^{iia1} and X^{iia2} preferably represents an alkyl group having 1 to 6 carbon atoms, and more preferably represents an ethyl group.

In general formula (ii-1a), in terms of further improving Δε, at least one or more of X^{iia3} and X^{iia4} represents a fluorine atom or a chlorine atom.

In general formula (ii-1a), when R^{iia2} represents a chlorine atom or a cyano group, preferably, X^{iia3} represents a fluorine atom.

Three benzene rings, which are ring structures in a molecule of the compound represented by general formula (ii-1a) in the present invention, preferably have 1 to 5 halogen atoms (including fluorine atoms) in total, and more preferably have 1 to 4 halogen atoms.

As specific structures of general formula (ii) and general formula (ii-1a) according to the present invention, liquid crystal compounds represented by general formulae (ii-41) to (ii-52) below are preferred. In the liquid crystal composition according to the present invention, the compounds represented by general formulae (ii-41) to (ii-54) may be used singly or in combination of two or more.

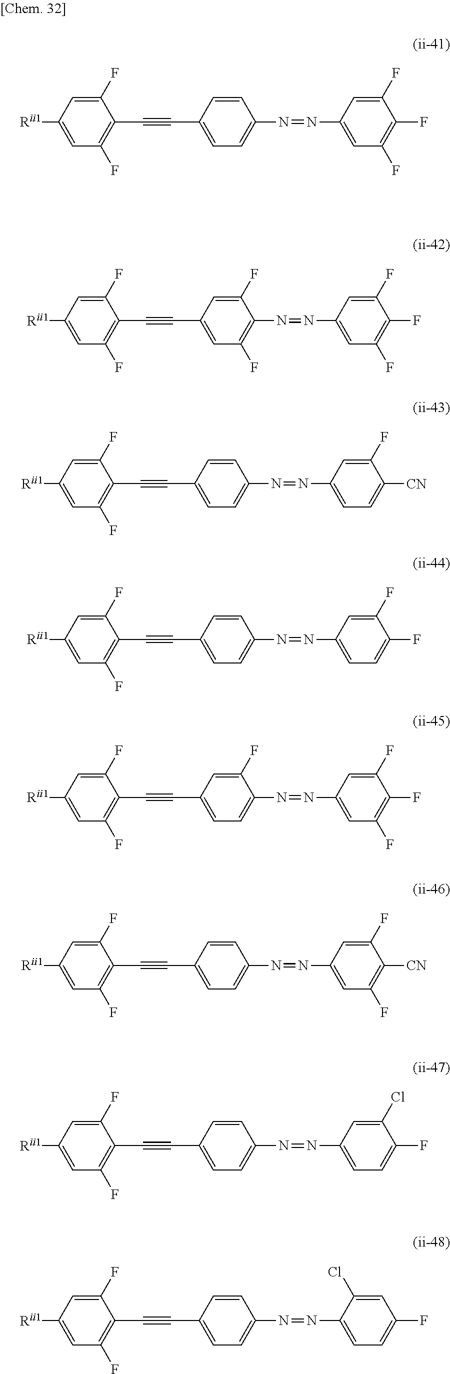

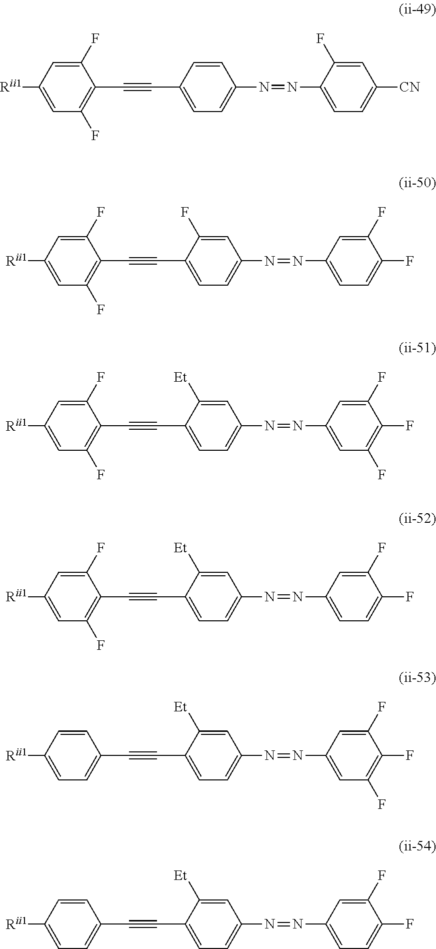

In general formula (ii-41) to general formula (ii-54), Rⁱⁱ¹ and Rⁱⁱ² each independently represent the same meaning as Rⁱⁱ¹ and Rⁱⁱ² in general formula (ii), wherein Rⁱⁱ¹ preferably represents an alkyl group having 1 to 6 carbon atoms, an alkenyl group having 1 to 6 carbon atoms, an alkoxy group having 1 to 6 carbon atoms, or an alkenyloxy group having 1 to 6 carbon atoms. Et represents an ethyl group.

In the liquid crystal composition according to the present invention, the preferred amount of general formula (ii) can be used as the amount of each of the compounds in general formula (ii-41) to general formula (ii-54) in the entire liquid crystal composition.

The compound represented by general formula (ii-1a) can be produced by a known method and can be produced, for example, by the following method.

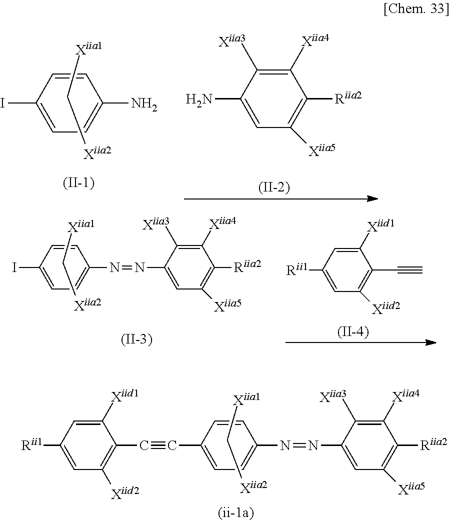

(In the formulae, Rⁱⁱ¹, R^{iia2}, X^{iia1} to X^{iia5}, X^{iid1}, and X^{iid2} respectively have the same meaning as Rⁱⁱ¹, R^{iia2}, X^{iia1} to X^{iia5}, X^{iid1}, and X^{iid2} in general formula (ii-1a).)

The compound represented by general formula (II-1) is allowed to react with the compound represented by general formula (II-2) to yield the compound represented by general formula (II-3).

The compound represented by general formula (II-3) is allowed to react with the compound represented by general formula (II-4) to yield the compound represented by general formula (ii-1a).

Examples of a preferred specific form of the compounds represented by general formula (ii) and general formula (ii-1) include compounds represented by structural formulae (ii-1.1) to (ii-1.96) below.

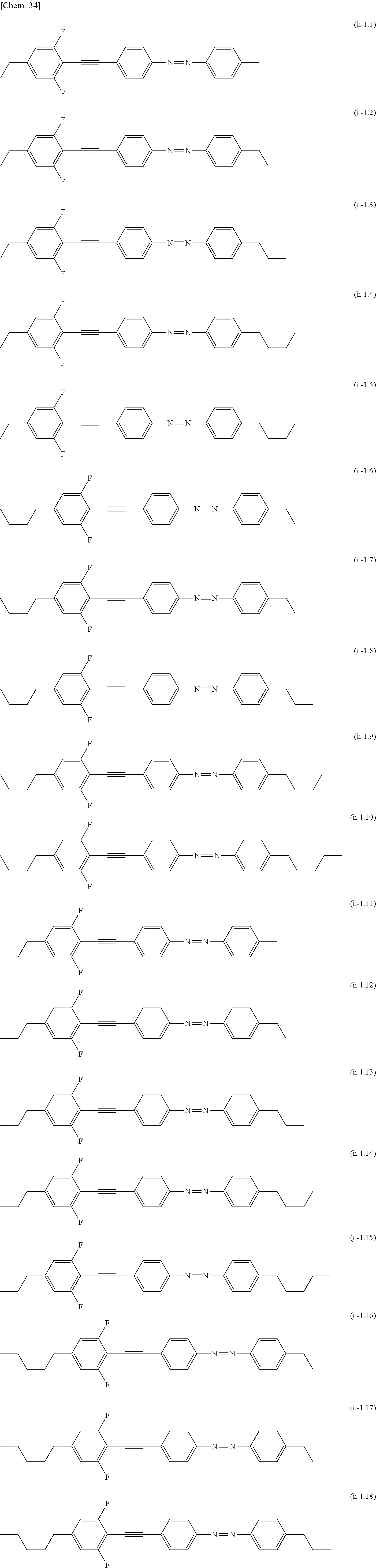

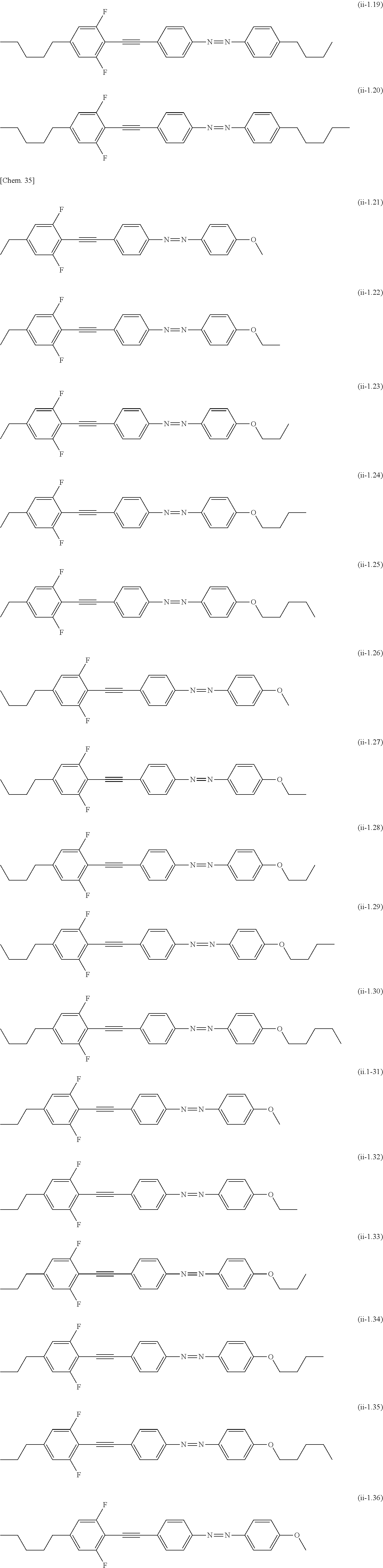

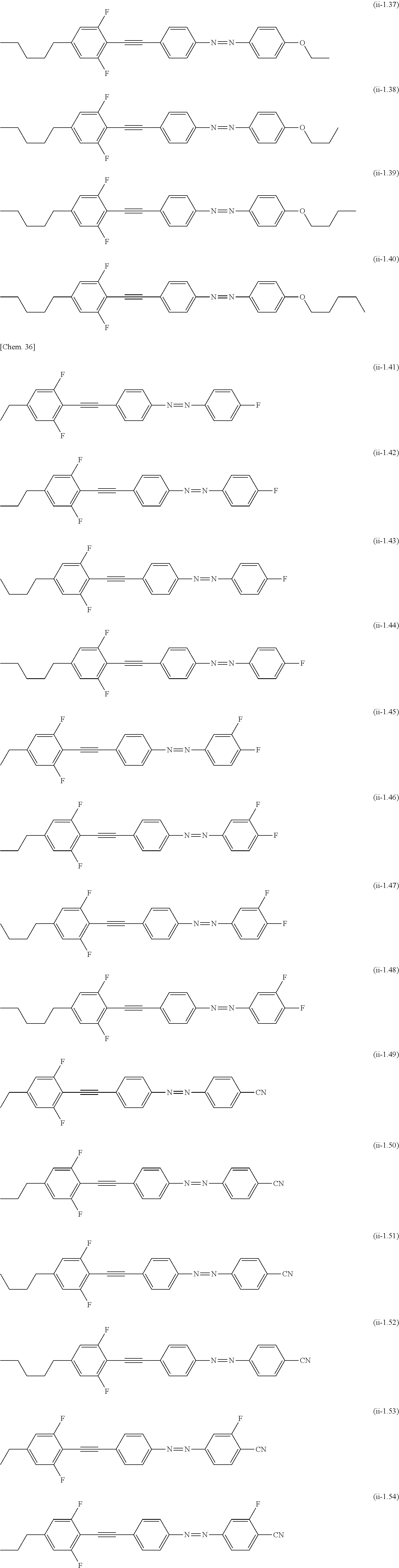

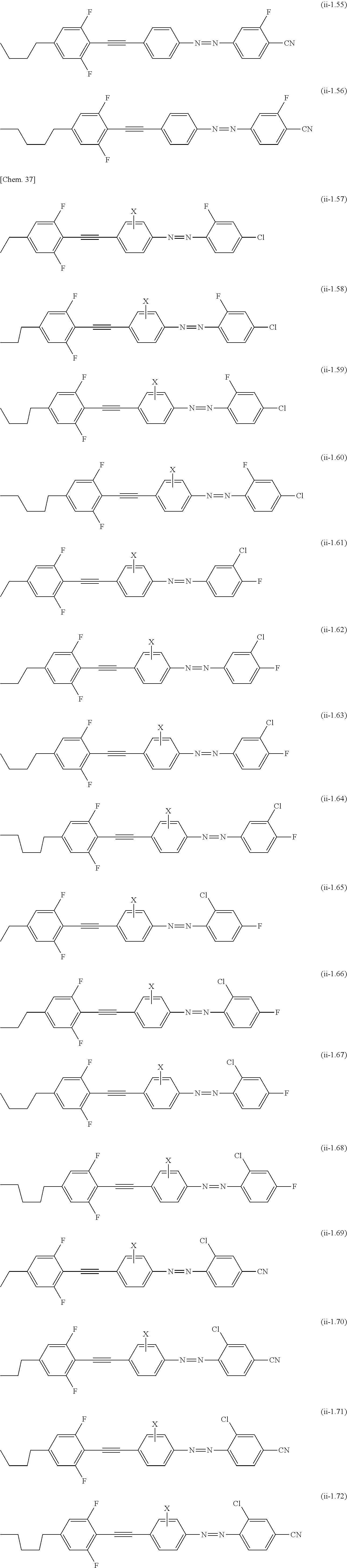

In the formulae, Xs each independently represent a hydrogen atom, a fluorine atom, or an alkyl group having 1 to 6 carbon atoms.

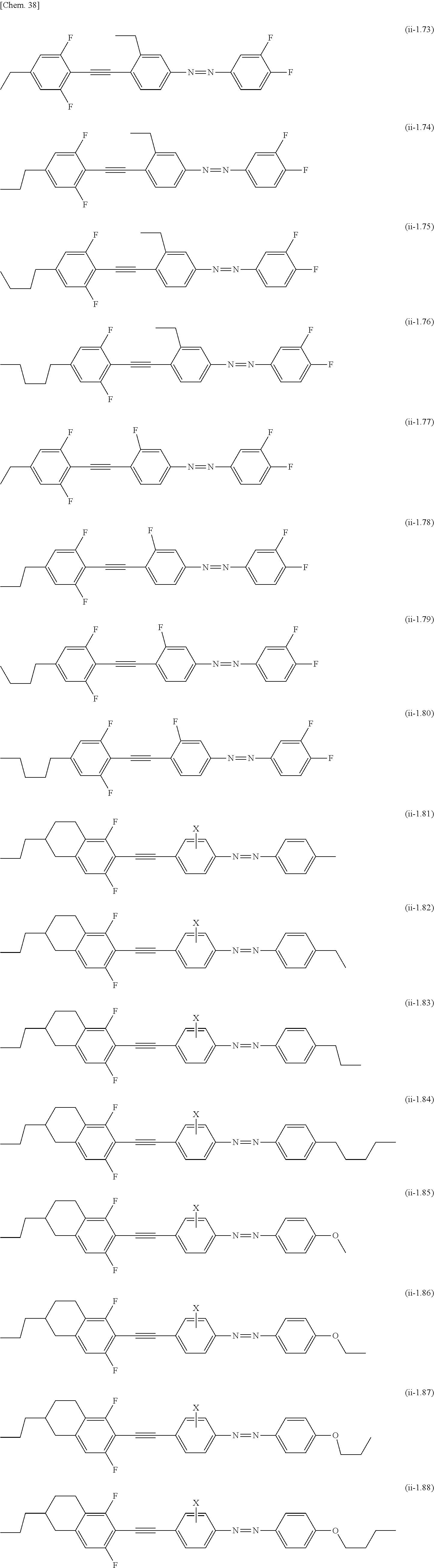

In the formulae, Xs each independently represent a hydrogen atom, a fluorine atom, or an alkyl group having 1 to 6 carbon atoms.

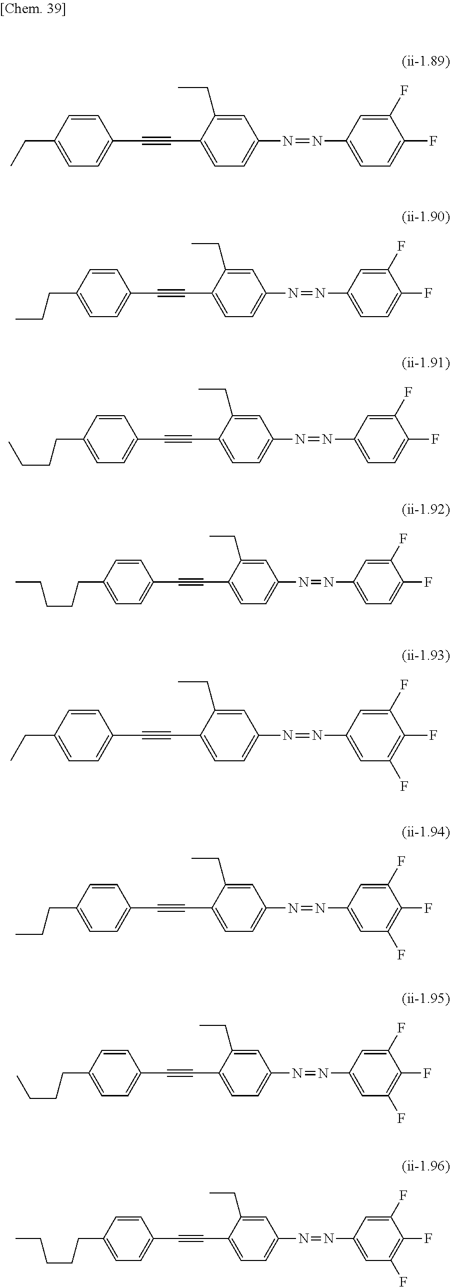

Among the compounds represented by structural formulae (ii-1.1) to (ii-1.96), (ii-1.2) to (ii-1.8), (ii-1.12) to (ii-1.18), (ii-1.22) to (ii-1.28), (ii-1.32) to (ii-1.38), and (ii-1.41) to (ii-1.96) are preferred.

In the liquid crystal composition of the present invention, if the amount of the compound represented by general formula (ii) is small, its effect is small, and therefore the lower limit of the preferred amount in the composition is 1% by mass, 2% by mass, 5% by mass, 7% by mass, 9% by mass, 10% by mass, 12% by mass, 15% by mass, 17% by mass, 20% by mass, 25% by mass, and 30% by mass. In terms of preventing inconvenience such as precipitation, the upper limit of the preferred amount is 50% by mass, 40% by mass, 30% by mass, 25% by mass, 20% by mass, 18% by mass, 15% by mass, 13% by mass, and 10% by mass.

The above is a description of the compounds represented by general formula (i) and general formula (ii), which are essential components of the liquid crystal composition of the present invention. The liquid crystal composition according to the present invention may contain, as optional components, one or two or more selected from the group consisting of compounds represented by general formulae (1a) to (1c), compounds represented by general formulae (2a) to (2c), and compounds represented by general formula (iii) The optional components of the liquid crystal composition according to the present invention will be described below.

Preferably, the liquid crystal composition according to the present invention further contains one or two or more compounds selected from general formula (1a), general formula (1b), and general formula (1c) below.

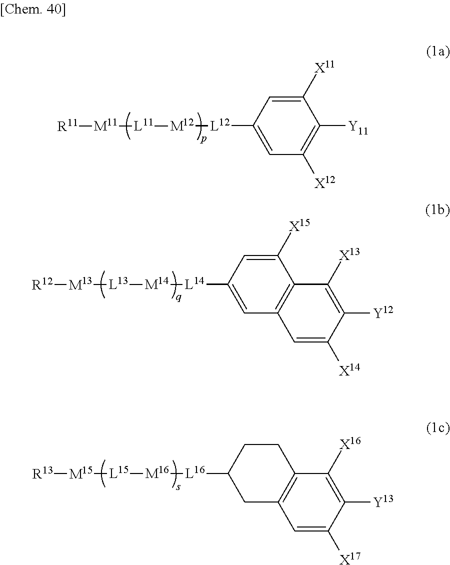

In general formulae (1a) to (1c),

R¹¹, R¹², and R¹³ each independently represent an alkyl group having 1 to 10 carbon atoms, an alkenyl group having 2 to 10 carbon atoms, or an alkynyl group having 2 to 10 carbon atoms, wherein one methylene group or two or more non-adjacent methylene groups in these groups are optionally substituted with —O— or —S—, and one or two or more hydrogen atoms in these groups are optionally substituted with a fluorine atom or a chlorine atom,

M¹¹, M¹², M¹³, M¹⁴, M¹⁵, and M¹⁶ each independently represent any one of the following group (a), group (b), or group (d),

(a) a trans-1,4-cyclohexylene group (one methylene group or two or more non-adjacent methylene groups in this group are optionally substituted with —O— or —S—),

(b) a 1,4-phenylene group (one —CH═ or two or more non-adjacent —CH='s in this group are optionally substituted with —N═), a 3-fluoro-1,4-phenylene group, or a 3,5-difluoro-1,4-phenylene group, and

(d) a 1,4-cyclohexenylene group, a 1,4-bicyclo[2.2.2]octylene group, a piperidine-2,5-diyl group, a naphthalene-2,6-diyl group, a 1,2,3,4-tetrahydronaphthalene-2,6-diyl group, or a decahydronaphthalene-2,6-diyl group,

one or two or more hydrogen atoms in the group (a), the group (b), or the group (d) are each optionally substituted with a cyano group, a fluorine atom, a chlorine atom, a trifluoromethyl group, or a trifluoromethoxy group,

L¹¹, L¹², L¹³, L¹⁴, L¹⁵, and L¹⁶ each independently represent a single bond, —COO—, —OCO—, —CH₂CH₂—, —(CH₂)₄—, —OCH₂—, —CH₂O—, —OCF₂—, —N═N—, —CF₂O—, or —C≡C—,

p, q, and s each independently represent 0, 1, or 2,

a plurality of M¹²s, M¹⁴s, M¹⁶s, L¹¹s, L¹³s, and/or L¹⁵s, if present, may be the same or different,

X¹¹, X¹², X¹³, X¹⁴, X¹⁵, X¹⁶, and X¹⁷ each independently represent a hydrogen atom or a fluorine atom, and

Y¹¹, Y¹², and Y¹³ each independently represent a fluorine atom, a chlorine atom, a cyano group (—CN), a thiocyanato group (—SCN), a cyanato group (—OCN), —C≡C—CN, a trifluoromethoxy group, a trifluoromethyl group, a 2,2,2-trifluoroethyl group, a difluoromethoxy group, an alkyl group having 1 to 10 carbon atoms, an alkenyl group having 2 to 10 carbon atoms, or an alkynyl group having 2 to 10 carbon atoms, wherein one methylene group or two or more non-adjacent methylene groups in these groups are optionally substituted with —O— or —S—, and one or two or more hydrogen atoms in these groups are optionally substituted with a fluorine atom or a chlorine atom,

provided that the compound represented by general formula (i) is excluded from the compounds represented by (1a), (1b), and (1c).

The liquid crystal composition according to the present invention preferably contains at least one or two or more compounds selected from the group consisting of the compounds represented by general formulae (1a) to (1c), and particularly preferably contains two to eight compounds. In the liquid crystal composition according to the present invention, the lower limit of the amount (100% by mass of the entire liquid crystal composition) of at least one or two or more liquid crystal compounds selected from the group consisting of the compounds represented by general formula (1a) to general formula (1c) is preferably 1% by mass, more preferably 3% by mass, and even more preferably 5% by mass. In the liquid crystal composition according to the present invention, the upper limit of the amount (100% by mass of the entire liquid crystal composition) of at least one or two or more liquid crystal compounds selected from the group consisting of the compounds represented by general formula (1a) to general formula (1c) is 60% by mass, preferably 50% by mass, preferably 40% by mass, even more preferably 30% by mass.

The liquid crystal composition according to the present invention more preferably contains at least one or two or more compounds selected from the group consisting of the compounds represented by general formula (1a) or (1b), and even more preferably contains at least one or two or more compounds selected from the group consisting of the compounds represented by general formula (1a).

The lower limit of the preferred amount (% by mass) of the compound represented by formula (1a) in the total amount of the liquid crystal composition of the present invention is 1%, 2%, 3%, 5%, 8%, 10%, 13%, 15%, 18%, 20%, 25%, 30%, and 35%. In terms of preventing inconvenience such as precipitation, the upper limit of the preferred amount is 35%, 30%, 25%, 20%, 15%, 10%, 5%, and 3%.

As a preferred form of the compounds of general formula (1a), compounds represented by general formula (1a.1) to general formula (1a.59) below are preferred.

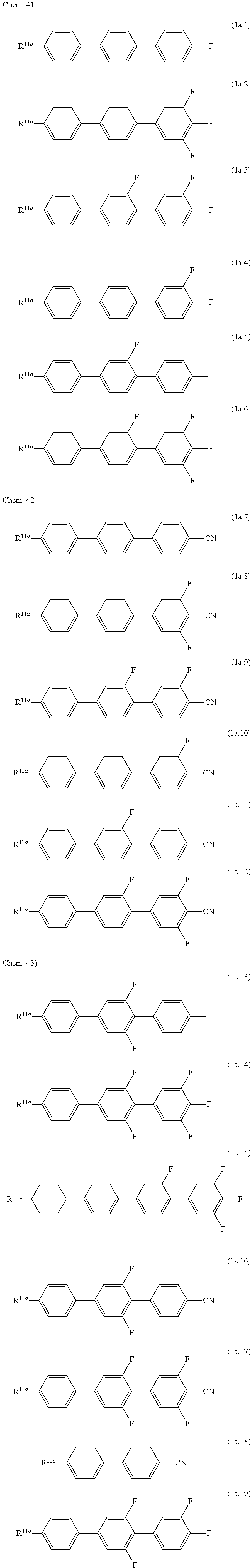

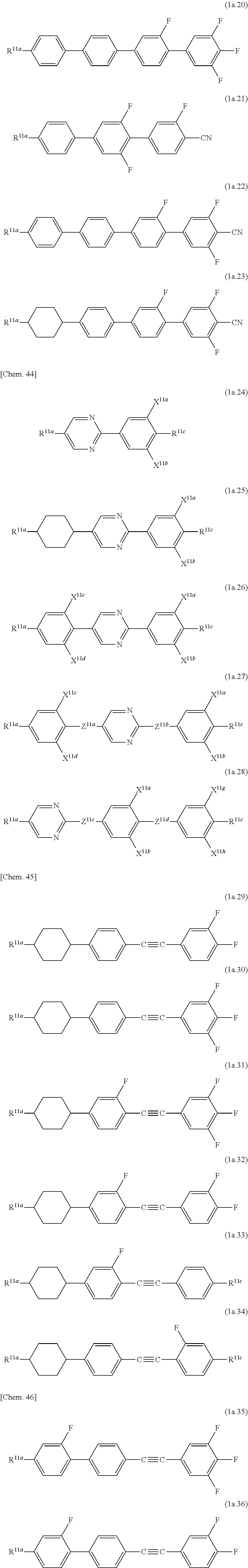

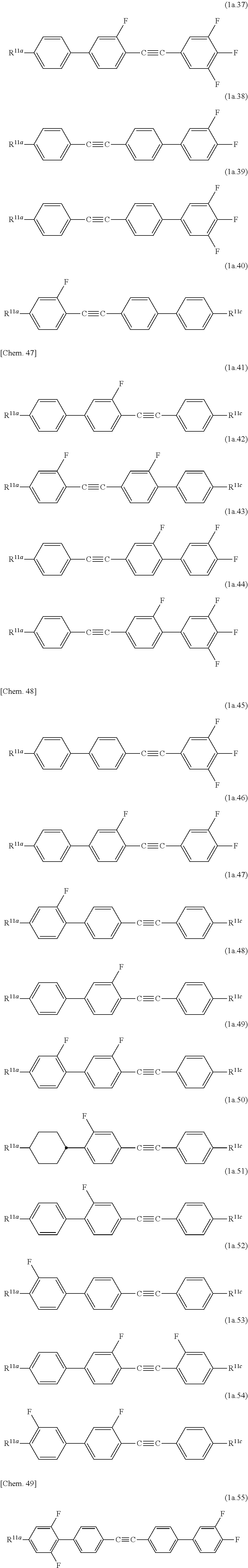

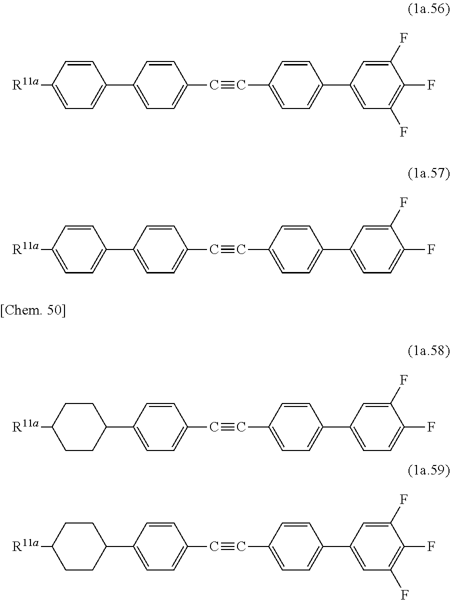

In general formulae (1a.1) to (1a.59), R^{11a} represents an alkyl group having 1 to 12 carbon atoms, an alkenyl group having 2 to 12 carbon atoms, an alkoxyl group having 1 to 12 carbon atoms, and an alkenyloxy group having 2 to 12 carbon atoms.

R^{11c} represents a hydrogen atom, a fluorine atom, a chlorine atom, a cyano group, an alkyl group having 1 to 12 carbon atoms, an alkenyl group having 2 to 12 carbon atoms, an alkoxyl group having 1 to 12 carbon atoms, an alkenyloxy group having 2 to 12 carbon atoms,

X^{11a} to X^{iic}, X^{iig}, and X^{iih} each independently represent a hydrogen atom or a fluorine atom, and

Z^{11a}, Z^{11b}, Z^{11c}, and Z^{11d} each independently represent —OCH₂—, —CH₂O—, —C₂H₄—, —C₄H₈—, —COO—, —OCO—, —CH═CH—, —CF═CF—, —CF₂O—, —OCF₂—, —CF₂CF₂—, —C≡C—, or a single bond.

Among the compounds represented by general formulae (1a.1) to (1a.59), (1a.1) to (1a.24), (1a.26), and (1a.35) to (1a.54) are preferred.

Specific examples of the compounds of general formula (1a) include compounds represented by structural formulae (1a.11.1) to (1a.48.5) below.

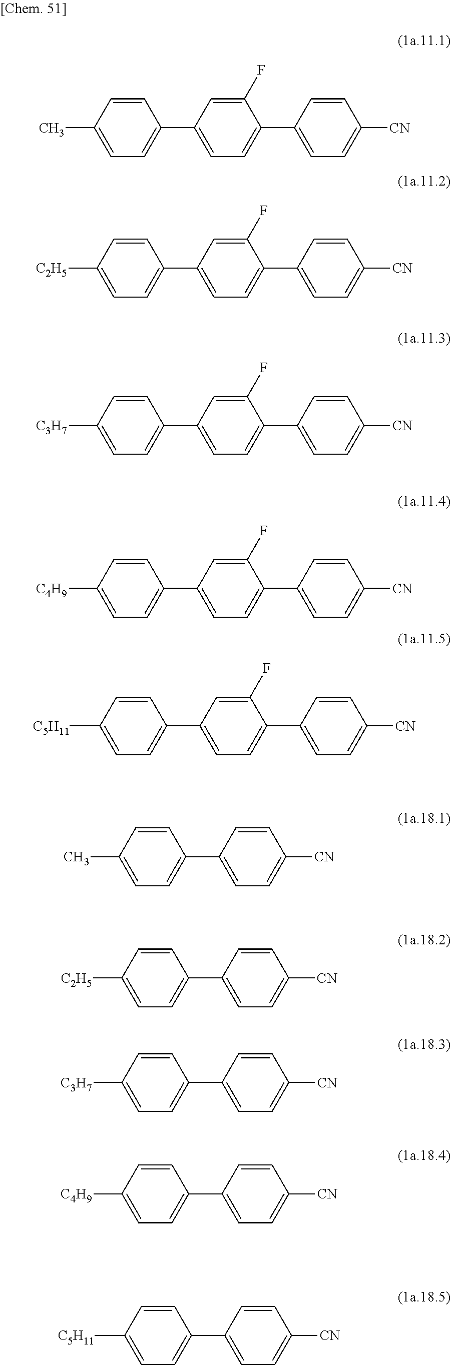

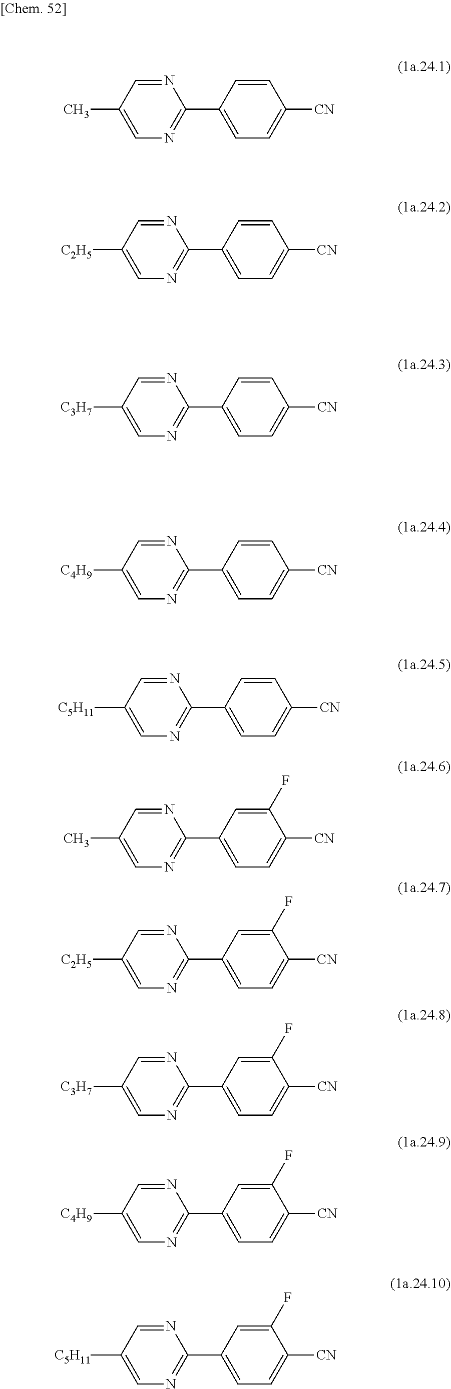

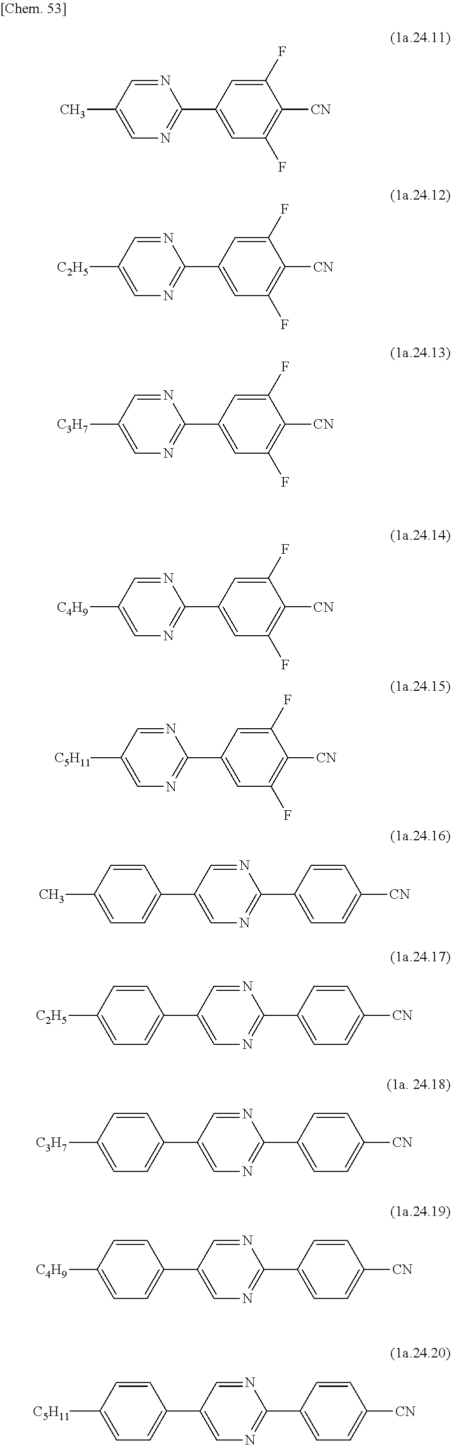

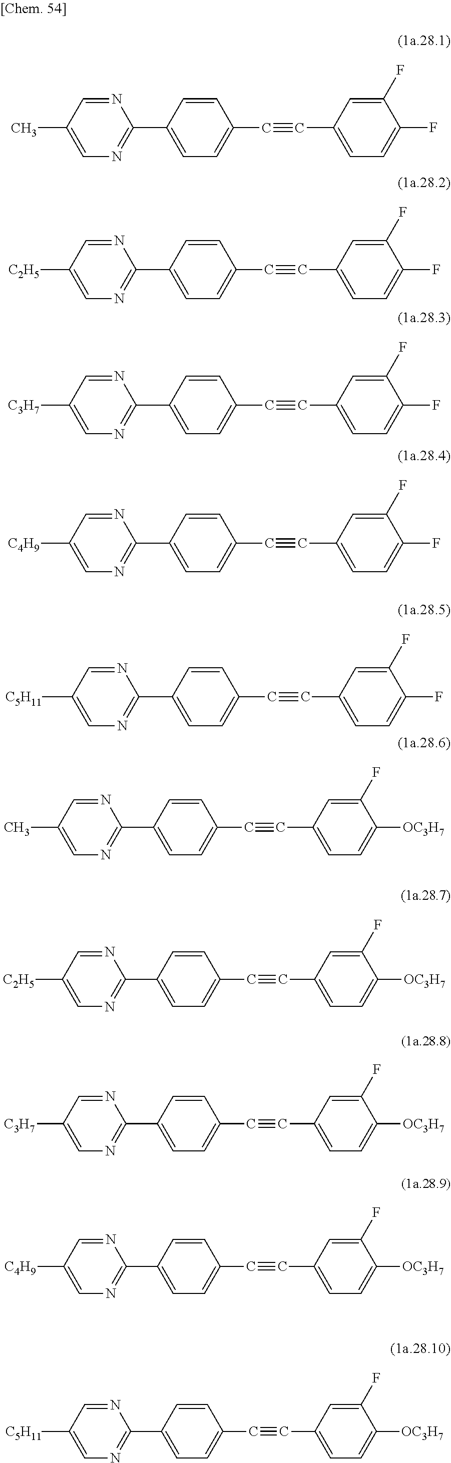

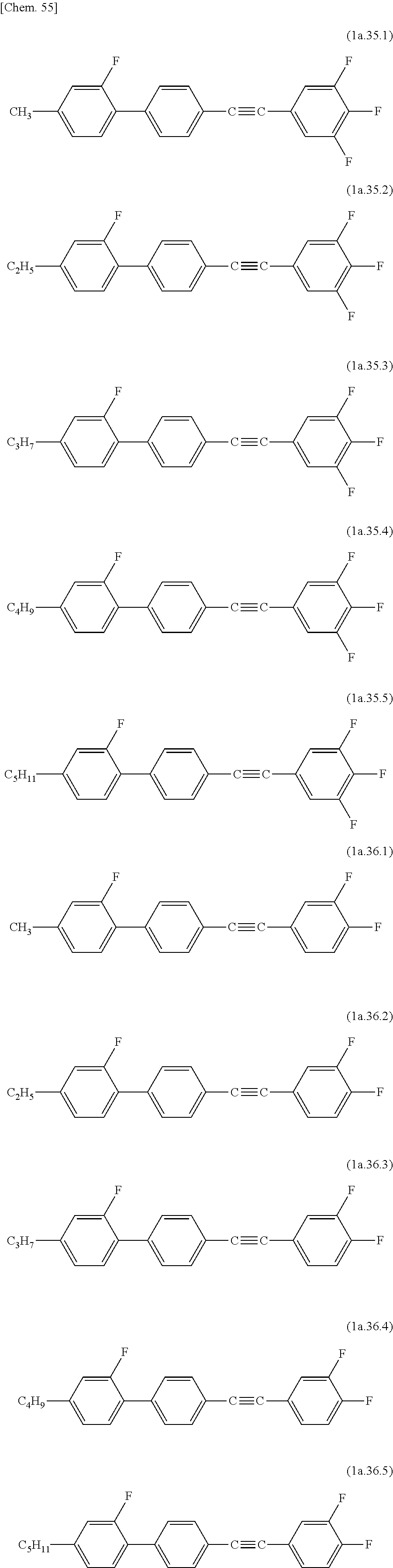

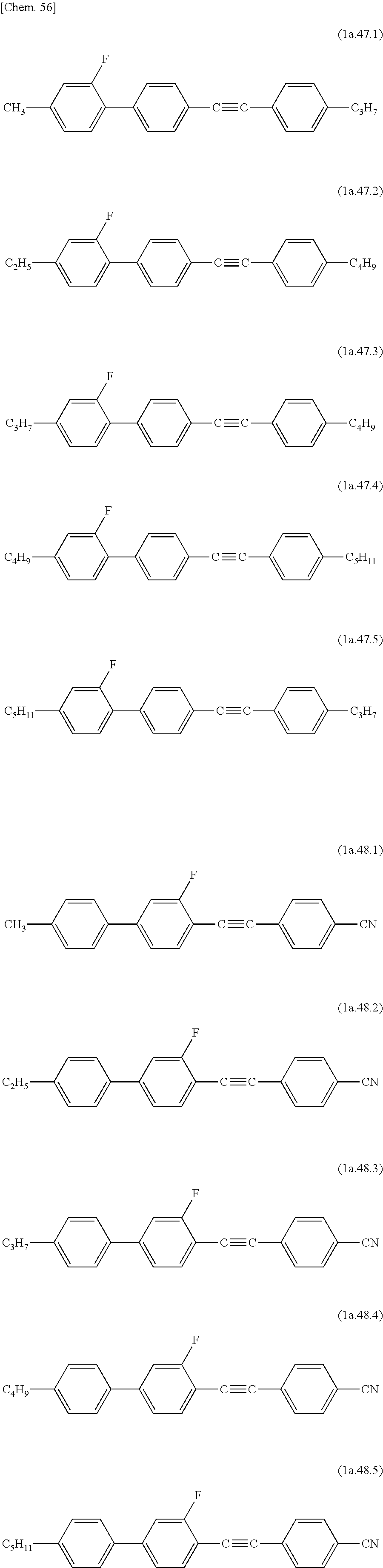

Among the compounds represented by structural formulae (1a.11.1) to (1a.48.5), (1a.11.2) to (1a.11.5), (1a.18.2) to (1a.18.5), (1a.24.12) to (1a.24.15), (1a.28.2) to (1a.28.5), (1a.28.7) to (1a.28.10), (1a.35.3), (1a.36.3), (1a.47.3), and (1a.48.3) are preferred.

As a preferred form of general formula (1a), the compound represented by general formula (1a-1) is preferred. The compound represented by general formula (1a-1) can be used to produce a composition having a liquid crystal phase over a wide temperature range, low viscosity, good solubility at low temperatures, high specific resistance and voltage retention, and stability against heat and light, while achieving a high Δn.

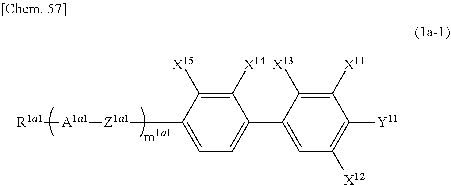

(In the formula, Y¹¹, X¹¹, and X¹² respectively have the same meaning as Y¹¹, X¹¹, and X¹² in general formula (1a),

R^{1a1} represents an alkynyl group having 2 to 12 carbon atoms, wherein one or two or more non-adjacent —CH₂-'s in the alkynyl group are each independently optionally substituted with —CH═CH—, —C≡C—, —O—, —CO—, —COO—, or —OCO—, and one or two or more hydrogen atoms in R^{1a1} are each independently optionally substituted with a fluorine atom,

X¹³ to X¹⁵ each independently represent a hydrogen atom or a fluorine atom, wherein X¹¹ and X¹³ do not simultaneously represent a fluorine atom, and X¹⁴ and X¹⁵ do not simultaneously represent a fluorine atom,

A^{1a1} has the same meaning as M¹¹ in general formula (1a),

Z^{1a1} has the same meaning as L¹¹ in general formula (1a), and

m^{1a1} represents 0 or 1.)

The compounds represented by formula (1a-1) may be used singly or in combination of two or more.

The lower limit of the amount (% by mass) of the compound represented by general formula (1a-1) in the total amount of the liquid crystal composition of the present invention is preferably 1 mass %, preferably 2%, preferably 5%, preferably 7%, preferably 9%, preferably 10%, preferably 12%, preferably 15%, preferably 17%, and preferably 20%. In terms of preventing inconvenience such as precipitation, the upper limit is preferably 50%, preferably 40%, preferably 30%, preferably 25%, preferably 20%, preferably 18%, preferably 15%, preferably 13%, and preferably 10%.

In general formula (1a-1), R^{1a1} is preferably an alkynyl group having 1 to 8 carbon atoms and preferably selected from groups represented by any of formulae (R11) to (R15). (The black circle in each formula represents a carbon atom in a ring structure.)

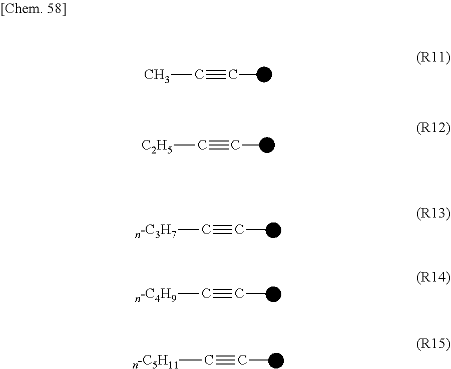

(R13) and (R14) are particularly preferred.

In general formula (1a-1), Y¹¹ is preferably a fluorine atom, a cyano group, a trifluoromethyl group, or a trifluoromethoxy group when the compound represented by general formula (1a-1) is what is called a p-type compound with a positive Δε, and preferably a fluorine atom or a cyano group in terms of improving Δε.

When the compound represented by general formula (1a-1) is what is called a nonpolar compound in which Δε is almost zero, Y¹¹ represents an alkyl group having 1 to 10 carbon atoms, an alkenyl group having 2 to 10 carbon atoms, or an alkynyl group having 2 to 10 carbon atoms, wherein one methylene group or two or more non-adjacent methylene groups in these groups preferably represent a group optionally substituted with —O— or —S—.

A^{1a1} is preferably aromatic when a higher Δn is required, preferably aliphatic in order to improve the response speed, preferably each independently represents a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, and more preferably represents the following structure,

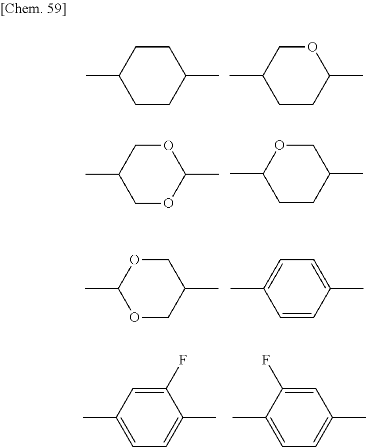

more preferably represents a trans-1,4-cyclohexylene group or a 1,4-phenylene group.

Z^{1a1} is preferably a single bond.

m^{1a1} is preferably 0 when the solubility in the liquid crystal composition is important, and preferably 1 when Δn and Tni are important.

X¹¹ to X¹⁴ are all hydrogen atoms, or preferably one is a fluorine atom and the rest are hydrogen atoms, and preferably X¹⁴ is a fluorine atom and the rest are hydrogen atoms.

The compounds represented by general formula (1a-1) are preferably compounds represented by general formula (1a-11) to general formula (1a-34) below.

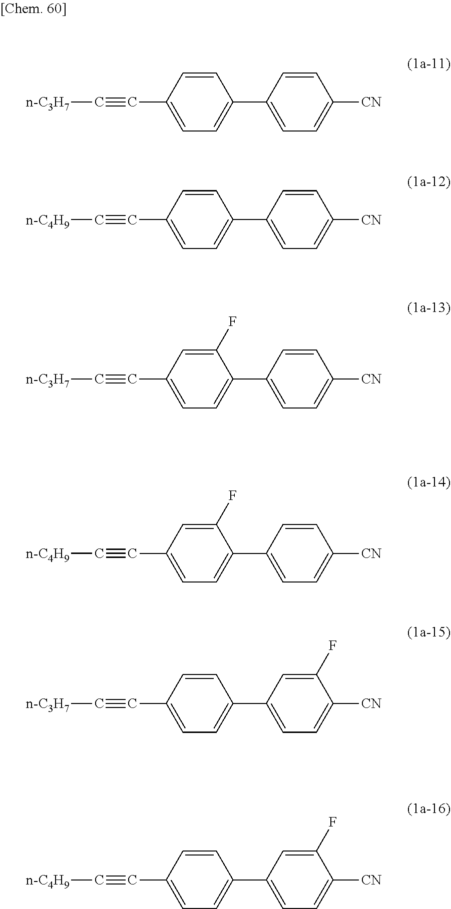

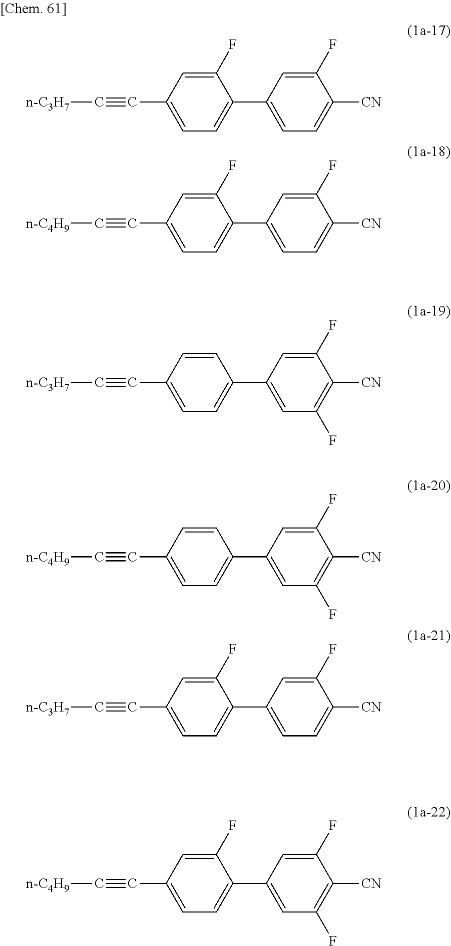

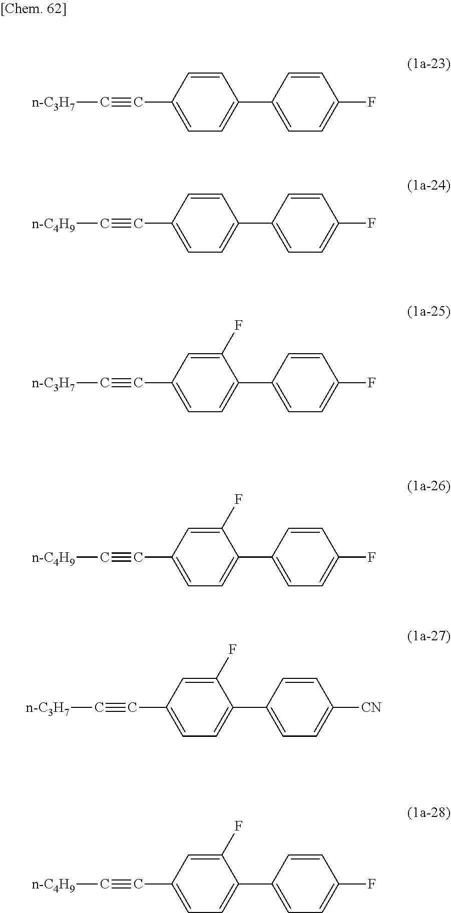

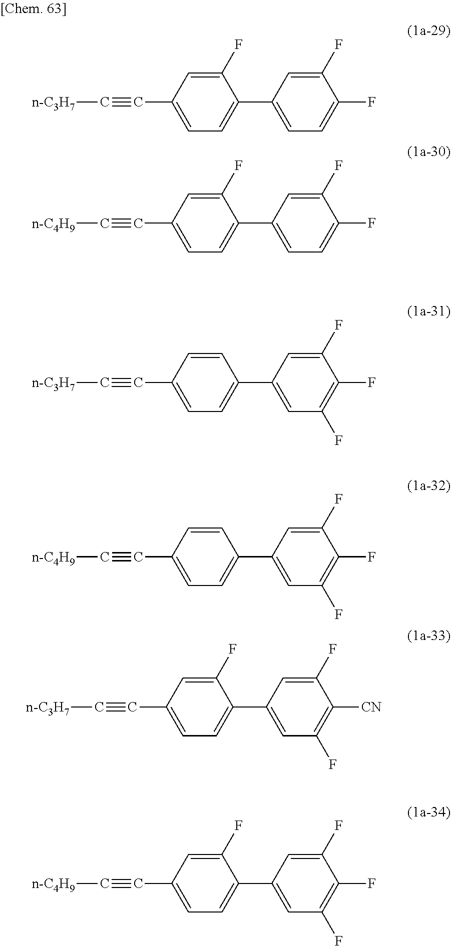

Preferably, the liquid crystal composition according to the present invention further contains one or two or more compounds represented by general formulae (2a) to (2c) below.

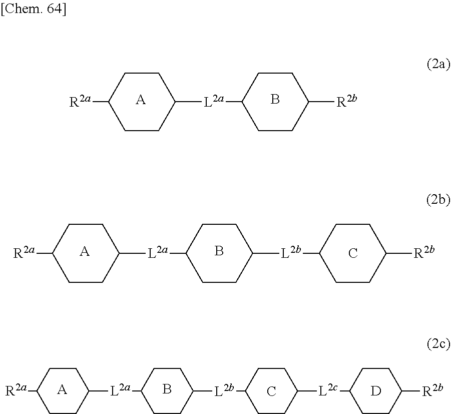

In formulae (2a) to (2c),

R^{2a} and R^{2b} each independently represent an alkyl group having 1 to 12 carbon atoms and may be linear or have a methyl or ethyl branch, and may have a 3 to 6 membered ring structure, wherein arbitrary —CH₂— present in the group is optionally substituted with —O—, —S—, —CH═CH—, —CH═CF—, —CF═CH—, —CF═CF—, or —C≡C—, and an arbitrary hydrogen atom in the group is optionally substituted with a fluorine atom or a trifluoromethoxy group,

the ring A, the ring B, the ring C, and the ring D each independently represent a trans-1,4-cyclohexylene group, a trans-decahydronaphthalene-trans-2,6-diyl group, a 1,4-phenylene group optionally substituted with one or two fluorine atoms or methyl groups, a naphthalene-2,6-diyl group optionally substituted with one or more fluorine atoms, a tetrahydronaphthalene-2,6-diyl group optionally substituted with one or two fluorine atoms, a 1,4-cyclohexenylene group optionally substituted with one or two fluorine atoms, a 1,3-dioxane-trans-2,5-diyl group, a pyrimidine-2,5-diyl group, or a pyridine-2,5-diyl group,

L^{2a}, L^{2b}, and L^{2c} are each an independent linking group and represent a single bond, an ethylene group (—CH₂CH₂—), a 1,2-propylene group (—CH(CH₃) CH₂— and —CH₂CH(CH₃)—), a 1,4-butylene group, —COO—, —OCO—, —OCF₂—, —CF₂O, —CH═CH—, —CH═CF—, —CF═CH—, —CF═CF—, —C≡C—, or —CH═N—N═CH—.

The liquid crystal composition according to the present invention preferably contains at least one compound selected from the group consisting of the compounds represented by general formulae (2a) to (2c), and particularly preferably contains two to eight compounds. In the liquid crystal composition according to the present invention, the lower limit of the amount (100% by mass of the entire liquid crystal composition) of at least one or two or more liquid crystal compounds selected from the group consisting of the compounds represented by general formula (2a) to general formula (2c) is preferably 0% by mass, more preferably 3% by mass, and even more preferably 5% by mass. In the liquid crystal composition according to the present invention, the upper limit of the amount (100% by mass of the entire liquid crystal composition) of at least one or two or more liquid crystal compounds selected from the group consisting of the compounds represented by general formula (2a) to general formula (2c) is 50% by mass, preferably 45% by mass, preferably 38% by mass, and even more preferably 25% by mass.

The liquid crystal composition according to the present invention more preferably contains at least one or two or more compounds selected from the group consisting of the compounds represented by general formula (2a) or (2b), and even more preferably contains one or two or more compounds selected from the group consisting of the compounds represented by general formula (2a).

The lower limit of the preferred amount (% by mass) of the compound represented by formula (2a) in the total amount of the liquid crystal composition of the present invention is 0%, 0.5%, 1%, 1.5%, 2%, 2.5%, and 3%. In terms of preventing inconvenience such as precipitation, the upper limit of the preferred amount is 45%, 35%, 25% 15%, 10%, 8%, and 5%.

Examples of a preferred form of the compounds represented by general formulae (2a) to (2c) include compounds represented by general formulae (2a-1) to (2a-28) below.

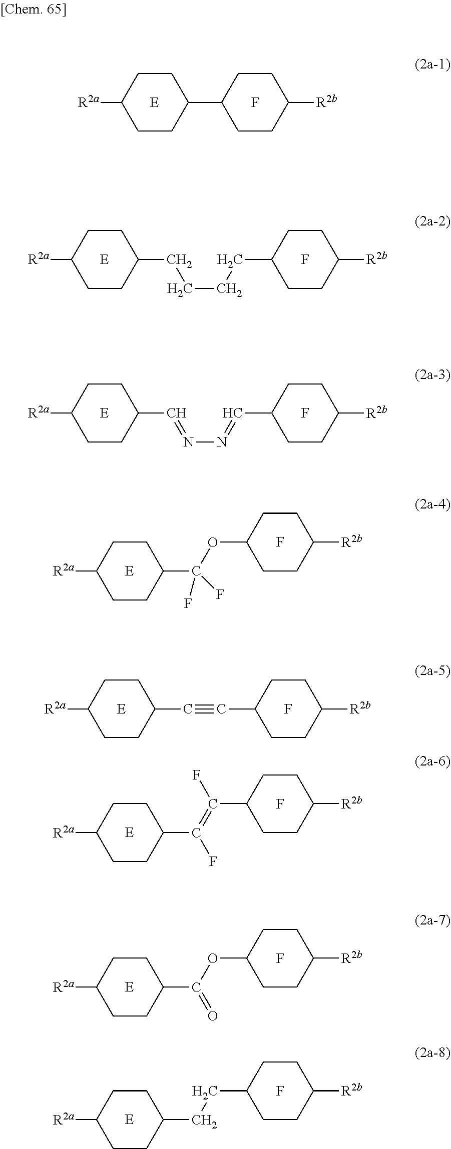

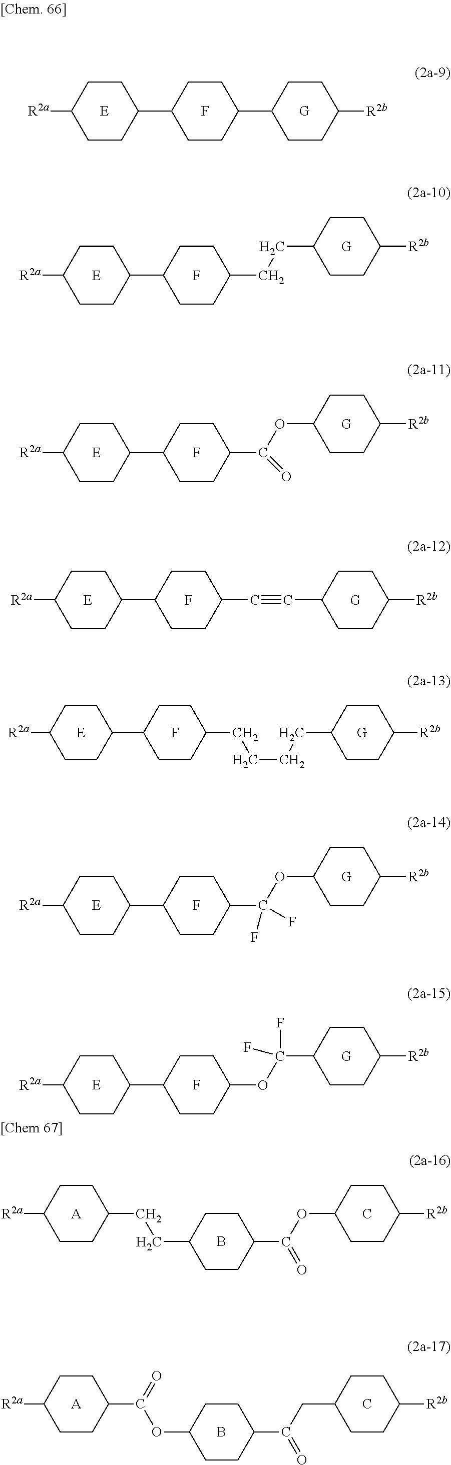

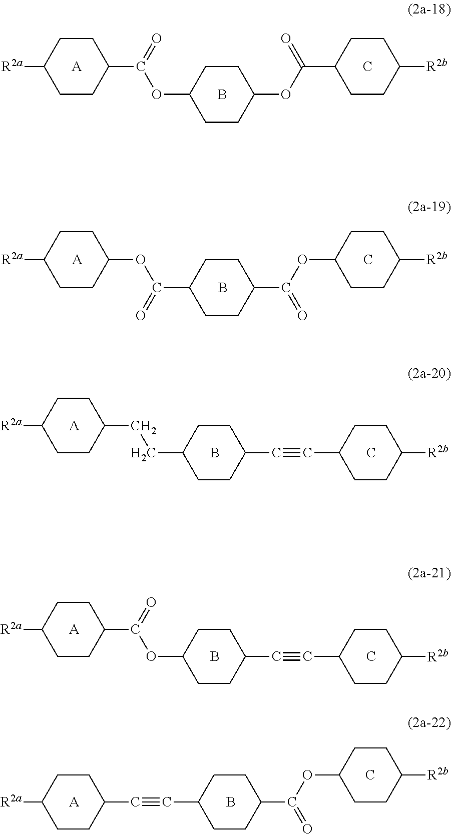

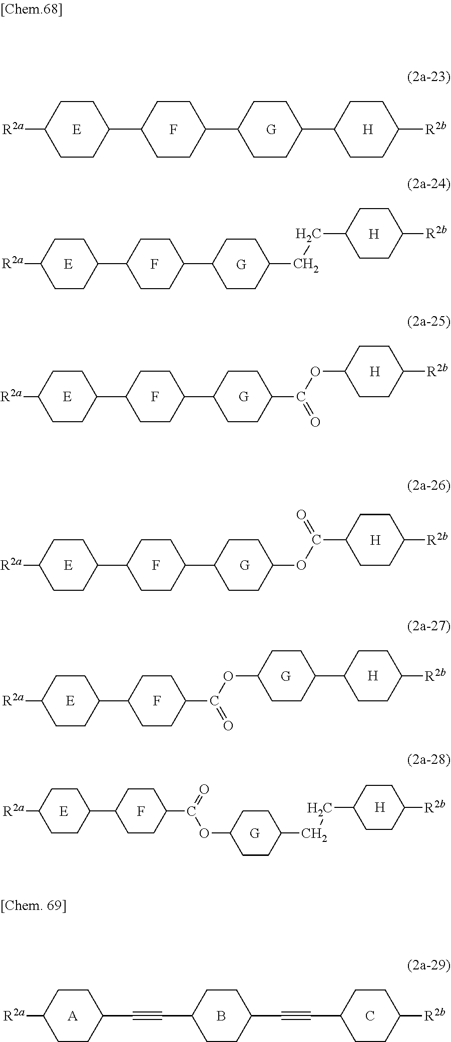

In general formulae (2a-1) to (2a-29), R^{2a} and R^{2b} each independently represent an alkyl group having 1 to 8 carbon atoms, an alkoxy group having 1 to 8 carbon atoms, an alkenyl group having 2 to 8 carbon atoms, an alkenyloxy group having 2 to 8 carbon atoms, or a thioalkoxy group having 1 to 8 carbon atoms, and the ring E, the ring F, the ring G, and the ring H each independently represent any one of formulae (a1) to (a25).

Among the compounds of general formulae (2a-1) to (2a-29), (2a-1) to (2a-3), (2a-5), (2a-8) to (2a-10), and (2a-12) are preferred.

Specific examples of the compounds of general formula (2a) according to the present invention include compounds represented by structural formulae (2a-5.1) to (2a-5.13) and (2a-12.1) to (2a-12.8) below.

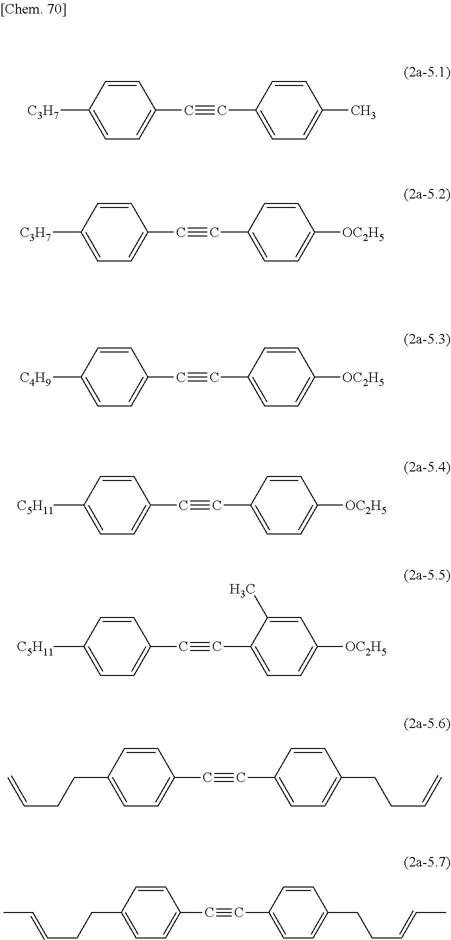

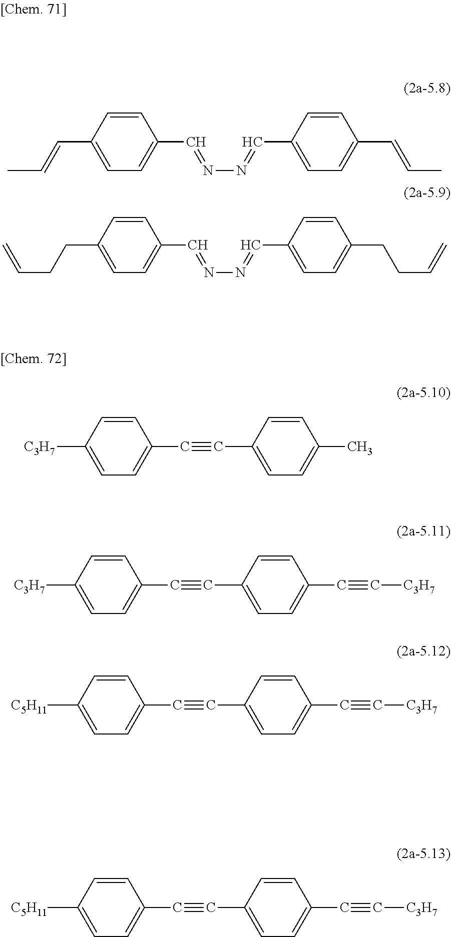

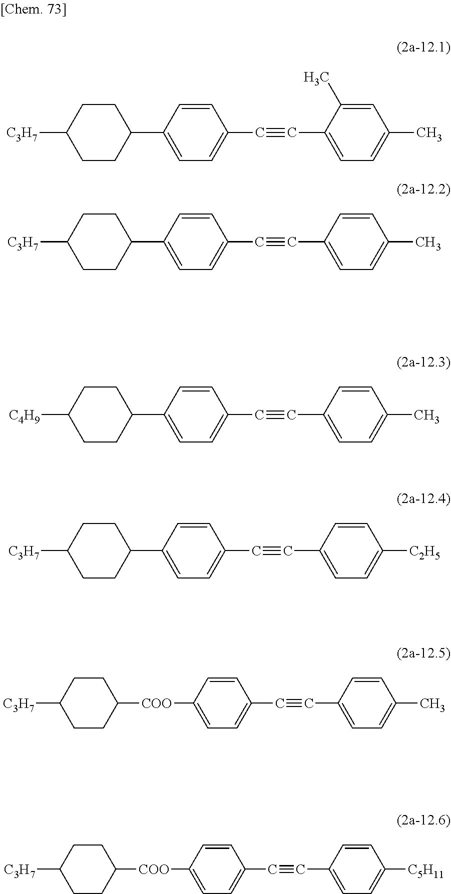

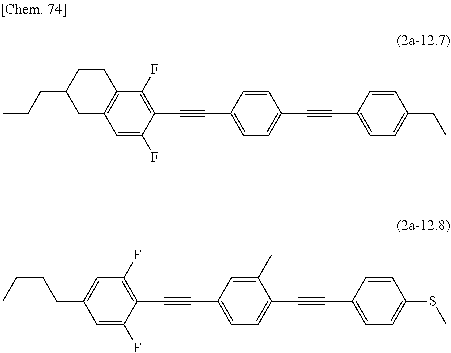

Among the compounds represented by structural formulae (2a-5.1) to (2a-5.13) and (2a-12.1) to (2a-12.8), (2a-5.2) to (2a-5.5), (2a-5.11) to (2a-5.13), and (2a-12.1) to (2a-12.4) are preferred.

Preferably, the liquid crystal composition according to the present invention further contains at least one compound selected from the group consisting of compounds represented by general formula (iii).

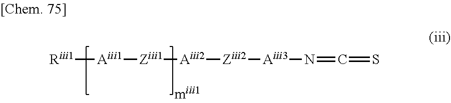

In general formula (iii),

Rⁱⁱⁱ¹ represents a linear or branched alkyl group or alkyl halide group having 1 to 40 carbon atoms, wherein a methylene group or an alkylene halide group containing one secondary carbon atom in these groups is optionally substituted with —O—, —CH═CH—, or —C≡C— such that oxygen atoms are not directly adjacent to each other,

mⁱⁱⁱ¹ represents an integer of 0, 1, or 2,

Aⁱⁱⁱ¹ to Aⁱⁱⁱ³ each independently represent any one of the following groups (a) to (c),

(a) a 1,4-cyclohexylene group (one methylene group or two or more non-adjacent methylene groups in this group are optionally substituted with —O— or —S—),

(b) a 1,4-phenylene group (one —CH═ or two or more non-adjacent —CH='s in this group are optionally substituted with —N═),

(c) a naphthalene-2,6-diyl group, a 1,2,3,4-tetrahydronaphthalene-2,6-diyl group, or a decahydronaphthalene-2,6-diyl group (one —CH═ or two or more non-adjacent —CH='s in the naphthalene-2,6-diyl group or the 1,2,3,4-tetrahydronaphthalene-2,6-diyl group are optionally substituted with —N═),

hydrogen atoms in the groups (a) to (c) are each independently optionally substituted with a fluorine atom, a chlorine atom, or a linear or branched alkyl group or alkyl halide group having 1 to 10 carbon atoms,

Zⁱⁱⁱ¹ and Zⁱⁱⁱ² each independently represent a single bond, —C≡C—, —CH═CH—, —CF═CF—, or —C(R^{iiia})═N—N═C(R^{iiib})—, wherein R^{iiia} and R^{iiib} each independently represent a hydrogen atom, a halogen atom, or a linear or branched alkyl group or alkyl halide group having 1 to 10 carbon atoms, and

a plurality of Aⁱⁱⁱ¹s and Zⁱⁱⁱ¹s present when mⁱⁱⁱ¹ is 2 may be the same or different.

In general formula (iii), Rⁱⁱⁱ¹ preferably represents a linear alkyl group or an alkyl halide group having 1 to 11 carbon atoms, wherein a methylene group or an alkylene halide group containing one secondary carbon atom in these groups is optionally substituted with —O—, —CH═CH—, or —C≡C— such that oxygen atoms are not directly adjacent to each other.

In general formula (iii), Aⁱⁱⁱ¹ to Aⁱⁱⁱ³ are preferably each independently a trans-1,4-cyclohexylene group or a 1,4-phenylene group optionally substituted with a fluorine atom, a chlorine atom, or a linear alkyl group or alkyl halide group having 1 to 10 carbon atoms. Examples of Aⁱⁱⁱ¹ to Aⁱⁱⁱ³ similarly include divalent cyclic groups represented by formulae (a1) to (a25) exemplified for Aⁱ¹ of general formula (i). Specifically, Aⁱⁱⁱ¹ to Aⁱⁱⁱ³ are each independently preferably formulae (a1) to (a3), (a5) to (a6), (a9) to (a10), (a12) to (a25), more preferably (a1) to (a3) and (a12) to (a25), and even more preferably (a1) to (a3) and (a12) to (a18).

In general formula (iii), Zⁱⁱⁱ¹ and Zⁱⁱⁱ² preferably each independently represent a single bond, —C≡C—, —CH═CH—, —CF═CF—, or —C(R^{iiia})═N—N═C(R^{iiib})—.

Here, R^{iiia} and R^{iiib} preferably each independently represent a hydrogen atom, a halogen atom, or a linear alkyl group or alkyl halide group having 1 to 10 carbon atoms.

In general formula (iii), Zⁱⁱⁱ¹ and Zⁱⁱⁱ² are more preferably each independently a single bond or —C≡C—. More preferably, a molecule of the compound represented by general formula (iii) has at least one —C≡C—. That is, in general formula (iii), preferably, at least one of Zⁱⁱⁱ² and 0 or more and 2 or less Zⁱⁱⁱ¹ represent —C≡C—.

In general formula (iii), mⁱⁱⁱ¹ preferably represents an integer of 0, 1, or 2. A plurality of Aⁱⁱⁱ¹ and Zⁱⁱⁱ¹ present when mⁱⁱⁱ¹ is 2 may be the same or different.

The liquid crystal composition according to the present invention preferably contains at least one compound represented by (iii) and particularly preferably contains two to eight compounds.

The lower limit of the preferred amount (% by mass) of the compound represented by general formula (iii) in the total amount of the liquid crystal composition of the present invention is 1.7% by mass, 2% by mass, 4% by mass, 4.3% by mass, 5% by mass, 5.7% by mass, and 6% by mass. In terms of preventing inconvenience such as precipitation, the upper limit of the preferred amount is 23% by mass, 20% by mass, 18% by mass, 14% by mass, 13% by mass, 10% by mass, 8% by mass, and 5% by mass. In the liquid crystal composition of the present invention, the preferred amount of the compound represented by general formula (iii) is 2 to 20% by mass, more preferably 4 to 15% by mass, and particularly preferably 6 to 12% by mass.

Examples of specific structures of general formula (iii) include compounds represented by general formulae (iii.1) to (iii.6) below.

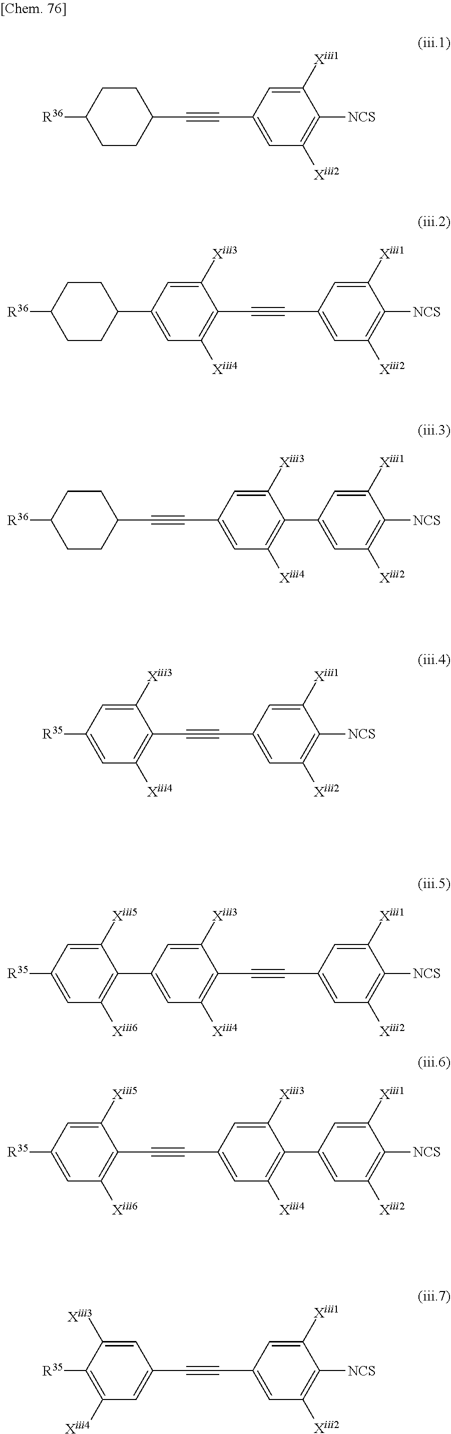

In general formulae (iii.1) to (iii.7), R³⁵ represents an alkyl group having 1 to 8 carbon atoms, or an alkoxyl group having 1 to 8 carbon atoms, or an alkenyl group having 2 to 8 carbon atoms, R³⁶ represents an alkyl group having 1 to 8 carbon atoms or an alkenyl group having 2 to 8 carbon atoms, and Xⁱⁱⁱ¹ to Xⁱⁱⁱ⁶ each independently represent a hydrogen atom, a fluorine atom, or a chlorine atom.

More specifically, the compounds represented by general formulae (iii.1) to (iii.7) are preferably compounds represented by structural formulae (iii.a) to (iii.e) below.

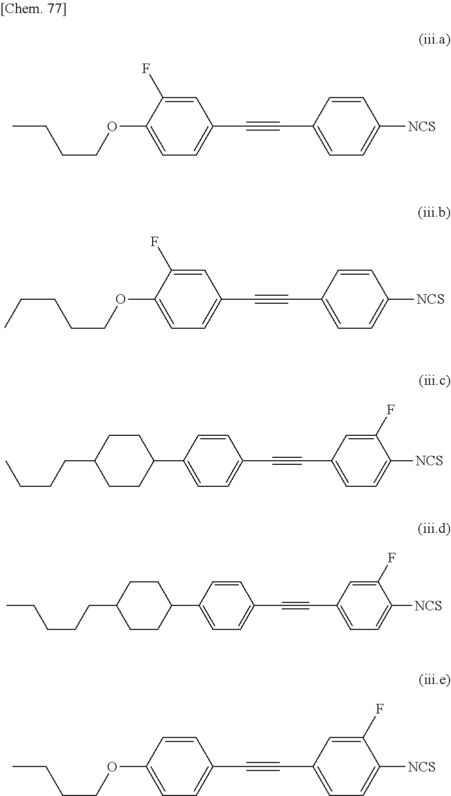

In the liquid crystal composition according to the present invention, the total amount (% by mass) of the compounds represented by general formulae (i) to (ii) is preferably 10 to 85%, preferably 13 to 80%, and preferably 15 to 70% of the entire liquid crystal composition.

In the liquid crystal composition according to the present invention, the total amount (% by mass) of the compounds represented by general formulae (i) to (iii) is preferably 13 to 88%, preferably 16 to 85%, and preferably 18 to 73% of the entire liquid crystal composition.

In the liquid crystal composition according to the present invention, the total amount (% by mass) of the compounds represented by general formulae (i) to (ii) and general formula (1a) is preferably 13 to 88%, preferably 16 to 85%, and preferably 18 to 73% of the entire liquid crystal composition.

In the liquid crystal composition according to the present invention, the total amount (% by mass) of the compounds represented by general formulae (i) to (ii) and general formula (2a) is preferably 13 to 88%, preferably 16 to 85%, and preferably 18 to 73% of the entire liquid crystal composition.

In the liquid crystal composition according to the present invention, the total amount (% by mass) of the compounds represented by general formulae (i) to (ii) and general formula (2b) is preferably 13 to 88%, preferably 16 to 85%, and preferably 18 to 73% of the entire liquid crystal composition.

In the liquid crystal composition according to the present invention, the total amount (% by mass) of the compounds represented by general formulae (i) to (ii) and general formula (2c) is preferably 13 to 88%, preferably 16 to 85%, and preferably 18 to 73% of the entire liquid crystal composition.

In the liquid crystal composition according to the present invention, the total amount (% by mass) of the compounds represented by general formulae (i) to (iii) and general formula (1a) is preferably 30 to 93%, preferably 35 to 88%, and preferably 40 to 85% of the entire liquid crystal composition.

In the liquid crystal composition according to the present invention, the total amount (% by mass) of the compounds represented by general formulae (i) to (iii) and general formula (2a) is preferably 30 to 93%, preferably 35 to 88%, and preferably 40 to 85% of the entire liquid crystal composition.

In the liquid crystal composition according to the present invention, the total amount (% by mass) of the compounds represented by general formulae (i) to (iii) and general formula (2b) is preferably 30 to 93%, preferably 35 to 88%, and preferably 40 to 85% of the entire liquid crystal composition.

In the liquid crystal composition according to the present invention, the total amount (% by mass) of the compounds represented by general formulae (i) to (iii) and general formula (2c) is preferably 30 to 93%, preferably 35 to 88%, and preferably 40 to 85% of the entire liquid crystal composition.

In the liquid crystal composition according to the present invention, the total amount (% by mass) of the compounds represented by general formulae (i) to (ii), the compound represented by general formula (1a), and the compound represented by general formula (2a) is preferably 30 to 89%, preferably 35 to 93%, and preferably 40 to 85% of the entire liquid crystal composition.

In the liquid crystal composition according to the present invention, the total amount (% by mass) of the compounds represented by general formulae (i) to (ii), the compound represented by general formula (1a), and the compounds represented by general formulae (2a) to (2b) is preferably 30 to 93%, preferably 35 to 88%, and preferably 40 to 85% of the entire liquid crystal composition.

In the liquid crystal composition according to the present invention, the total amount (% by mass) of the compounds represented by general formulae (i) to (ii), the compound represented by general formula (1a), and the compounds represented by general formulae (2a) to (2c) is preferably 30 to 93%, preferably 35 to 88%, and preferably 40 to 85% of the entire liquid crystal composition.

In the liquid crystal composition according to the present invention, the total amount (% by mass) of the compounds represented by general formulae (i) to (iii), the compound represented by general formula (1a), and the compounds represented by general formulae (2a) to (2c) is preferably 33 to 96%, preferably 38 to 91%, and preferably 43 to 88% of the entire liquid crystal composition.

The liquid crystal composition according to the present invention may contain, in addition to the liquid crystal compounds described above, additives such as a known stabilizer, a known polymerizable liquid crystal compound, or a polymerized compound, as necessary depending on the manner of use.

Examples of the stabilizer include hydroquinones, hydroquinone monoalkyl ethers, tertiary butyl catechols, pyrogallols, thiophenols, nitro compounds, β-naphthylamines, β-naphthols, nitroso compounds, hindered phenols, and hindered amines. When the stabilizer is used, the amount added is preferably in the range of 0.005 to 1% by mass of the liquid crystal composition, even more preferably 0.02 to 0.5% by mass, and particularly preferably 0.03 to 0.1% by mass.

The liquid crystal phase upper limit temperature (T_{NI}) of a liquid crystal composition is the temperature at which the liquid crystal composition exhibits a phase transition from the nematic phase to the isotropic phase. As T_{NI} increases, the nematic phase can be retained even at higher temperatures, and a wider drive temperature range can be ensured. T_{NI} is preferably 120° C. or higher, preferably 120 to 200° C., and preferably 130 to 180° C.

The liquid crystal composition according to the present invention preferably has a Δn (refractive index anisotropy) of 0.3 or higher at 25° C. and 589.0 nm, preferably 0.3 to 0.60, preferably 0.33 to 0.55, preferably 0.35 to 0.50. Δn in the visible light region correlates with Δε in the tens of GHz band, and as Δn increases, change in dielectric constant in the GHz band can be increased. Therefore, when the liquid crystal composition has Δn of 0.3 or higher at 589.0 nm, the change in dielectric constant in the GHz band can be increased and therefore the liquid crystal composition is suitable for antennas.

Here, the relationship between the phase difference Re, the thickness d (cell gap) of the liquid crystal layer, and Δn is expressed by an equation: Δn=Re/d. In the present description, Δn is obtained from a phase difference measurement device. More specifically, a sample of the liquid crystal composition of the present invention is injected into a glass cell with a polyimide alignment film, and the in-plane retardation (phase difference Re) at a measurement temperature of 25° C. and 589 nm is measured with a retardation film and optical material inspection system RETS-100 (Otsuka Electronics Co., Ltd.). A glass cell with a cell gap of 3.0 μm between glass substrates was used, in which the rubbing direction of the polyimide alignment film is parallel.

The ne and no of the liquid crystal composition may be measured with an Abbe refractometer to calculate Δn.

The Δε (dielectric constant anisotropy) of the liquid crystal composition according to the present invention at 25° C. and 1 kHz is preferably 12 or higher, preferably 12 to 30, preferably 13 to 25, and preferably 14 to 20.

A liquid crystal element including the liquid crystal composition according to the present invention, more specifically, a liquid crystal element, a sensor, a liquid crystal lens, an optical communication device, and an antenna will be described below.

The liquid crystal element according to the present invention includes the liquid crystal composition described above and is preferably driven by an active matrix system or a passive matrix system.

The liquid crystal element according to the present invention is preferably a liquid crystal element in which the dielectric constant is reversely switched by reversibly changing the orientation direction of liquid crystal molecules of the liquid crystal composition described above.

The sensor according to the present invention includes the liquid crystal composition described above. Examples of embodiments thereof include ranging sensors using electromagnetic waves, visible light, or infrared light, infrared sensors using temperature change, temperature sensors using reflected light wavelength change caused by pitch change of cholesteric liquid crystal, pressure sensors using reflected light wavelength change, UV sensors using reflected light wavelength change caused by compositional change, electrical sensors using temperature change caused by voltage or current, radiation sensors using temperature change involved with track of radiation particles, ultrasonic sensors using liquid crystal molecules' arrangement change caused by mechanical vibration of ultrasonic waves, and electromagnetic field sensors using reflected light wavelength change caused by temperature change or liquid crystal molecules' arrangement change caused by electric fields.

The ranging sensors are preferably for light detection and ranging (LiDAR) using a light source.

Preferred LiDAR applications are satellites, aircrafts, unmanned aerial vehicles (drones), automobiles, railroads, and ships.

For automobile applications, self-driving automobile applications are particularly preferred.

The light source is preferably an LED or a laser, and preferably a laser.

Light used for LiDAR is preferably infrared light and preferably has a wavelength of 800 to 2,000 nm.

An infrared laser with a wavelength of 905 nm or 1,550 nm is particularly preferred.

An infrared laser with 905 nm is preferred when the cost of photodetectors used and sensitivity in all weathers are important. An infrared laser with 1,550 nm is preferred when safety of human vision is important.

The liquid crystal composition according to present invention exhibits a high Δn and therefore can provide sensors with high phase modulation power in the visible light, infrared light, and electromagnetic wave regions and with high detection sensitivity.

The liquid crystal lens according to the present invention includes the liquid crystal composition described above and, for example, according to an embodiment, includes a first transparent electrode layer, a second transparent electrode layer, a liquid crystal layer containing the liquid crystal composition described above between the first transparent electrode layer and the second transparent electrode layer, an insulating layer between the second transparent electrode layer and the liquid crystal layer, and a high resistance layer between the insulating layer and the liquid crystal layer. The liquid crystal lens according to the present invention is used, for example, as a 2D/3D switchable lens and a focusing lens for cameras.

The optical communication device according to the present invention includes the liquid crystal composition described above. Examples thereof include, as one of its embodiments, a liquid crystal on silicon (LCOS) including a liquid crystal layer in which liquid crystals forming a plurality of pixels are arranged in two dimensions on a reflective layer (electrode). The optical communication device according to the present invention is used, for example, as a spatial phase modulator.

The antenna according to the present invention includes the liquid crystal composition described above.

More specifically, the antenna according to the present invention includes a first substrate having a plurality of slots, a second substrate facing the first substrate and having a power feed section, a first dielectric layer between the first substrate and the second substrate, a plurality of patch electrodes disposed corresponding to the slots, a third substrate having the patch electrodes, and a liquid crystal layer between the first substrate and the third substrate, in which the liquid crystal layer contains the liquid crystal composition described above.

The liquid crystal layer containing the liquid crystal compounds represented by general formulae (i) and (ii) can be used to provide an antenna having a high dielectric constant anisotropy Δε, a high refractive index anisotropy Δn, a wide nematic liquid crystal temperature range, stability at room temperature, and high reliability against external stimuli such as heat. Thus, an antenna capable of greater phase control over electromagnetic waves in the microwave or millimeter wave range can be provided.

The antenna according to the present invention will be described below with reference to the drawings.

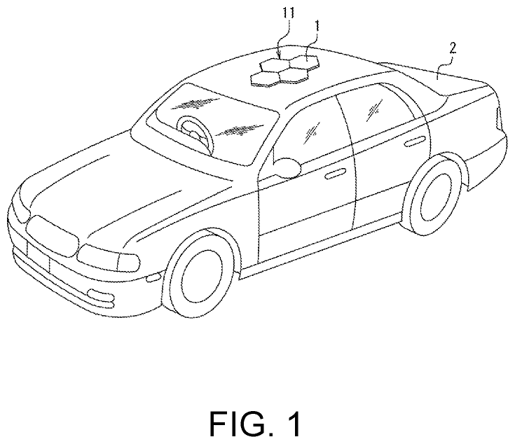

As illustrated in FIG. 1, an antenna assembly 11 having four antenna units 1 connected together is mounted on the roof of a vehicle (automobile) 2. The antenna units 1 are planar antennas. Mounted on the roof, the antenna units 1 are always pointed in the direction of a communications satellite. This configuration enables satellite communications capable of transmission and reception in both directions.

The term “antenna” as used herein includes the antenna unit 1 or the antenna assembly 11 having a plurality of antenna units 1 connected together.

Preferably, the antenna according to the present invention operates in the Ka-band frequencies or K-band frequencies or the Ku-band frequencies used for satellite communications.

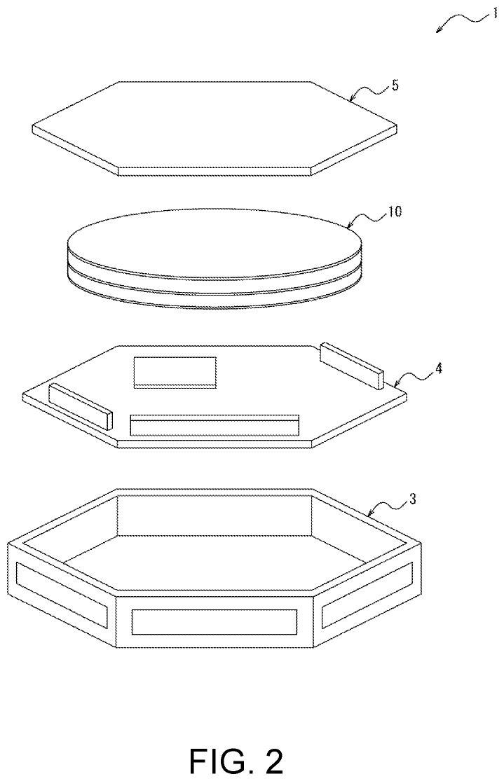

An exemplary embodiment of the components of the antenna unit 1 is illustrated in FIG. 2. FIG. 2 is an exploded view of the antenna unit 1 illustrated in FIG. 1. Specifically, the antenna unit 1 includes an antenna body 10, a control board 4 that controls the antenna body 10, a case 3 having a recess that can accommodate the antenna body 10 and the control board 4, and a top cover 5 that seals the case 3.

The control board 4 is provided with a transmitter and/or a receiver. The transmitter has a mechanism to transmit information from a signal source, such as sound or image data, in the form of radio waves, for example, after voice encoding, image encoding, or the like by an information source encoding process, error correcting encoding by a transmission line encoding process, and modulation. On the other hand, the receiver has a mechanism to modulate incoming radio waves, correct errors by a transmission line decoding process, perform, for example, voice decoding or image decoding by an information source decoding process, and convert the decoded signals into information such as voice or image data. The control board 4 is a known microcomputer composed of a CPU, a RAM, a ROM, and the like and centrally controls the operation of each part of the antenna body 1, the transmitter and/or the receiver. The CPU or the ROM of the control board 4 reads various programs stored in advance into the RAM and executes the programs to perform predetermined processes. The control board 4 has functions such as a memory to store various setting information or control programs, a computing unit to perform various computations related to the amount and the direction of voltage applied to the liquid crystal layer in the antenna body 1, various computations related to transmission of radio waves, and/or various computations related to reception of radio waves, and a detector to detect received or transmitted radio waves or detect a voltage applied to the liquid crystal layer.

In FIG. 2, the case 3 and the top cover 5 in a hexagonal prism shape are illustrated as an example of the case 3 that can accommodate the disc-shaped antenna body 1, but the case 3 and the top cover 5 can be modified into any known shape, such as a cylinder, an octagonal prism, or a triangular prism, depending on the shape of the antenna body 1.

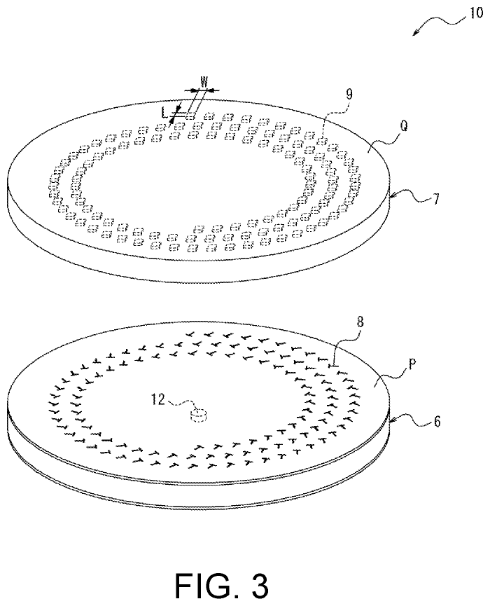

The configuration of the antenna body 10 will be described below with reference to FIGS. 3 to 10. FIG. 3 is an exploded diagram illustrating the components of the antenna body 10.

As illustrated in FIG. 3, the antenna body 10 includes a slot array section 6 and a patch array section 7. The slot array section 6 has a plurality of slots (notches) 8 on a surface of a disc-shaped conductor P and a power feed section 12 inside the center of the slot array section 6. The patch array section 7 has a plurality of square patches 9, for example, having a length L and a width W, on a disc body Q. The antenna body 10 has the slot array section 6 that is the disc-shaped conductor P having a plurality of slots 8 and the disc-shaped patch array section 7 having a plurality of patches. The patch array section 7 and the patch array section 6 are laminated such that the patches 9 face the slots 8 formed on the surface of the disc-shaped conductor P.

The slot array section 6 is an antenna section having notches (hereinafter slots 8) formed in the disc-shaped conductor Q as radiating elements (or incidence elements). The slot array section 6 has the slots 8 and the power feed section 12 provided at the center of the disc-shaped conductor Q. In general, the slot array section 6 has a mechanism directly excited at the distal end of a transmission line or excited through a cavity on the back of the slot. The slot array section 6 can be used for power feeding to the patch antenna through the slot from an antenna with a ground plate, a microstrip line, or the like. In FIG. 3, the slot array section 6 in the form of a radial line slot array is illustrated by way of example, but the scope of the present invention is not limited thereto.

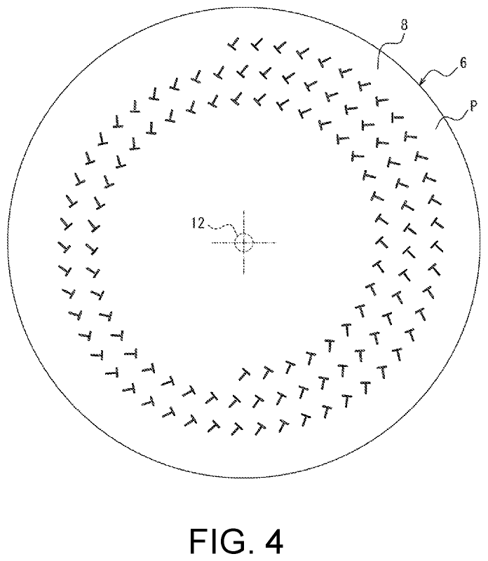

FIG. 4 is a top view of the slot array section 6 in FIG. 3. The slot array section 6 will be described below with reference to FIG. 4. The slot array section 6 has a structure to feed power through a coaxial line provided at the center. For this, the slot array section 6 illustrated in FIG. 4 has the power feed section 12 at the center. In the slot array section 6, a plurality of pairs of slots 8 (hereinafter referred to as “slot pairs”) are formed on the surface of the disc-shaped conductor P. Each of the slot pairs 8 has two rectangular notches arranged in a “V” shape. More specifically, two slots 8 each having a rectangular parallelepiped shape are arranged to be orthogonal to each other, and one slot of the slot pair 8 is spaced apart from the other slot by ¼ wavelength. This structure enables transmission and reception of circularly polarized waves with different rotational directions depending on the azimuth angle of the antenna.

In the present description, two slots 8 are referred to as slot pair 8, one slot 8 is simply referred to as slot 8, and slot and slot pair are collectively referred to as slot (pair) 8.

A plurality of slot pairs 8 are formed in a spiral shape from the center of the disc-shaped conductor substrate P to the radially outer side. The slot pairs 8 are formed on the surface of the disc-shaped substrate such that the distance between the slot pairs 8 adjacent along the spiral is constant. This configuration allows the phases to be matched in front of the slot array section 6 to enhance electromagnetic fields, thereby forming a pencil beam in front.

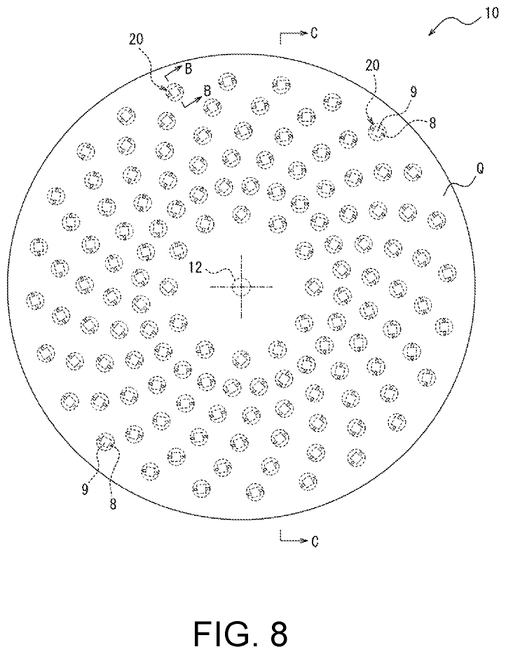

In FIGS. 3 and 4, the slots 8 having a rectangular parallelepiped shape are illustrated by way of example. However, the shape of the slots 8 in the present invention is not limited to a rectangular parallelepiped shape and may be known shapes such as circular, oval, and polygonal shapes. Although FIGS. 3 and 4 illustrate slot pairs as an illustrative example of the slots 8, the slots 8 in the present invention are not limited to slot pairs. Furthermore, although a spiral arrangement of the slots 8 on the surface of the disc-shaped conductor substrate P is illustrated as an example, the arrangement of the slots 8 is not limited to a spiral arrangement, and the slots 8 may be arranged, for example, concentrically as illustrated in FIG. 8 described later.

The power feed section 12 in the present invention has the function of receiving electromagnetic waves and/or radiating electromagnetic waves. The power feed section 12 in the present invention may be any section that transmits to the receiver high-frequency power generated by capturing radio waves with the patches 9 that are radiating elements or incidence elements, or any section that connect the radiating elements to the power feed line for supplying high-frequency power. Known power feeders and power feed lines can be used. FIGS. 3 and 4 illustrate a coaxial power feed section by way of example.

As illustrated in FIG. 3, the patch array section 7 includes the disc body Q having a plurality of square-shaped patches 9 each having a length L and a width W and a liquid crystal layer (not illustrated) filled between the patch array section 7 and the slot array section 6. The patch array section 7 in the present embodiment has a configuration of what is called a microstrip antenna and is a resonator that resonates at a frequency in which the length L matches an integer multiple of ½ wavelength.

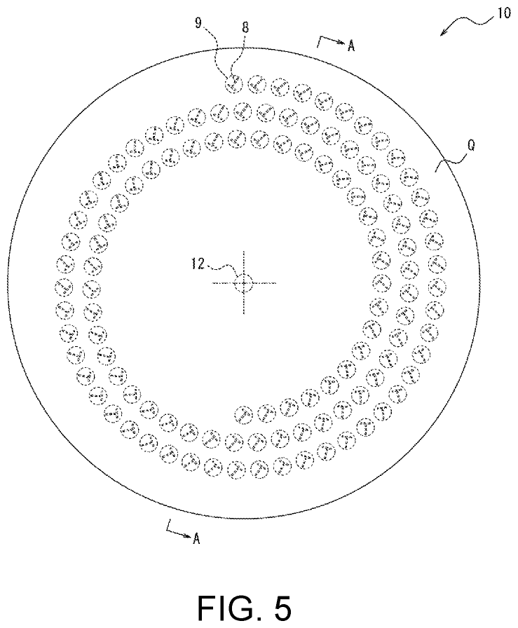

In FIG. 3, the square-shaped patch 9 having a length L and a width W is illustrated as an example of the patch 9. However, the shape of the patch 9 is not limited to a quadrature and the patch 9 may be circular. FIG. 5 illustrates an embodiment with circular patches 9 as another embodiment of the present invention.

FIG. 5 is a top view of the antenna body 10 in the present invention. More specifically, the antenna body 10 is viewed from the patch array section 7, and the patches 9, the power feed section 12, and the slot pairs 8 are projected perpendicularly to the main surface of the disc body Q. The patches 9, the power feed section 12, and the slot pairs 8 are therefore depicted by broken lines. When the patches 9 have a circular shape, the antenna can operate in an electromagnetic field distribution commonly called the TM₁₁ mode. As illustrated in FIG. 5, the projection of the patch 9 and the projection of the slot pair 8 overlap, which suggests that the patch 9 on the disc body Q faces the corresponding slot 8 formed on the surface of the disc-shaped conductor P. The configuration in which each patch 9 is disposed for the corresponding slot 8 can be used to feed power from the slot 8 to the patch 9 by electromagnetic coupling feeding or propagate an incoming radio wave from the patch 9 to the slot 8. Thus, an antenna capable of transmitting and/or receiving radio waves can be provided.

In general, the method of feeding the radiating element (for example, patch 9) of the patch array section 7 using a common transmission line such as coaxial line or a planar transmission line can be classified mainly into two types: direct coupling feeding and electromagnetic coupling feeding. Thus, the feeding method in the present invention includes two methods: direct coupling feeding in which a transmission path is directly connected to the patch 9 (radiating element) to excite the radiating element; and electromagnetic coupling feeding in which the patch electrode (radiating element) is excited by an electromagnetic field produced on the periphery of an open-ended or short-circuited power feed line, rather than directly connecting the transmission path to the patch electrode (radiating element). In the present invention, a manner of the electromagnetic coupling feeding is indicated.

In the present embodiment, since the power feed line by the (coaxial) power feed section 12 is open-ended, a current standing wave is generated such that the terminal of the power feed line coincides with a node. Then, a magnetic field surrounding the power feed line ((coaxial) power feed section 12) is produced, and this magnetic field is incident on the slot 8 to excite the slot (pair) 8. The magnetic field produced by the excitation of the slot (pair) 8 is then incident on the patch 9 to excite the patch 9. It is preferable that the slot (pair) 8 is formed at a position where the magnetic field produced from the power feed line ((coaxial) power feed section 12) is strongest (an antinode of the current standing wave), because the excitation intensity is largest when the magnetic field incident on the slot 8 is strongest.

A preferred embodiment of the antenna according to the present invention is a combination of a radial line slot array and a patch antenna array.

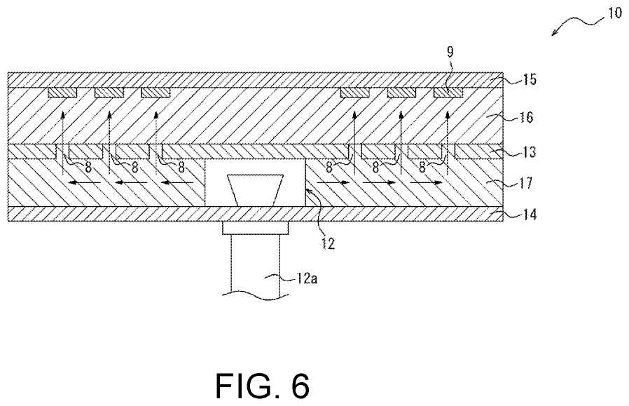

An embodiment of the antenna body 10 will now be described with reference to FIG. 6 illustrating a section of the antenna body 10 illustrated in FIG. 5. FIG. 6 is a schematic diagram illustrating a configuration of the antenna.

As illustrated in FIG. 6, the antenna body 10 includes a disc-shaped second substrate 14, a disc-shaped first substrate 13 (corresponding to the disc-shaped conductor P, also referred to as slot array substrate) having a plurality of slots (pairs) 8 formed from the center to the radially outer side, a first dielectric layer 17 provided between the second substrate 14 and the first substrate 13, a power feed section 12 provided at the center of the disc-shaped first substrate 13 and the disc-shaped second substrate 14, a disc-shaped third substrate 15 (corresponding to the disc body Q, also referred to as patch substrate), patches 9 (radiating elements or incidence elements) attached to the third substrate 15, and a liquid crystal layer 16 provided between the third substrate 15 and the first substrate 13. The power feed section 12 is electrically connected to the transmitter and/or the receiver provided on the control board via a power feed line 12a. The patches 9 correspond to respective slot pairs 8.

As used herein “the patch(es) 9 correspond to (respective) slot pair(s) 8” means that the projected plane of the patch 9 projected perpendicularly to the main surface of the second substrate 14 overlaps with the slot (pair) 8, as explained with reference to FIG. 5 above. In other words, the projected plane of the slot (pair) 8 projected perpendicularly to the main surface of the third substrate 15 overlaps with the patch 9.

The first substrate 13, the second substrate 14, and the third substrate 15 are preferably disc bodies having the same area.

In FIG. 6, a radio wave (arrows) fed by the (coaxial) power feed section 12 is transmitted from the slots (pairs) 8 to the liquid crystal layer 16 while propagating in the form of a cylindrical wave in the first dielectric layer 17 to the radially outer side. The slot (pair) 8 can generate a circularly polarized wave when two slots orthogonal to each other in what is called a “V” shape are arranged with a ¼ wavelength shift, as illustrated in FIG. 4. As described above, the magnetic field produced from the slot (pair) 8 by excitation of the slot (pair) 8 by electromagnetic coupling feeding is incident on the patch 9 to excite the patch 9. As a result, the patch 9 can radiate a directional radio wave.

On the other hand, in reception of an incoming radio wave, based on the reciprocity theorem of transmission and reception, after the patch 9 receives an incoming radio wave, the incoming wave is propagated to the power feed section 12 via the slot (pair) 8 provided directly below the patch 9, in a reverse manner of the above.

Circularly polarized waves are radio waves in which, unlike linearly polarized waves, the electric field direction rotates over time, and classified into right-circularly-polarized waves for use in GPS or ETC and left-circularly-polarized waves for use in satellite radio broadcasting and the like. The antenna according to the present invention can receive any one of the polarized waves.

The orientation direction of liquid crystal molecules in the liquid crystal layer 16 can be changed by applying a voltage to the liquid crystal layer 16 between the patches 9 and the first substrate 13. As a result, the dielectric constant of the liquid crystal layer 16 changes, and the capacitance of the slot (pair) 8 changes accordingly. Consequently, the reactance and the resonance frequency of the slot (pair) 8 can be controlled. In other words, since the reactance and the resonance frequency of the slot 8 can be adjusted by controlling the dielectric constant of the liquid crystal layer 16, power feeding to each patch 9 can be controlled by adjusting the excitation of the slot (pair) 8 and the patch 9. Thus, radiation radio waves can be adjusted through the liquid crystal layer 16. For this, for example, a voltage application adjuster for adjusting a voltage to be applied to the liquid crystal layer 16, such as a TFT, may be provided. Changing the orientation direction of liquid crystal molecules in the liquid crystal layer 16 changes the refractive index, resulting in phase shifting of the electromagnetic waves transmitted through the liquid crystal layer 16. Consequently, phased array control can be implemented.

The first substrate 13 and the second substrate 14 can be formed of any material that is a conductor such as copper. The material of the third substrate 15 is not limited and can be selected from known materials such as glass substrates, acrylic substrates, ceramic (alumina), silicon, and glass cloth Teflon (registered trademark) (PTFE), depending on the manner of use. The material of the first dielectric layer 17 can be selected as appropriate from known materials depending on the desired dielectric constant and may be a vacuum. The patch 9 may be formed of any material that is a conductor such as copper or silver.

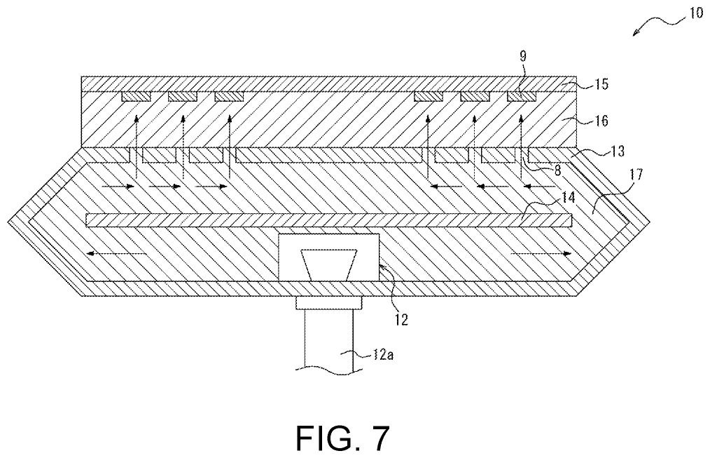

Another embodiment of the antenna body 10 will now be described with reference to FIG. 7. The embodiment illustrated in FIG. 7 differs from the embodiment illustrated in FIG. 6 in the slot array section 6 of the antenna body 10.

In FIG. 7, the antenna body 10 includes a hollow-body first substrate 13 having a plurality of slots (pairs) 8 formed on one surface, a disc-shaped second substrate 14, a first dielectric layer 17, and a power feed section 12 accommodated inside the hollow-body first substrate 13, a disc-shaped third substrate 15, patches 9 attached to the third substrate 15, and a liquid crystal layer 16 provided between the third substrate 15 and the first substrate 13. The power feed section 12 is provided between the second substrate 14 and the first substrate 13 on the other surface on which the slots (pairs) 8 are not formed, and at the center of the first substrate 13 and the disc-shaped second substrate 14. The power feed section 12 is electrically connected to the transmitter and/or the receiver provided on the control board via a power feed line 12a. The patches 9 correspond to respective slot pairs 8. In FIG. 7, both side surface portions of the hollow-body first substrate 13 protrude outward of the hollow body, specifically, have inclined surfaces at 45° relative to the horizontal direction.

As illustrated in FIG. 7, a radio wave (arrows) fed by the (coaxial) power feed section 12 propagates in the form of a cylindrical wave in the first dielectric layer 17 to the radially outer side. The propagating cylindrical wave is reflected at both side surface portions of the hollow-body first substrate 13, and the cylindrical wave moving around the second substrate 14 is converted into a traveling wave (arrows) traveling from the outer periphery of the disc-shaped first substrate 13 toward the center and propagates in the first dielectric layer 17. In this case, the traveling wave is transmitted from the slot (pair) 8 to the liquid crystal layer 16. Thus, the patch 9 is excited to radiate a directional radio wave in the same manner as in the embodiment illustrated in FIG. 6.

On the other hand, in reception of an incoming radio wave, similarly, after the patch 9 receives an incoming radio wave, the incoming radio wave propagates to the power feed section 12 via the slot (pair) 8 provided directly below the patch 9.

Yet another embodiment of the antenna body 10 will now be described with reference to FIG. 8 to FIG. 10. In the embodiment of the antenna body 10 in FIG. 5 to FIG. 7 described above, the antenna body 10 is configured such that the liquid crystal layer 16 is uniformly provided between the first substrate 13 and the third substrate 15. On the other hand, in the embodiment in FIG. 8 to FIG. 10, the antenna body 10 is configured such that the liquid crystal layer 16 is filled in a space (hereafter referred to as sealed region 20) in which a patch 9 and a slot 8 are arranged.

FIG. 8 is a top view illustrating an exemplary embodiment of the antenna body 10 according to the present invention. More specifically, in FIG. 8, the antenna body 10 is viewed from the patch array section 7, and the patches 9, the power feed section 12, and the slots 8 are projected perpendicularly to the main surface of the disc body Q. The patches 9, the power feed section 12, and the slots 8 are therefore depicted by broken lines, in the same manner as in FIG. 5. In FIG. 8, a square-shaped patch 9 and one rectangular parallelepiped-shaped slot 8 are disposed in the corresponding sealed region 20. As illustrated in FIG. 8, the projection of the patch 9 and the projection of the slot 8 overlap, suggesting that the slot 8 is formed directly below the patch 9. With this configuration, in the embodiment of the antenna body 10 illustrated in FIG. 8, power can be fed from the slot 8 to the patch 9 by electromagnetic coupling feeding, or an incoming radio wave can propagate from the patch 9 to the slot 8. Thus, an antenna capable of transmitting and/or receiving radio waves can be provided.

As illustrated in FIG. 8, in the present embodiment, the patches 9 and the slots 8 are arranged concentrically from the center of the disc body Q toward the outer periphery of the disc body Q. With this configuration, a conical beam is emitted by coaxial mode feeding, and the phases are matched in front of the disc body Q, thereby enhancing the electromagnetic fields.

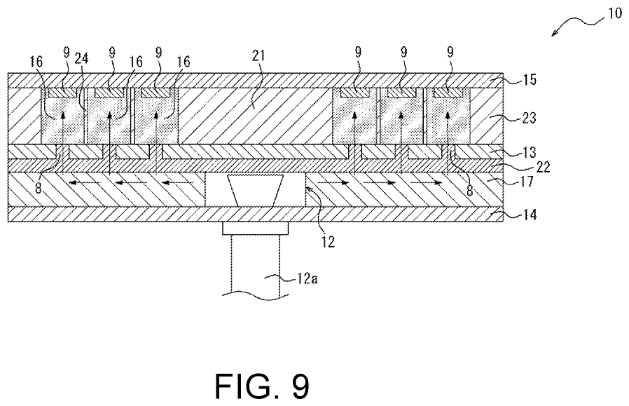

An embodiment of the antenna body 10 will now be described with reference to FIG. 9 illustrating a section of the antenna body 10 illustrated in FIG. 8. FIG. 9 is a schematic diagram illustrating a configuration of the antenna.

As illustrated in FIG. 9, the antenna body 10 includes a disc-shaped second substrate 14, a disc-shaped first substrate 13 having a plurality of slots 8 formed concentrically from the center to the radially outer side, a buffer layer 22 provided on a surface of the first substrate 13 on the side closer to the second substrate 14, a first dielectric layer 17 provided between the buffer layer 22 and the second substrate 14, a power feed section 12 provided at the center of the disc-shaped first substrate 13 and the disc-shaped second substrate 14 and in contact with the first dielectric layer 17, a disc-shaped third substrate 15, patches 9 (radiating elements or incidence elements) attached to the third substrate 15, and a liquid crystal layer 16 divided by seal walls 24 between the third substrate 15 and the first substrate 13 and filled in contact with the patches 9 in a plurality of sealed regions 20 having the patches 9. The power feed section 12 is electrically connected to the transmitter and/or the receiver provided on the control board via a power feed line 12a. The patches 9 correspond to respective slot pairs 8. At least one patch 9, at least one slot 8, and the liquid crystal layer 16 are present in each of the sealed regions 20. The sealed regions 20 are divided by seal walls 21, 23, and 24.

Although not illustrated in FIG. 9, a TFT (thin-film transistor) for controlling the voltage of the liquid crystal layer 16 may be provided in each sealed region 20, if necessary, for example, on the first substrate 13. With this configuration, application of a voltage to the liquid crystal layer 16 can be controlled by an active system. An alignment film may be provided, if necessary, in each sealed region 20 to fix the orientation direction of the liquid crystal molecules forming the liquid crystal layer 16. As the alignment film, a homeotropic alignment film that facilitates vertical orientation of liquid crystal molecules or a homogeneous alignment film that facilitates horizontal orientation of liquid crystal molecules may be provided between the first substrate 13 and the liquid crystal layer 16. Examples include polyimide alignment films and photoalignment films.

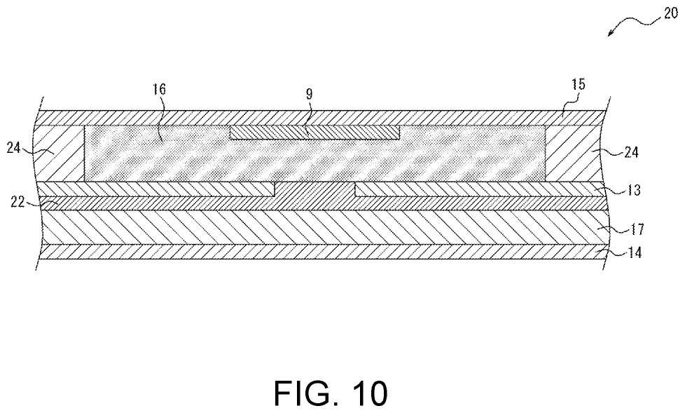

The sealed region 20 in the present embodiment will now be described with reference to FIG. 10 illustrating a section of the antenna body 10 in FIG. 8 cut along line B-B. FIG. 10 is a schematic diagram illustrating the sealed region 20.

As illustrated in FIG. 10, the sealed region 20 is a sealed space surrounded in all directions by the seal walls 24, the buffer layer 22 and the first substrate 13, and the third substrate 15. In the inside, at least one patch 9 and at least one slot 8 are provided to face each other in the same sealed space, which is filled with the liquid crystal layer 16.

In the present embodiment, the seal walls 24 may be formed of a known insulator or the like. The buffer layer 22 may be formed of a known dielectric material or the like.

Although not illustrated in FIG. 10, a TFT (thin-film transistor) for controlling the voltage to the liquid crystal layer 16 may be provided in the sealed region 20, if necessary, for example, on the first substrate 13. With this configuration, application of a voltage to the liquid crystal layer 16 can be controlled by an active system. The driving method by the active system will be described in more detail. Examples thereof include a method in which the patch 9 serves as a common electrode and the first substrate 13 serves as a pixel electrode, and a TFT formed on the first substrate 13 controls a voltage between the patch 9 and the first substrate 13 to control the orientation of liquid crystal molecules in the liquid crystal layer 16, a method in which the first substrate 13 serves as a pixel electrode, an electrode layer and a TFT are formed on the first substrate 13, and a voltage between the patch 9 and the first substrate 13 is controlled to control the orientation of liquid crystal molecules in the liquid crystal layer 16, and a method in which a comb electrode and a TFT are provided on the first substrate 13, and the TFT controls the orientation of liquid crystal molecules in the liquid crystal layer 16. The method of controlling the application of a voltage to the liquid crystal layer 16 by an active system is not limited to the above methods.

In this case, an alignment film may be provided for fixing the orientation direction of liquid crystal molecules forming the liquid crystal layer 16 in each sealed region 20. As the alignment film, a homeotropic alignment film that facilitates vertical orientation of liquid crystal molecules or a homogeneous alignment film that facilitates horizontal orientation of liquid crystal molecules may be provided between the first substrate 13 and the liquid crystal layer 16.

The voltage applied to the liquid crystal layer 16 between the patch 9 and the first substrate 13 may be modulated in order to tune the liquid crystal layer 16. For example, as described above, the voltage applied to the liquid crystal layer 16 is controlled using the active system, whereby the capacitance of the slot 8 is changed. Consequently, the reactance and the resonance frequency of the slot 8 can be controlled. The resonance frequency of the slot 8 is correlated with energy radiating from the radio wave propagating on the line. The resonance frequency of the slot 8 is therefore adjusted so that the slot 8 is not substantially coupled to the cylindrical wave energy from the power feed section 12, or is coupled to the cylindrical wave energy and radiates the energy into free space. Such control of the reactance and resonance frequency of the slot 8 can be performed in each of the sealed regions 20. In other words, power feeding to the patch 9 in each sealed region 20 can be controlled by the TFT by controlling the dielectric constant of the liquid crystal layer 16. Thus, patches 9 to transmit radio waves and patches not to transmit radio waves can be controlled, so that transmission and reception of radiated radio waves can be adjusted through the liquid crystal layer 16.

### EXAMPLES

The present invention will be described in more detail below with examples, but the present invention is not intended to be limited by the following examples.

### (Example 1) Production of Compound Represented by Formula (I-1)

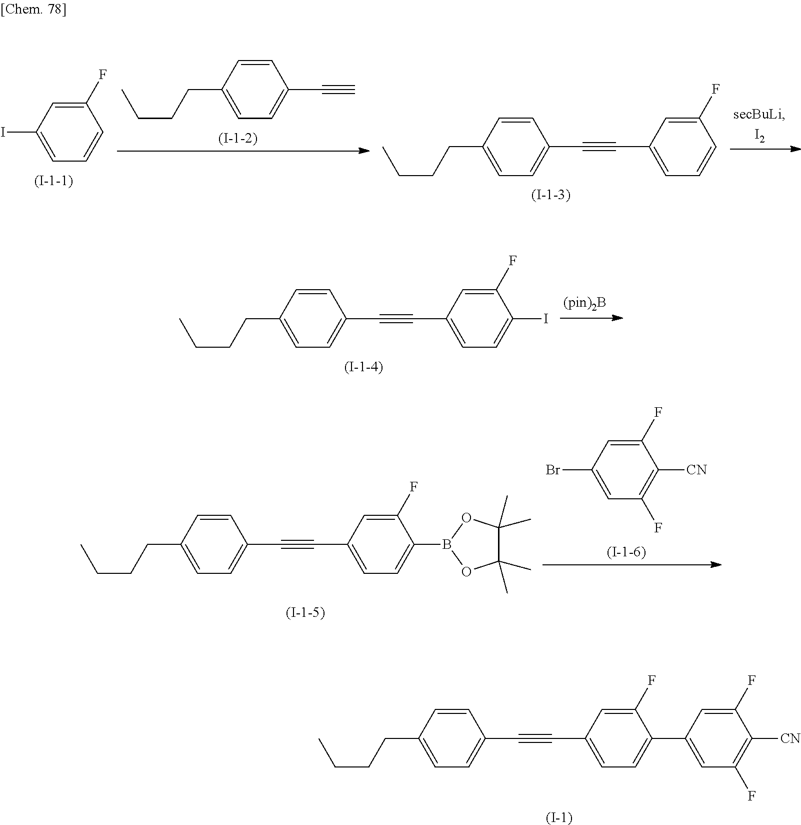

In a nitrogen atmosphere, 33.7 g of the compound represented by formula (I-1-1), 0.5 g of copper(I) iodide, 67 mL of triethylamine, 202 mL of N,N-dimethylformamide, and 0.9 g of bis(triphenylphosphine)palladium(II) dichloride were added to a reaction vessel. At 80° C., a solution of 20.0 g of the compound represented by formula (I-1-2) dissolved in 20 mL of N,N-dimethylformamide was added dropwise, and the mixture was heated and stirred for 6 hours. The reaction solution was cooled and poured into water and extracted with toluene. The organic layer was washed sequentially with 5% hydrochloric acid, water, and salt water, and purified by column chromatography (silica gel, dichloromethane/hexane) to yield 20.6 g of the compound represented by formula (I-1-3).

In a nitrogen atmosphere, 18.6 g of the compound represented by formula (I-1-3) and 186 mL of tetrahydrofuran were added to a reaction vessel. At −70° C., 84.4 mL of a sec-butyllithium (1.05 M)/cyclohexane-hexane solution was added dropwise, and the mixture was stirred for 1 hour. At −65° C., a solution of 22.5 g of iodine dissolved in 68 mL of tetrahydrofuran was added dropwise, and the mixture was stirred for 2 hours. The temperature was gradually increased to room temperature. Water and a sodium hydrogen sulfite solution were added dropwise, and the solution was extracted with toluene. The organic layer was washed sequentially with water and salt water, and purified by column chromatography (silica gel, hexane) and recrystallization (methanol) to yield 13.9 g of the compound represented by formula (I-1-4).

In a nitrogen atmosphere, 12.9 g of the compound represented by formula (I-1-4), 10.4 g of bis(pinacolato)diboron, 10.1 g of potassium acetate, and 104 mL of dimethyl sulfoxide were added to a reaction vessel. At 85° C., 0.5 g of [1,1′-bis(diphenylphosphino)ferrocene]palladium(II) dichloride dichloromethane adduct was added, and the mixture was heated and stirred for 5 hours. The reaction solution was cooled and poured into water and extracted with toluene. The organic layer was washed sequentially with water and salt water, and purified by column chromatography (alumina, toluene) to yield 12.8 g of the compound represented by formula (I-1-5).

In a nitrogen atmosphere, 3.5 g of the compound represented by formula (I-1-6), 3.4 g of potassium carbonate, 28 mL of toluene, 14 mL of ethanol, 14 mL of water, and 0.2 g of dichlorobis[di-t-butyl(p-dimethylaminophenyl)phosphino]palladium(II) were added to a reaction vessel. With heating and refluxing, a solution of 6.1 g of the compound represented by formula (I-1-5) dissolved in 12 mL of toluene and 6 mL of ethanol was added dropwise, and the mixture was heated and refluxed for 5 hours. The reaction solution was poured into water and extracted with toluene. The organic layer was washed sequentially with water and salt water, and purified by column chromatography (silica gel, dichloromethane/hexane) and recrystallization (hexane) to yield 5.0 g of the compound represented by formula (I-1).

Phase transition temperature: C 79 N 134 I

1H-NMR (400 MHz, CHLOROFORM-D) δ 7.47-7.33 (m, 5H), 7.29-7.26 (d, 2H), 7.19 (d, J=8.2 Hz, 2H), 2.64 (t, J=7.8 Hz, 2H), 1.65-1.57 (m, 2H), 1.36 (td, J=14.9, 7.3 Hz, 2H), 0.94 (t, J=7.3 Hz, 3H)

MS (EI): m/z=389

### (Example 2) Production of Compound Represented by Formula (I-2)

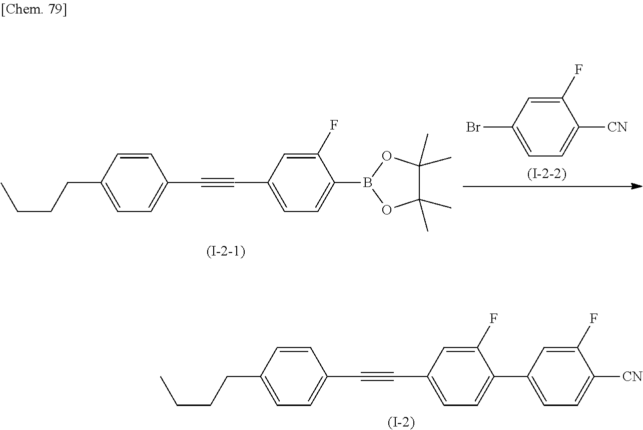

The compound represented by formula (I-2) was produced by the same method as in Example 1, except that the compound represented by formula (I-1-6) was replaced by the compound represented by formula (I-2-2).

Phase transition temperature: C 76 N 183 I

MS (EI): m/z=371

### (Example 3) Production of Compound Represented by Formula (I-3)

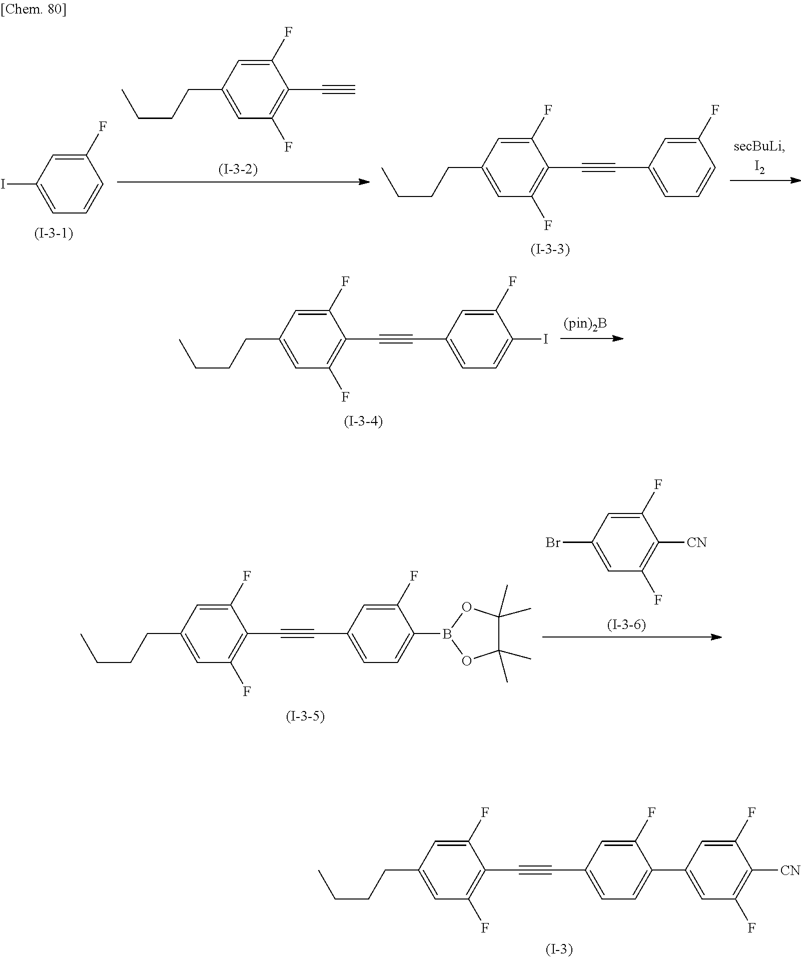

The compound represented by formula (I-3) was produced by the same method as in Example 1, except that the compound represented by formula (I-1-2) was replaced by the compound represented by formula (I-3-2).

MS (EI): m/z=425

### (Example 4) Production of Compound Represented by Formula (II-1)

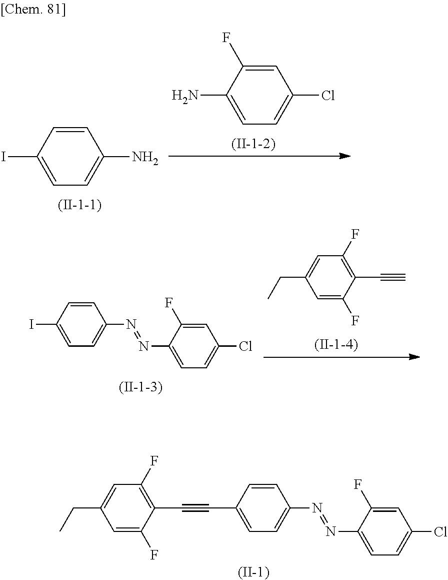 [SMILES: Nc1ccc(Cl)cc1F ; Nc1ccc(I)cc1 ; Fc1cc(Cl)ccc1/N=N/c1ccc(I)cc1 ; C#Cc1c(F)cc(CC)cc1F ; CCc1cc(F)c(C#Cc2ccc(/N=N/c3ccc(Cl)cc3F)cc2)c(F)c1 ; "(II-1)"]

In a nitrogen atmosphere, 10.0 g of the compound represented by formula (II-1-1) and 100 mL of dichloromethane were added to a reaction vessel. At room temperature, a solution of 125 g of potassium peroxymonosulfate [KHSO₅ (>approximately 45%)] dissolved in 200 mL of water was added dropwise, and the mixture was stirred for 15 hours at room temperature. The reaction solution was separated, and the organic layer was washed sequentially with 5% hydrochloric acid, water, and salt water. After the solvent was removed, the product was dissolved in 200 mL of acetic acid. At room temperature, 6.6 g of the compound represented by formula (II-1-2) was added, and the mixture was stirred for 15 hours. The precipitate was filtered and washed sequentially with acetic acid and water. By drying, 13.2 g of the compound represented by formula (II-1-3) was obtained.

The compound represented by formula (II-1-4) was produced by the method described in International Journal of Molecular Sciences, 2013, Vol. 14, No. 12, pp. 23257-23273. In a nitrogen atmosphere, 13.2 g of the compound represented by formula (II-1-3), 0.2 g of copper(I) iodide, 0.2 g of [1,1′-bis(diphenylphosphino)ferrocene]palladium(II) dichloride dichloromethane adduct, 26 mL of triethylamine, and 78 mL of N,N-dimethylformamide were added to a reaction vessel. With heating at 50° C., a solution of 6.7 g of the compound represented by formula (II-1-4) dissolved in 14 mL of N,N-dimethylformamide was added dropwise, and the mixture was heated and stirred for 8 hours. The reaction solution was poured into water and extracted with toluene. The organic layer was washed sequentially with 5% hydrochloric acid and salt water, and purified by column chromatography (silica gel, dichloromethane/hexane), activated carbon treatment, and recrystallization (acetone/hexane) to yield 10.2 g of the compound represented by formula (II-1).

MS (EI): m/z=398

### (Example 5) Production of Compound Represented by Formula (II-2)

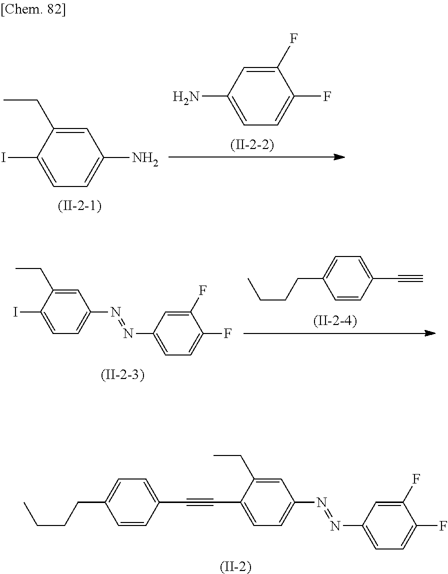

The compound represented by formula (II-2) was produced by the same method as in Example 4 except that the compound represented by formula (II-1-1) was replaced by the compound represented by formula (II-2-1), that the compound represented by formula (II-1-2) was replaced by the compound represented by formula (II-2-2), and that the compound represented by formula (II-1-4) was replaced by the compound represented by formula (II-2-4).

MS (EI): m/z=402

Nematic liquid crystal compositions described in Examples were produced and various physical properties were measured. The compositions of the following Examples and Comparative Examples contain the compounds in the proportions listed in the tables, and the amount contained is indicated by “% by mass”. In the examples, the following abbreviations are used to describe the compounds.

### (Ring Structure)

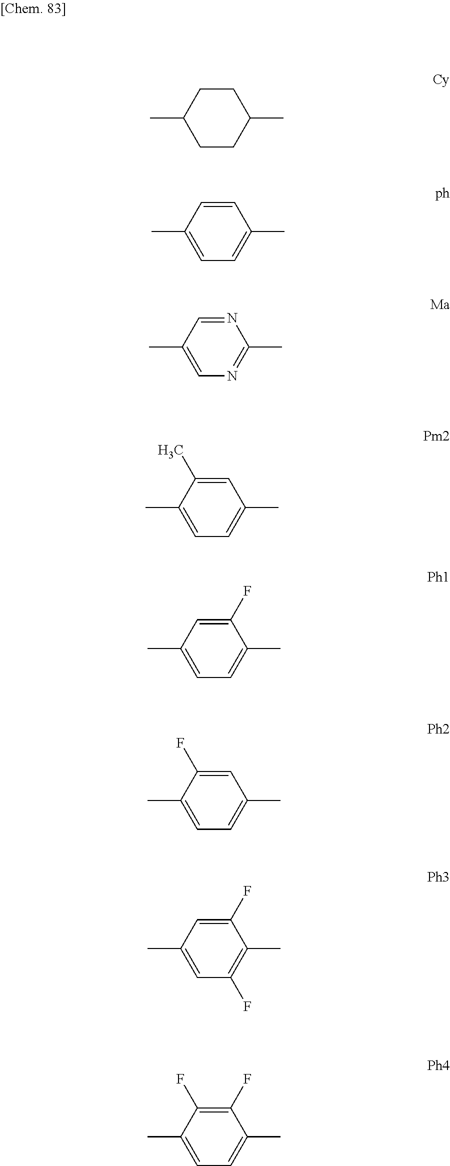

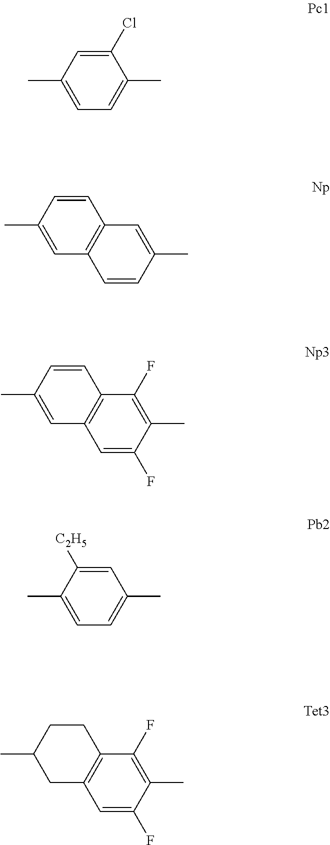

In the following Examples, the trans forms are represented unless otherwise specified.

### (Side Chain Structure and Linkage Structure)

TABLE 1

| Description in abbreviated | Substituent and |
|---|---|
| formula | linking group |
| -F | -F |
| -C1 | -C1 |
| -n (n is an integer equal | —CₙH_{2n + 1} |
| to or greater than 1) | |
| n- (n is an integer equal | CₙH_{2n + 1}— |
| to or greater than 1) | |
| —On (n is an integer equal | —OCₙH_{2n + 1} |
| to or greater than 1) | |
| nO— (n is an integer equal | CₙH_{2n + 1}O— |
| to or greater than 1) | |
| -nV (n is an integer equal | —CₙH₂ₙ-CH = CH₂ |
| to or greater than 1) | |
| Vn- (n is an integer equal | CH₂ = CH-CₙH₂ₙ— |
| to or greater than 1) | |
| —CN | —CN |
| —NCS | —NCS |
| | Single bond |
| -T- | —C = C— |
| —CFFO— | —CF₂O— |
| -D- | —N = N— |
| —COO— | —C(=O)O— |
| -Z- | —CH = N—N = CH— |

### (Physical Properties and Evaluation Methods)

### <Upper Limit Temperature (T_{NI} (° C.))>

T_{NI} (° C.): temperature at which the composition exhibits a transition from the nematic phase to the isotropic phase

<Refractive Index Anisotropy (Δn)>

Δn: refractive index anisotropy of the liquid crystal composition at 25° C. and 589 nm

### —Evaluation Method of Refractive Index Anisotropy

The liquid crystal composition was injected into a glass cell with a polyimide alignment film, and the in-plane retardation (phase difference) at a measurement temperature of 25° C. and 589 nm was measured with a retardation film and optical material inspection system RETS-100 (Otsuka Electronics Co., Ltd.). A glass cell with a cell gap of 3.0 μm between glass substrates was used, in which the rubbing direction of the polyimide alignment film was parallel. The Δn of the liquid crystal composition was calculated from the formula: phase difference=thickness of liquid crystal layer (cell gap) x Δn.

### <Dielectric Constant Anisotropy (Δε)>

Δε: dielectric constant anisotropy of the liquid crystal composition at 25° C.

### Examples 6 to 15

The liquid crystal compounds listed in Tables 2 and 3 were prepared, nematic liquid crystal compositions were produced, and various physical properties were measured by the evaluation methods above.

### Comparative Examples 1 to 4

The liquid crystal compounds listed in Tables 4 and 5 were prepared, nematic liquid crystal compositions were produced, and various physical properties were measured by the evaluation methods above.

TABLE 2

| | Example | Example | Example | Example | Example |
|---|---|---|---|---|---|
| | 6 | 7 | 8 | 9 | 10 |
| T_{NI} (° C.) | 145.1 | 157.4 | 166.3 | 150.3 | 165.3 |
| Δn @589 nm | 0.375 | 0.385 | 0.392 | 0.369 | 0.379 |
| Δε @1 kHz | 14.3 | 15.0 | 16.3 | 14.4 | 15.3 |
| 3-Ph1-Ph-T-Ph3—F | 20 | 20 | 20 | 20 | 20 |
| 3-Ph1-Ph-T-Ph1—F | 10 | 10 | 10 | 10 | 10 |
| 4-Ph1-Ph-T-Ph1—F | | | | 5 | |
| 3-Ph1-Ph-T-Ph-4 | 20 | 20 | 15 | 30 | 20 |
| 4-Ma-Ph-T-Ph—O4 | | 10 | 10 | 5 | 10 |
| 4-Ma-Ph-T-Ph1—F | | 10 | 10 | 5 | 10 |
| 2-Ph3-T-Ph-D-Ph-3 | 5 | 6 | 6 | 5 | 3 |
| 3-Ph3-T-Ph-D-Ph-2 | 5 | 6 | 6 | 5 | 3 |
| 3-Ph3-T-Ph-D-Ph-3 | 5 | 8 | 8 | 5 | 4 |
| 3-Tet3-T-Ph-D-Ph-2 | 10 | | | | 10 |
| 3-Ph-T-Ph1-Ph—CN | 10 | | 10 | | |
| 4-Ph-T-Ph1-Ph3—CN | 5 | 10 | 5 | 10 | 10 |
| 3-T-Ph1-Ph—CN | 5 | | | | |
| 4-T-Ph1-Ph—CN | 5 | | | | |

TABLE 3

| | Example | Example | Example | Example | Example |
|---|---|---|---|---|---|
| | 11 | 12 | 13 | 14 | 15 |
| T_{NI} (° C.) | 162.0 | 138.0 | 159.4 | 140.5 | 158.7 |
| Δn @589 nm | 0.385 | 0.357 | 0.372 | 0.361 | 0.380 |
| Δε @1 kHz | 13.7 | 14.2 | 15.7 | 13.6 | 12.4 |
| 3-Ph1-Ph-T-Ph3—F | 20 | 20 | 20 | 16 | 20 |
| 3-Ph1-Ph-T-Ph1—F | 10 | 10 | 10 | 10 | 10 |
| 4-Ph1-Ph-T-Ph1—F | | 5 | 10 | | |
| 3-Ph1-Ph-T-Ph-4 | 20 | 30 | 20 | 10 | 20 |
| 4-Ma-Ph-T-Ph—O4 | 10 | 5 | 5 | | |
| 4-Ma-Ph-T-Ph1—F | 10 | 5 | 5 | | |
| 2-Ph3-T-Ph-D-Ph-3 | 6 | 3 | 3 | 5 | 6 |
| 3-Ph3-T-Ph-D-Ph-2 | 6 | 3 | 4 | 7 | 8 |
| 3-Ph3-T-Ph-D-Ph-3 | 8 | 3 | 3 | 5 | 6 |
| 3-Tet3-T-Ph-D-Ph-2 | | | 10 | 13 | 10 |
| 4-Ph-T-Pb2-D-Ph1—F | | 3 | | | |
| 2-Ph3-T-Ph-D-Ph2—C1 | | 3 | | | |
| 3-Ph-T-Ph1-Ph—CN | | | | | |
| 4-Ph-T-Ph1-Ph3—CN | | 10 | | 8 | 10 |
| 4-Ph-T-Ph1-Ph1—CN | 10 | | | | |
| 4-Ph3-T-Ph1-Ph3—CN | | | 10 | | |
| V2-Ph-Z-Ph—2V | | | | | 10 |
| 5-Ph-T—Pm2—O2 | | | | 8 | |
| 3-Cy-Ph-T—Pm2-1 | | | | 8 | |
| 3-T-Ph1-Ph—CN | | | | 5 | |
| 4-T-Ph1-Ph—CN | | | | 5 | |

TABLE 4

| | Comparative | Comparative |
|---|---|---|
| | Example 1 | Example 2 |
| T_{NI} (° C.) | 138.5 | 137.4 |
| Δn @589 nm | 0.356 | 0.334 |
| Δε @1 kHz | 8.6 | 11.7 |
| V2-Ph-Z-Ph-2V | 10 | |
| 3-Ph1-Ph-T-Ph3—F | 15 | 10 |
| 3-Ph1-Ph-T-Ph1—F | 15 | |
| 4-Ph1-Ph-T-Ph1—F | 20 | 20 |
| 3-Ph1-Ph-T-Ph-4 | 20 | 20 |
| 4-Ma-Ph-T-Ph—O4 | | 10 |
| 4-Ma-Ph-T-Ph1—F | | 10 |
| 2-Ph3-T-Ph-D-Ph-3 | 6 | 4 |
| 3-Ph3-T-Ph-D-Ph-2 | 6 | 6 |
| 3-Ph3-T-Ph-D-Ph-3 | 8 | 4 |
| 4-Ph-T-Pb2-D-Ph1—F | | 2 |
| 2-Ph3-T-Ph-D-Ph2—Cl | | 2 |
| 3-Cy-Ph—CN | | 12 |

TABLE 5

| | Comparative | Comparative |
|---|---|---|
| | Example 3 | Example 4 |
| T_{NI} (° C.) | 119.5 | 112.4 |
| Δn @589 nm | 0.329 | 0.323 |
| Δε @1 kHz | 10.1 | 11.0 |
| V2-Ph-Z-Ph—2V | 20 | 20 |
| 3-Ph1-Ph-T-Ph3—F | 10 | 10 |
| 3-Ph1-Ph-T-Ph1—F | 10 | 10 |
| 4-Ph1-Ph-T-Ph1—F | 20 | 20 |
| 3-Ph1-Ph-T-Ph-4 | 20 | 20 |
| 3-Ph-T-Ph-1 | 10 | 10 |
| 3-Ph-T-Ph1-Ph—CN | 10 | 2 |
| 4-Ph-T-Ph1-Ph3—CN | | 8 |

The Δn in the visible light region correlates with Δε in the tens of GHz band, and as Δn increases, change in dielectric constant in the GHz band can be increased. Based on this, the evaluation results listed in Tables 2 to 5 demonstrated that the liquid crystal compositions of Examples 6 to 15 were suitable as liquid crystals for antennas. The evaluation results listed in Tables 2 to 5 demonstrated that Examples 6 to 15 have a higher Δn than Comparative Examples 3 to 4 and have a higher Tni and a higher Δε than Comparative Examples 1 to 2. It was demonstrated that Tni of Examples 6 to 15 is an equivalent or higher value than that of Comparative Examples 3 to 4 and is higher than that of Comparative Examples 1 to 2.

It was found that the liquid crystal compositions of Comparative Examples 1 to 4 are difficult to use as liquid crystals for antennas because Δn is low, or Δε is low so that great phase control over radio waves is impossible, or as does not reach a practical level.

### Examples 16 to 18

Liquid crystal compositions were prepared and evaluated in the same manner as in Examples 6 to 15, and it was found that similar effects were achieved. The results are listed in Table 6.

TABLE 6

| | Example | Example | Example |
|---|---|---|---|
| | 16 | 17 | 18 |
| T_{NI} (° C.) | 153.4 | 166.2 | 169.7 |
| Δn @589 nm | 0.402 | 0.401 | 0.402 |
| Δε @1 kHz | 12.74 | 12.91 | 13.76 |
| 2-Ph3-T-Ph-D-Ph-2 | 3 | 3 | 3 |
| 3-Ph3-T-Ph-D-Ph-2 | 3 | 3 | 3 |
| 3-Ph-T-Ph1-Ph—CN | 10 | 10 | 10 |
| V—2Ph-T-Ph—2V | 8 | | |
| 3-Ph-T-Ph1 | | 8 | |
| 4-Ph3-T-Pm3-T-Ph—S—1 | 6 | | |
| 4-T-Ph1-Ph—CN | 5 | 5 | 6.5 |
| 4-T-Ph-Ph—CN | | | 6.5 |
| 3-Ph-Ph1-Ph—CN | 10 | 10 | 10 |
| 4O—Ph2-T-Ph—NCS | 10 | 8 | 8 |
| 5O—Ph2-T-Ph—NCS | 10 | 8 | 8 |
| 4-Cy-Ph-T-Ph1—NCS | 15 | 15 | 15 |
| 5-Cy-Ph-T-Ph1—NCS | 15 | 15 | 15 |
| 4O—Ph-T-Ph1—NCS | 5 | 5 | 5 |
| 3-Tet3-T-Ph-T-Ph-2 | | 10 | 10 |

### INDUSTRIAL APPLICABILITY

The liquid crystal composition of the present invention can be used for crystal display elements, sensors, liquid crystal lenses, optical communication devices, and antennas.

### REFERENCE SIGNS LIST

1: antenna unit
2: vehicle
3: case
4: control board
5: top cover
6: slot array section
7: patch array section
8: slot
9: patch
10: antenna body
11: antenna assembly
12: power feed section
12a: power feed line
13: first substrate
14: second substrate
15: third substrate
16: liquid crystal layer
17: first dielectric layer
20: sealed region
21, 23, 24: seal wall
22: buffer layer
P: conductor
Q: disc body

1. A liquid crystal composition comprising:
one or two or more compounds represented by general formula (i) below: 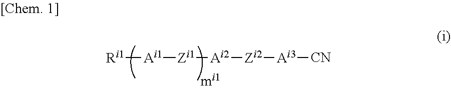
in general formula (i),
Rⁱ¹ represents an alkyl group having 1 to 12 carbon atoms, wherein one or two or more non-adjacent —CH₂-'s in the alkyl group are each independently optionally substituted with —CH═CH—, —C≡C—, —O—, —CO—, —COO—, or —OCO—, and one or two or more hydrogen atoms in Rⁱ¹ are each independently optionally substituted with a fluorine atom,
Aⁱ¹, Aⁱ², and Aⁱ³ each independently represent a group selected from the group consisting of the following groups (a) to (c):
(a) a 1,4-cyclohexylene group, wherein one —CH₂— or two or more non-adjacent —CH₂-'s in the 1,4-cyclohexylene group are optionally substituted with —O—,
(b) a 1,4-phenylene group, wherein one —CH═ or two or more non-adjacent —CH='s in the 1,4-phenylene group are optionally substituted with —N═, and
(c) a naphthalene-2,6-diyl group, a 1,2,3,4-tetrahydronaphthalene-2,6-diyl group, or a decahydronaphthalene-2,6-diyl group, wherein one —CH═ or two or more non-adjacent —CH='s in the naphthalene-2,6-diyl group or the 1,2,3,4-tetrahydronaphthalene-2,6-diyl group are optionally substituted with —N═,
one or two or more hydrogen atoms in the group (a), the group (b), and the group (c) are each independently optionally substituted with a halogen atom, a cyano group, or an alkyl group having 1 to 6 carbon atoms,
Zⁱ¹ and Zⁱ² each independently represent —OCH₂—, —CH₂O—, —C₂H₄—, —C₄H₈—, —COO—, —OCO—, —CH═CH—, —CF═CF—, —CF₂O—, —OCF₂—, —CF₂CF₂—, —C≡C—, or a single bond, wherein at least one Zⁱ¹ or Zⁱ² represents —C≡C—,
mⁱ¹ represents 1 or 2,
a plurality of Aⁱ¹s, if present, are optionally same or different, and a plurality of Zⁱ¹s, if present, are optionally same or different; and
one or two or more compounds represented by general formula (ii) below: 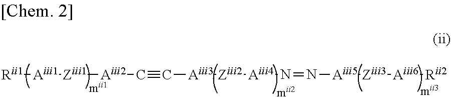
in general formula (ii),
Rⁱⁱ¹ and Rⁱⁱ² each independently represent a fluorine atom, a chlorine atom, a cyano group, or an alkyl group having 1 to 12 carbon atoms, wherein one or two or more non-adjacent —CH₂-'s in the alkyl group are each independently optionally substituted with —CH═CH—, —C≡C—, —O—, —CO—, —COO—, or —OCO—, and one or two or more hydrogen atoms in Rⁱⁱ¹ and Rⁱⁱ² are each independently optionally substituted with a fluorine atom, wherein Rⁱⁱ¹ and Rⁱⁱ² do not simultaneously represent a substituent selected from a fluorine atom, a chlorine atom, and a cyano group,
Zⁱⁱ¹, Zⁱⁱ², and Zⁱⁱ³ each independently represent a single bond, —OCH₂—, —CH₂O—, —C₂H₄—, —C₄H₈—, —COO—, —OCO—, —CH═CH—, —CF═CF—, —CF₂O—, —OCF₂—, —CF₂CF₂—, or —C≡C—,
Aⁱⁱ¹, Aⁱⁱ², Aⁱⁱ³, Aⁱⁱ⁴, Aⁱⁱ⁵, and Aⁱⁱ⁶ each independently represent a group selected from the group consisting of the following groups (a) to (c):
(a) a 1,4-cyclohexylene group, wherein one —CH₂— or two or more non-adjacent —CH₂-'s in the 1,4-cyclohexylene group are optionally substituted with —O—,
(b) a 1,4-phenylene group, wherein one —CH═ or two or more non-adjacent —CH='s in the 1,4-phenylene group are optionally substituted with —N═, and
(c) a naphthalene-1,4-diyl group, a naphthalene-2,6-diyl group, a 1,2,3,4-tetrahydronaphthalene-2,6-diyl group, or a decahydronaphthalene-2,6-diyl group, wherein one —CH═ or two or more non-adjacent —CH='s in the naphthalene-1,4-diyl group, the naphthalene-2,6-diyl group, or the 1,2,3,4-tetrahydronaphthalene-2,6-diyl group are optionally substituted with —N═,
one or two or more hydrogen atoms in the group (a), the group (b), and the group (c) are each independently optionally substituted with a halogen atom, a cyano group, or an alkyl group having 1 to 6 carbon atoms, and
mⁱⁱ¹, mⁱⁱ², and mⁱⁱ³ each independently represent 0 or 1, wherein mⁱⁱ¹+mⁱⁱ²+mⁱⁱ³ represents 0 or 1.

2. The liquid crystal composition according to claim 1, wherein the compound represented by general formula (i) is general formula (i-1) below: 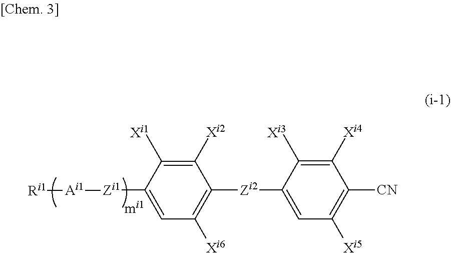
in general formula (i-1), Rⁱ¹, Aⁱ¹, Zⁱ¹, Zⁱ², and mⁱ¹ respectively have a same meaning as Rⁱ¹, Aⁱ¹, Zⁱ¹, Zⁱ², and mⁱ¹ in general formula (i), and
Xⁱ¹ to Xⁱ⁶ each independently represent a hydrogen atom or a fluorine atom, wherein Xⁱ¹ and Xⁱ² do not simultaneously represent a fluorine atom, and Xⁱ³ and Xⁱ⁴ do not simultaneously represent a fluorine atom.

3. The liquid crystal composition according to claim 1, wherein the compound represented by general formula (ii) is general formula (ii-1) below: 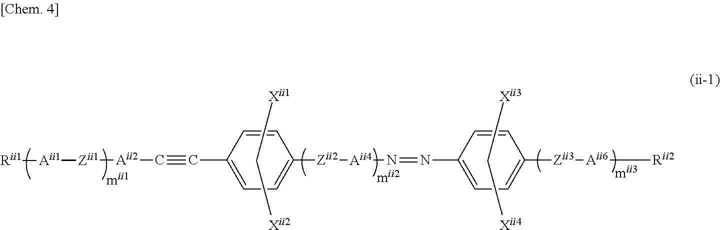
in general formula (ii-1), Rⁱⁱ¹, Rⁱⁱ², Zⁱⁱ¹, Zⁱⁱ², Zⁱⁱ³, Aⁱⁱ¹, Aⁱⁱ⁴, Aⁱⁱ⁶, mⁱⁱ¹, mⁱⁱ², and mⁱⁱ³ respectively have a same meaning as Rⁱⁱ¹, Rⁱⁱ², Zⁱⁱ¹, Zⁱⁱ², Zⁱⁱ³, Aⁱⁱ¹, Aⁱⁱ⁴, Aⁱⁱ⁶, mⁱⁱ¹, mⁱⁱ², and mⁱⁱ³ in general formula (ii),
Aⁱⁱ² represents a group selected from the group consisting of the following groups (d) to (f): 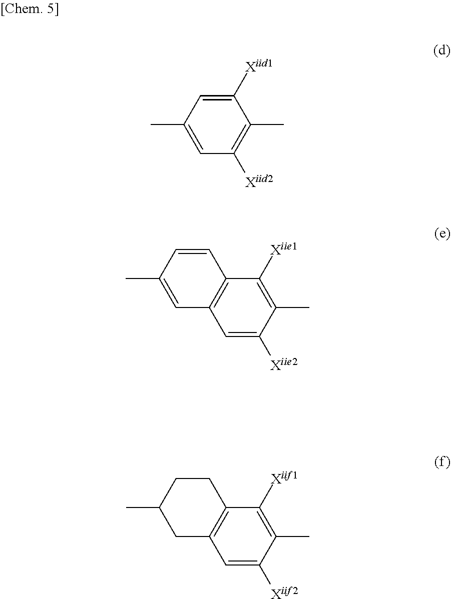
X^{iid1}, X^{iid2}, X^{iie1}, X^{iie2}, X^{iif1}, and X^{iif2} each independently represent a hydrogen atom or a fluorine atom,
Xⁱⁱ¹, Xⁱⁱ², Xⁱⁱ³, and Xⁱⁱ⁴ each independently represent a hydrogen atom, a halogen atom, a cyano group, or an alkyl group having 1 to 6 carbon atoms.

4. The liquid crystal composition according to claim 1, further comprising one or two or more compounds selected from general formula (1a), general formula (1b), and general formula (1c) below: 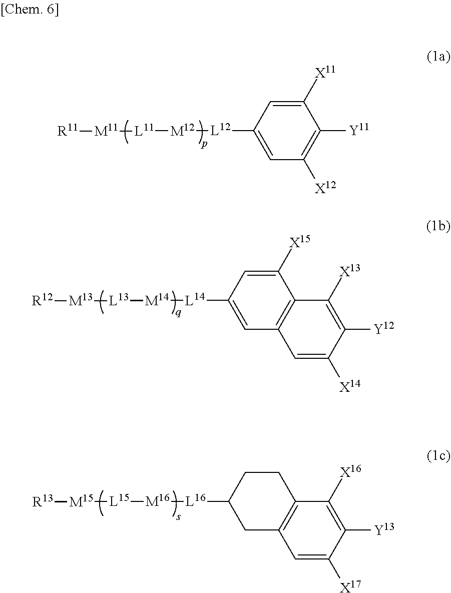
in general formulae (la) to (1c),
R¹¹, R¹², and R¹³ each independently represent an alkyl group having 1 to 10 carbon atoms, an alkenyl group having 2 to 10 carbon atoms, or an alkynyl group having 2 to 10 carbon atoms, wherein one methylene group or two or more non-adjacent methylene groups in these groups are optionally substituted with —O— or —S—, and one or two or more hydrogen atoms in these groups are optionally substituted with a fluorine atom or a chlorine atom,
M¹¹, M¹², M¹³, M¹⁴, M¹⁵, and M¹⁶ each independently represent any one of the following group (a), group (b), or group (d):
(a) a trans-1,4-cyclohexylene group, wherein one methylene group or two or more non-adjacent methylene groups in the trans-1,4-cyclohexylene group are optionally substituted with —O— or —S—,
(b) a 1,4-phenylene group, wherein one —CH═ or two or more non-adjacent —CH='s in the 1,4-phenylene group are optionally substituted with —N═, a 3-fluoro-1,4-phenylene group, or a 3,5-difluoro-1,4-phenylene group, and
(d) a 1,4-cyclohexenylene group, a 1,4-bicyclo[2.2.2]octylene group, a piperidine-2,5-diyl group, a naphthalene-2,6-diyl group, a 1,2,3,4-tetrahydronaphthalene-2,6-diyl group, or a decahydronaphthalene-2,6-diyl group,
one or two or more hydrogen atoms in the group (a), the group (b), or the group (d) are each optionally substituted with a cyano group, a fluorine atom, a chlorine atom, a trifluoromethyl group, or a trifluoromethoxy group,
L¹¹, L¹², L¹³, L¹⁴, L¹⁵, and L¹⁶ each independently represent a single bond, —COO—, —OCO—, —CH₂CH₂—, —(CH₂)₄—, —OCH₂—, —CH₂O—, —OCF₂—, —CF₂O—, or —C≡C—,
p, q, and s each independently represent 0, 1, or 2,
a plurality of M¹²s, M¹⁴s, M¹⁶s, L¹¹s, L¹³s, and/or L¹⁵s, if present, are optionally same or different,
X¹¹, X¹², X¹³, X¹⁴, X¹⁵, X¹⁶, and X¹⁷ each independently represent a hydrogen atom or a fluorine atom, and
Y¹¹, Y¹², and Y¹³ each independently represent a fluorine atom, a chlorine atom, a cyano group, a thiocyanato group, a cyanato group, —C≡C—CN, a trifluoromethoxy group, a trifluoromethyl group, a 2,2,2-trifluoroethyl group, a difluoromethoxy group, an alkyl group having 1 to 10 carbon atoms, an alkenyl group having 2 to 10 carbon atoms, or an alkynyl group having 2 to 10 carbon atoms, wherein one methylene group or two or more non-adjacent methylene groups in these groups are optionally substituted with —O— or —S—, and one or two or more hydrogen atoms in these groups are optionally substituted with a fluorine atom or a chlorine atom,
provided that the compound represented by general formula (i) is excluded from the compounds represented by general formulae (1a), (1b), and (1c).

5. The liquid crystal composition according to claim 4, wherein the compound represented by general formula (1a) is general formula (1a-1) below: 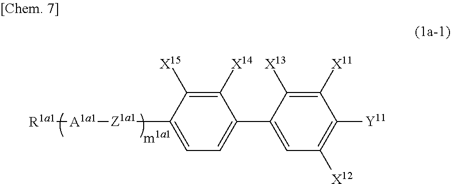
in the formula, Y¹¹, X¹¹, and X¹² respectively have a same meaning as Y¹¹, X¹¹, and X¹² in general formula (1a),
R^{1a1} represents an alkynyl group having 2 to 12 carbon atoms, wherein one or two or more non-adjacent —CH₂-'s in the alkynyl group are each independently optionally substituted with —CH═CH—, —C≡C—, —O—, —CO—, —COO—, or —OCO—, and one or two or more hydrogen atoms in R^{1a1} are each independently optionally substituted with a fluorine atom,
X¹³ to X¹⁵ each independently represent a hydrogen atom or a fluorine atom, wherein X¹¹ and X¹³ do not simultaneously represent a fluorine atom, and X¹⁴ and X¹⁵ do not simultaneously represent a fluorine atom,
A^{1a1} has a same meaning as M¹¹ in general formula (1a),
Z^{1a1} has a same meaning as L¹¹ in general formula (1a), and
m^{1a1} represents 0 or 1.

6. The liquid crystal composition according to claim 1, wherein Δn at 25° C. and 589.0 nm is 0.3 or higher.

7. A liquid crystal element comprising the liquid crystal composition according to claim 1.

8. The liquid crystal element according to claim 7, wherein the liquid crystal element is driven by an active matrix system or a passive matrix system.

9. A liquid crystal element wherein a dielectric constant is reversely switched by reversely changing an orientation direction of liquid crystal molecules of the liquid crystal composition according to claim 1.

10. A sensor comprising the liquid crystal composition according to claim 1.

11. A liquid crystal lens comprising the liquid crystal composition according to claim 1.

12. An optical communication device comprising the liquid crystal composition according to claim 1.

13. An antenna comprising the liquid crystal composition according to claim 1.

14. The antenna according to claim 13, comprising:
a first substrate having a plurality of slots;
a second substrate facing the first substrate and having a power feed section;
a first dielectric layer between the first substrate and the second substrate;
a plurality of patch electrodes disposed corresponding to the slots;
a third substrate having the patch electrodes; and
a liquid crystal layer between the first substrate and the third substrate, wherein the liquid crystal layer contains the liquid crystal composition.

15. A compound represented by general formula (i-1-1a) below: 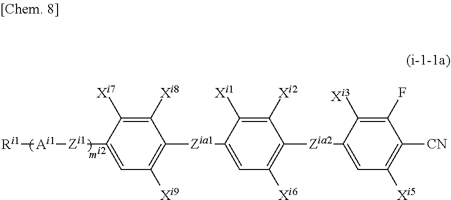
in general formula (i-1-1a),
Rⁱ¹ represents an alkyl group having 1 to 12 carbon atoms, wherein one or two or more non-adjacent —CH₂-'s in the alkyl group are each independently optionally substituted with —CH═CH—, —C≡C—, —O—, —CO—, —COO—, or —OCO—, and one or two or more hydrogen atoms in Rⁱ¹ are each independently optionally substituted with a fluorine atom,
Aⁱ¹ represents a group selected from the group consisting of the following groups (a) to (c):
(a) a 1,4-cyclohexylene group, wherein one —CH₂— or two or more non-adjacent —CH₂-'s in the 1,4-cyclohexylene group are optionally substituted with —O—,
(b) a 1,4-phenylene group, wherein one —CH═ or two or more non-adjacent —CH='s in the 1,4-phenylene group are optionally substituted with —N═, and
(c) a naphthalene-2,6-diyl group, a 1,2,3,4-tetrahydronaphthalene-2,6-diyl group, or a decahydronaphthalene-2,6-diyl group, wherein one —CH═ or two or more non-adjacent —CH='s in the naphthalene-2,6-diyl group or the 1,2,3,4-tetrahydronaphthalene-2,6-diyl group are optionally substituted with —N═,
hydrogen atoms in the group (a), the group (b), and the group (c) are each independently optionally substituted with a halogen atom, a cyano group, or an alkyl group having 1 to 6 carbon atoms,
Zⁱ¹ each independently represents —OCH₂—, —CH₂O—, —C₂H₄—, —C₄H₈—, —COO—, —OCO—, —CH═CH—, —CF═CF—, —CF₂O—, —OCF₂—, —CF₂CF₂—, —C≡C—, or a single bond,
mⁱ² represents 0 or 1,
Z^{ia1} and Z^{ia2} each independently represent a single bond or —C≡C—, wherein at least one of these represents —C≡C—,
Xⁱ¹, Xⁱ², Xⁱ³, Xⁱ⁵, and Xⁱ⁶ each independently represent a hydrogen atom or a fluorine atom, Xⁱ⁷, Xⁱ⁸, and Xⁱ⁹ each independently represent a hydrogen atom or a fluorine atom, wherein Xⁱ⁷ and Xⁱ⁸ do not simultaneously represent a fluorine atom, and at least one of Xⁱ², Xⁱ⁵, Xⁱ⁶, Xⁱ⁸, and Xⁱ⁹ represents a fluorine atom,
a plurality of Aⁱ¹s, if present, are optionally same or different, and a plurality of Zⁱ¹s, if present, are optionally same or different.

16. A compound represented by general formula (ii-1a) below: 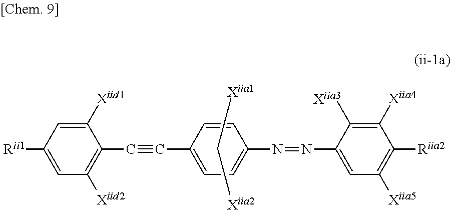
in general formula (ii-1a), R^{iia2} represents a fluorine atom, a chlorine atom, a cyano group, or an alkyl group having 1 to 12 carbon atoms,
X^{iid1} and X^{iia2} each independently represent a hydrogen atom or a fluorine atom,
Rⁱⁱ¹ represents a fluorine atom, a chlorine atom, a cyano group, or an alkyl group having 1 to 12 carbon atoms, wherein one or two or more non-adjacent —CH₂-'s in the alkyl group are each independently optionally substituted with —CH═CH—, —C≡C—, —O—, —CO—, —COO—, or —OCO—, and one or two or more hydrogen atoms in Rⁱⁱ¹ are each independently optionally substituted with a fluorine atom, wherein Rⁱⁱ¹ and R^{iia2} do not simultaneously represent a substituent selected from a fluorine atom, a chlorine atom, and a cyano group,
X^{iia1} and X^{iia2} each independently represent a hydrogen atom, a fluorine atom, or an alkyl group having 1 to 6 carbon atoms, and
X^{iia3}, X^{iia4}, and X^{iia5} each independently represent a hydrogen atom, a fluorine atom, or a chlorine atom, wherein at least one of X^{iia3}, X^{iia4}, and X^{iia5} represents a fluorine atom or a chlorine atom.
